(19) United States
(12) Patent Application Publication
(10) Pub. No.: US 2025/0293269 A1
(43) Pub. Date: Sep. 18, 2025

(54) CATALYTIC NANOMATERIAL, ITS PREPARATION AND USE IN APROTIC ALKALI METAL-GAS BATTERIES

(71) Applicant: City Universtiy of Hong Kong, Kowloon (HK)

(72) Inventors: Zhanxi Fan, Kowloon (HK); Jingwen Zhou, Kowloon (HK)

(21) Appl. No.: 19/045,958

(22) Filed: Feb. 5, 2025

Related U.S. Application Data
(60) Provisional application No. 63/564,673, filed on Mar. 13, 2024.

(51) Int. Cl. H01M 4/92; H01M 4/02; H01M 4/38; H01M 4/86; H01M 4/88; H01M 12/02; H01M 12/08

(52) U.S. Cl. CPC H01M 4/921; H01M 4/382; H01M 4/8867; H01M 12/02; H01M 12/08; H01M 2004/027; H01M 2004/8689

(57) ABSTRACT

A catalytic nanomaterial includes a Janus hollow nanostructure of a heterophase noble metal and a heterophase non-precious metal. The method for synthesizing the catalytic nanomaterial and the use of the catalytic nanomaterial are also addressed.

### TECHNICAL FIELD

The present invention relates to a catalytic nanomaterial, for example, particularly, but not exclusively, a catalytic nanomaterial comprising a Janus hollow nanostructure of a heterophase noble metal and a heterophase non-precious metal. The present invention also relates to a method for synthesizing the catalytic nanomaterial and to the use of the catalytic nanomaterial, particularly, as a bifunctional catalyst in an aprotic alkali metal-gas battery.

### BACKGROUND OF THE INVENTION

Alkali metal-gas batteries such as lithium-carbon dioxide (Li—CO₂) and Li-oxygen/air (Li—O₂/air) batteries with ultrahigh energy density and eco-friendly features have attracted extensive attention around the world. These Li-gas batteries provide more durable and cost-effective energy supply choices for portable electronics and electric equipment in the post period of lithium-ion batteries. In particular, Li—CO₂ battery has shown increasing significance for clean energy storage in recent years, by virtue of its dynamic carbon fixation ability (4Li+3CO₂→2Li₂CO₃+C, E^{θ}=2.8 V, 1875 Wh kg⁻¹) and unique potentials in space exploration (e.g., power source for Mars rover).

However, because CO₂ contamination is inevitable in air and it also spontaneously participates in Li—O₂ reactions to produce Li₂C₂O₄, Li₂C₂O₆ and Li₂CO₃ as the by-products in addition to the prevailing Li₂O₂/Li₂O via both electrochemical and chemical routes, it is believed that Li-gas batteries generally suffer from large discharge-charge overpotential gap, low rate capability and poor cycling life, leading to an unsatisfactory energy efficiency and cost economy in practical application scenarios especially for some high-power devices.

The present invention seeks to eliminate or at least mitigate the aforementioned shortcomings by providing a new or improved nanomaterial such as a catalytic nanomaterial that is capable of promoting kinetics and reversibility of carbon dioxide redox reaction in the alkali metal-gas batteries.

### SUMMARY OF THE INVENTION

In a first aspect of the present invention, there is provided a catalytic nanomaterial comprising a Janus hollow nanostructure of a heterophase noble metal and a heterophase non-precious metal.

Optionally, the Janus hollow nanostructure includes a tubular structure with one or more protrusions.

It is optional that the tubular structure and the protrusion each being a formation of the heterophase noble metal and the heterophase non-precious metal.

In an optional embodiment, the protrusion includes a heterophase non-precious metal section deposited on a heterophase noble metal section.

Optionally, the tubular structure includes a heterophase noble metal tubular formation with scattered heterophase non-precious metal crystal formations.

It is optional that the protrusion axially extends from the tubular structure.

In an optional embodiment, an interface is defined between the heterophase non-precious metal section and the heterophase noble metal section.

Optionally, the heterophase noble metal tubular formation is porous.

In an optional embodiment, the heterophase noble metal comprises a 4H/fcc noble metal and the heterophase non-precious metal comprises a 4H/fcc non-precious metal.

It is optional that the heterophase noble metal is selected from the group consisting of Ru, Rh, Ir, Pd, and Pt.

Optionally, the heterophase non-precious metal is selected from the group consisting of Ni, Co, Fe, and Zn.

In an optional embodiment, the heterophase noble metal comprises 4H/fcc Ru and the heterophase non-precious metal comprises 4H/fcc Ni.

Optionally, the tubular structure is a porous 4H/fcc Ru nanotube scattered with 4H/fcc Ni crystals and the one or more protrusions are dendritic structures axially protruding from the nanotube.

It is optional that the 4H/fcc Ni crystals are epitaxially deposited on the porous 4H/fcc Ru nanotube.

Optionally, the heterophase non-precious metal section comprises epitaxial deposition of 4H/fcc Ni crystals on the heterophase noble metal section of 4H/fcc Ru, thereby defining a Ru—Ni interface.

It is optional that the porous 4H/fcc Ru nanotube comprises a wall formed with a plurality of nanoholes.

In an optional embodiment, Ru and Ni have an atomic ratio of about 72.5:27.5.

It is optional that the catalytic nanomaterial is in powder form.

In an optional embodiment, the 4H/fcc Ru provides a carbon dioxide reduction reaction active site and the 4H/fcc Ni provides a carbon dioxide evolution reaction active site, thereby acting as a bifunctional catalyst.

In a second aspect of the present invention, there is provided a method for synthesizing the catalytic nanomaterial in accordance with the first aspect, comprising the steps of: epitaxially growing a 4H/fcc noble metal on a 4H/fcc Au nanorod; selectively etching the 4H/fcc Au nanorod to obtain a hollow 4H/fcc noble metal nanotube with a plurality of dendritic structures; quasi-epitaxially growing a 4H/fcc non-precious metal on the hollow 4H/fcc noble metal nanotube to obtain a Janus hollow nanostructure of the 4H/fcc noble metal and the 4H/fcc non-precious metal.

It is optional that the noble metal is selected from the group consisting of Ru, Rh, Ir, Pd, and Pt, and the non-precious metal is selected from the group consisting of Ni, Co, Fe, and Zn.

Optionally, the noble metal is Ru and the non-precious metal is Ni.

In an optional embodiment, the method comprises the steps of: epitaxially growing 4H/fcc Ru on the 4H/fcc Au nanorod in the presence of 1, 2-hexadecanediol and oleylamine under heat treatment; selectively etching the 4H/fcc Au nanorod in a solution mixture of 0.1 M CuCl₂ and DMF under heat treatment to obtain a hollow 4H/fcc Ru nanotube with a plurality of 4H/fcc Ru dendritic structures; quasi-epitaxially growing 4H/fcc Ni on the hollow 4H/fcc Ru nanotube with a plurality of 4H/fcc Ru dendritic structures in the presence of 1,2-hexadecanediol and oleylamine under heat treatment to obtain a 4H/fcc Ru—Ni Janus hollow nanostructure.

In a third aspect of the present invention, there is provided an aprotic alkali metal-gas battery comprising the catalytic nanomaterial in accordance with the first aspect, wherein the battery is selected from the group consisting of aprotic Li—CO₂ battery, aprotic Li-air battery, aprotic Na—CO₂ battery, aprotic Na-air battery, aprotic K—CO₂ battery and aprotic K-air battery.

Optionally, the aprotic alkali metal-gas battery comprises a cathode having the catalytic nanomaterial, the cathode being positioned in an aprotic electrolyte along with an alkali metal anode.

In an optional embodiment, the aprotic alkali metal-gas battery is an aprotic Li—CO₂ battery or an aprotic Li-air battery.

Optionally, the aprotic alkali metal-gas battery comprises: a Li-based aprotic electrolyte; a Li metal anode; a cathode including a 4H/fcc Ru—Ni Janus hollow nanostructure as claimed in claim 1; and a separator disposed between the Li metal anode and the cathode.

It is optional that the Li-based aprotic electrolyte includes a DMSO solution of a Li salt, and an ionic liquid.

Optionally, the Li salt is selected from the group consisting of lithium hexafluorophosphate (LiPF₆), lithium perchlorate (LiClO₄), lithium nitrate (LiNO₃), lithium tetrafluoroborate (LiBF₄), lithium bistrifluoromethane sulfonimide (LiTFSI), lithium difluorosulfonimide (LiFSI), lithium triflate (LiCF₃SO₃) and a combination thereof.

It is optional that the Li salt has a concentration of about 0.1 M to about 4 M.

Optionally, the ionic liquid is selected from the group consisting of 1-ethyl-3-methylimidazole tetrafluoroborate ([Emim]BF₄), 1-ethyl-3-methylimidazole bistrifluoromethosulfonimide ([Emim]TFSI), 1-ethyl-3-methylimidazole difluorosulfonimide ([Emim]FSI), 1-Ethyl-3-methylimidazolium chloride ([Emim]Cl) and a combination thereof.

It is optional that the Li-based aprotic electrolyte includes about 5% to about 50% by volume of the ionic liquid.

In an optional embodiment, the cathode further includes a conductive carbon material and a binder.

Optionally, the conductive carbon material is selected from the group consisting of graphene, carbon nanotubes (CNTs), carbon blacks, carbon paper, carbon cloth and a combination thereof.

It is optional that the binder includes Nafion.

Optionally, the cathode has a weight ratio of 4H/fcc Ru—Ni Janus hollow nanostructure:conductive carbon material:binder of about 2.7:0.9:0.4.

In an optional embodiment, the cathode has a mass loading of a mixture of the 4H/fcc Ru—Ni Janus hollow nanostructure and the conductive carbon material of about 0.2 mg cm⁻³ to about 0.3 mg cm⁻³.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1 shows the schematic illustration of the catalytic nanomaterial in accordance with the embodiments of the present invention;

FIG. 2 shows the adsorption energies of the proposed noble and non-precious metals and discharge products obtained from the theoretical simulations regarding the composition optimization of metal catalysts with dual sites for Li—CO₂ electrochemistry;

FIG. 3A shows the adsorption energies of Li on the proposed noble and non-precious metals obtained from the theoretical simulations regarding the composition optimization of metal catalysts with dual sites for Li—CO₂ electrochemistry;

FIG. 3B shows the adsorption energies of CO on the proposed noble and non-precious metals obtained from the theoretical simulations regarding the composition optimization of metal catalysts with dual sites for Li—CO₂ electrochemistry;

FIG. 3C shows the adsorption energies of Li₂CO₃ on the proposed noble and non-precious metals obtained from the theoretical simulations regarding the composition optimization of metal catalysts with dual sites for Li—CO₂ electrochemistry;

FIG. 4 is a table summarizing the adsorption energies of reactive materials (Li, CO₂) and reaction products (Li₂C₂O₄, Li₂CO₃, C) on the established (002)_{2H-Ru}, (111)_{fcc-Ir}, (111)_{fcc-Pd}, (111)_{fcc-Pt}, (111)_{fcc-Rh}, (110)_{bcc-Fe}, (002)_{2H-Co}, (111)_{fcc-Ni}, and (002)_{2H-Zn} surfaces;

FIG. 5 shows the Gibbs free energy barriers of Li₂CO₃ degradation processes on the most thermodynamically abundant facets of the proposed noble and non-precious metals obtained from the theoretical simulations regarding the composition optimization of metal catalysts with dual sites for Li—CO₂ electrochemistry;

FIG. 6 is a table summarizing the decomposition and delithiation energy barriers of *Li₂CO₃ adsorbed on the (002)_{2H-Ru}, (111)_{fcc-Ir}, (111)_{fcc-Pd}, (111)_{fcc-Pt}, (111)_{fcc-Rh}, (110)_{bcc-Fe}, (002)_{2H-Co}, (111)_{fcc-Ni} and (002)_{2H-Zn} surfaces;

FIG. 7 shows the Gibbs free energy barriers of Li₂C₂O₄ degradation processes on the most thermodynamically abundant facets of the proposed noble and non-precious metals obtained from the theoretical simulations regarding the composition optimization of metal catalysts with dual sites for Li—CO₂ electrochemistry;

FIG. 8 is a table summarizing the decomposition and delithiation energy barriers of *Li₂C₂O₄ adsorbed on the (002)_{2H-Ru}, (111)_{fcc-Ir}, (111)_{fcc-Pd}, (111)_{fcc-Pt}, (111)_{fcc-Rh}, (110)_{bcc-Fe}, (002)_{2H-Co}, (111)_{fcc-Ni} and (002)_{2H-Zn} surfaces;

FIG. 9 shows the phonon spectra of 4H Ru and 4H Ni crystal models;

FIG. 10 shows the adsorption energies of reactive materials and discharge products on the most thermodynamically abundant facets of 2H, fcc, 4H Ru and fcc, 4H Ni crystals;

FIG. 11 is a table summarizing the adsorption energies of reactive materials (Li, CO₂) and reaction products (Li₂C₂O₄, Li₂CO₃, C) on the established (002)_{2H-Ru}, (111)_{f-Ru}, (004)_{4H-Ru} and (110)_{4H-Ru} surfaces for Ru and (111)_{f-Ni}, (004)_{4H-Ni} and (110)_{4H-Ni} surfaces for Ni;

FIG. 12 shows the comparison of the adsorption energies of different raw materials, intermediates and discharge products on the exposed surfaces of nanometals. Li, LiCO₂, Li₂CO₂, LiC₂O₄, Li₂C₂O₄, Li₂CO₃, CO₂, CO and C are selected as the species to be adsorbed on the (002)_{2H-Ru}, (110)_{4H-Ru}, (004)_{4H-Ru}, (110)_{4H-Ni} and (004)_{4H-Ni} surfaces;

FIG. 13 shows the theoretical models. Top views of the optimized energetically most favorable structures of *Li, *LiCO₂, *LiC₂O₄, *Li₂C₂O₄, *Li₂CO₃, *CO and *C adsorbed on the selected (002)_{2H-Ru}, (110)_{4H-Ru}, (004)_{4H-Ru}, (110)_{4H-Ni} and (004)_{4H-Ni} surfaces;

FIG. 14 is table summarizing the charge density differences of adsorbed Li₂CO₃ and L₂C₂O₄ on the (002)_{2H-Ru}, (110)_{4H-Ru}, (004)_{4H-Ru}, (110)_{4H-Ni}, and (004)_{4H-Ni} facets;

FIG. 15 shows the charge density differences of adsorbed Li₂CO₃ and L₂C₂O₄ on the (002)_{2H-Ru}, (110)_{4H-Ru}, (004)_{4H-Ru}, (110)_{4H-Ni}, and (004)_{4H-Ni} facets;

FIG. 16A shows the partial electronic density of states (PDOS) around the Fermi level (E_{f}) of (002)_{2H-Ru} facets after the Li₂C₂O₄ adsorption;

FIG. 16B shows the partial electronic density of states (PDOS) around the Fermi level (E_{f}) of (110)_{4H-Ru} facets after the Li₂C₂O₄ adsorption;

FIG. 16C shows the partial electronic density of states (PDOS) around the Fermi level (E_{f}) of (004)_{4H-Ru} facets after the Li₂C₂O₄ adsorption;

FIG. 16D shows the partial electronic density of states (PDOS) around the Fermi level (E_{f}) of (110)_{4H-Ni} facets after the Li₂C₂O₄ adsorption;

FIG. 16E shows the partial electronic density of states (PDOS) around the Fermi level (E_{f}) of (004)_{4H-Ni} facets after the Li₂C₂O₄ adsorption;

FIG. 17A shows the partial electronic density of states (PDOS) around the Fermi level (E_{f}) of (002)_{2H-Ru} facets after the Li₂CO₃ adsorption;

FIG. 17B shows the partial electronic density of states (PDOS) around the Fermi level (E_{f}) of (110)_{4H-Ru} facets after the Li₂CO₃ adsorption;

FIG. 17C shows the partial electronic density of states (PDOS) around the Fermi level (E_{f}) of (004)_{4H-Ru} facets after the Li₂CO₃ adsorption;

FIG. 17D shows the partial electronic density of states (PDOS) around the Fermi level (E_{f}) of (110)_{4H-Ni} facets after the Li₂CO₃ adsorption;

FIG. 17E shows the partial electronic density of states (PDOS) around the Fermi level (E_{f}) of (004)_{4H-Ni} facets after the Li₂CO₃ adsorption;

FIG. 18 shows the most energy-favorable CO₂RR pathways on the (002)_{2H-Ru}, (110)_{4H-Ru}, (004)_{4H-Ru}, (110)_{4H-Ni}, and (004)_{4H-Ni} facets;

FIG. 19 is a table summarizing the Gibbs free energy barriers of *Li, *LiCO₂, *LiC₂O₄, *Li₂C₂O₄, *Li₂C₂O₄+*CO and *LiCO₂+*C adsorbed on the (002)_{2H-Ru}, (004)_{4H-Ru}, (110)_{4H-Ru}, (004)_{4H-Ni} and (110)_{4H-Ni} surfaces;

FIG. 20 shows the Gibbs energy barriers of Li₂CO₃ (left panel) and Li₂C₂O₄ (right panel) decomposition and the following delithiation processes on (002)_{2H-Ru}, (110)_{4H-Ru}, (004)_{4H-Ru}, (110)_{4H-Ni}, (004)_{4H-Ni} facets;

FIG. 21A shows the Li₂CO₃ decomposition energy barriers during the fracture of a Li—O bond with the lowest bond energy;

FIG. 21B shows the atomic models for (002)_{2H-Ru} facets corresponding to FIG. 21A;

FIG. 21C shows the atomic models for (110)_{4H-Ru} facets corresponding to FIG. 21A;

FIG. 21D shows the atomic models for (004)_{4H-Ru} facets corresponding to FIG. 21A;

FIG. 21E shows the atomic models for (110)_{4H-Ni} facets corresponding to FIG. 21A;

FIG. 21F shows the atomic models for (004)_{4H-Ni} (f) facets corresponding to FIG. 21A;

FIG. 22 is a table summarizing the decomposition and delithiation energy barriers of *Li₂CO₃ adsorbed on the (002)_{2H-Ru}, (004)_{4H-Ru}, (110)_{4H-Ru}, (004)_{4H-Ni} and (110)_{4H-Ni} surfaces;

FIG. 23A shows the Li₂C₂O₄ decomposition energy barriers during the fracture of a Li—O bond with the lowest bond energy;

FIG. 23B shows the atomic models for (002)_{2H-Ru} facets corresponding to FIG. 23A;

FIG. 23C shows the atomic models for (110)_{4H-Ru} facets corresponding to FIG. 23A;

FIG. 23D shows the atomic models for (004)_{4H-Ru} facets corresponding to FIG. 23A;

FIG. 23E shows the atomic models for (110)_{4H-Ni} facets corresponding to FIG. 23A;

FIG. 23F shows the atomic models for (004)_{4H-Ni} (f) facets corresponding to FIG. 23A;

FIG. 24 is a table summarizing the Decomposition and delithiation energy barriers of *Li₂C₂O₄ adsorbed on the (002)_{2H-Ru}, (004)_{4H-Ru}, (110)_{4H-Ru}, (004)_{4H-Ni} and (110)_{4H-Ni} surfaces;

FIG. 25 shows the lithium migration barriers on the (110)_{4H-Ru}, (004)_{4H-Ru}, (110)_{4H-Ni}, and (004)_{4H-Ni} facets. Inset: the atomic models demonstrating the migration route of a Li atom on the corresponding surfaces;

FIG. 26 is a schematic illustration depicting the synthetic procedure and atomic arrangement of heterophase 4H/fcc Ru—Ni heteronanostructures;

FIG. 27A shows the low-magnification of SEM image of the as-synthesized 4H/fcc Au nanorods;

FIG. 27B shows the high-magnification of SEM image of the as-synthesized 4H/fcc Au nanorods;

FIG. 27C shows the high-magnification of TEM image of the as-synthesized 4H/fcc Au nanorods;

FIG. 27D shows the HAADF-STEM image (left) of the as-synthesized 4H/fcc Au nanorods, and the FFT patterns (right) corresponding to the regions (e) and (f);

FIG. 27E shows the XRD pattern of the as-synthesized 4H/fcc Au nanaorods;

FIG. 28A shows the low-magnification TEM image of hierarchical 4H/fcc Ru—Ni nanotubes;

FIG. 28B shows the TEM image of the hierarchical 4H/fcc Ru—Ni nanotubes where the vertically oriented Ru—Ni nanodendrites constitute the nanotubes with holey walls, with a magnification scale of 50 nm;

FIG. 28C shows the TEM image of the hierarchical 4H/fcc Ru—Ni nanotubes where the vertically oriented Ru—Ni nanodendrites constitute the nanotubes with holey walls, with a magnification scale of 5 nm;

FIG. 28D shows the HRTEM image of the hierarchical 4H/fcc Ru—Ni nanotubes where the vertically oriented Ru—Ni nanodendrites constitute the nanotubes with holey walls, with a magnification scale of 5 nm;

FIG. 28E shows the HRTEM image of the hierarchical 4H/fcc Ru—Ni nanotubes where the vertically oriented Ru—Ni nanodendrites constitute the nanotubes with holey walls, with a magnification scale of 5 nm and corresponding to FIG. 28D;

FIG. 29A shows the TEM image of the purity of 4H/fcc Au@Ru nanorods and the length and thickness of the Ru dendrites grown on the Au seeds, with a magnification scale of 100 nm;

FIG. 29B shows the TEM image of the purity of 4H/fcc Au@Ru nanorods and the length and thickness of the Ru dendrites grown on the Au seeds, with a magnification scale of 20 nm;

FIG. 29C shows the HRTEM image and the FFT patterns of regions (d) and (e) of the HRTEM image, with the regions (d) and (e) corresponding to the 4H and fcc domains of the Ru dendrites, respectively;

FIG. 29D shows the HRTEM image illustrating the interplanar distance for (004) planes of the 4H Ru crystals;

FIG. 30A shows the TEM image illustrating the purity of the hierarchical 4H/fcc Ru nanotubes;

FIG. 30B shows the TEM image illustrating the size of the hierarchical 4H/fcc Ru nanotubes;

FIG. 30C shows the HRTEM image of the porous walls of the hierarchical 4H/fcc Ru nanotubes;

FIG. 30D shows the HRTEM image of the 4H/fcc Ru dendrites and the FFT patterns of regions (e) and (f), with the regions (e) and (f) corresponding to the 4H and fcc domains, respectively;

FIG. 31A shows the aberration-corrected HAADF-STEM image of the hierarchical 4H/fcc Ru—Ni nanotubes;

FIG. 31B shows the low-magnification HAADF-STEM images of 4H/fcc Ru—Ni nanotubes;

FIG. 31C shows the low-magnification HAADF-STEM images of 4H/fcc Ru—Ni nanotubes, with the white arrows indicating the Ni crystals which have the lower contrast;

FIG. 31D shows the HAADF-STEM image of a representative Ru—Ni dendrite with emphasized Ru/Ni boundary;

FIG. 32 shows the atomic-resolution HAADF-STEM image showing the outer edge and inner root of a Ru—Ni nanodendrite, with the FFT patterns of the selected regions (e) and (f) corresponding to 4H Ni and 4H Ru, respectively;

FIG. 33 shows the integrated pixel intensities along the arrows corresponding to the regions (e) and (f) marked in FIG. 32;

FIG. 34 shows the atomic-resolution HAADF-STEM image elucidating the lattice fringes of a 4H Ni domain near the edge;

FIG. 35 shows the atomic-resolution HAADF-STEM image showing the atomic arrangements in 4H and fcc domains of the Ru—Ni dendrites of FIG. 31D;

FIG. 36 shows the EDS spectrum of 4H/fcc Ru—Ni catalysts. Inset: a table showing the elemental ratios between Ru and Ni;

FIG. 37A shows the HAADF-STEM image of a single 4H/fcc Ru—Ni hierarchical nanotube;

FIG. 37B shows the EDS line-scan profiles j) across the single 4H/fcc Ru—Ni hierarchical nanotube indicated by the white dashed arrow in FIG. 37A;

FIG. 37C shows the HAADF-STEM image and the corresponding EELS elemental mapping of a single 4H/fcc Ru—Ni nanotube;

FIG. 37D shows the EELS line scan along the arrow in FIG. 37C, showing the presence of Ru and Ni signals at the two walls (S1 and S2) of the nanotube but with more Ni at the outer regions;

FIG. 38 shows the elemental mappings of Ru, Ni, and their mixture embedded in HAADF-STEM image of a 4H/fcc Ru—Ni nanotube;

FIG. 39 shows the high-resolution XPS spectra of Ru 3p orbits for 4H/fcc Ru—Ni, 4H/fcc Ru, 2H Ru and fcc Ni nanostructures;

FIG. 40 shows the high-resolution XPS spectra of Ni 2p orbits for 4H/fcc Ru—Ni, 4H/fcc Ru, 2H Ru and fcc Ni nanostructures;

FIG. 41 shows the normalized Ru K-edge XANES spectra of 4H/fcc Ru—Ni, 4H/fcc Ru and 2H Ru. Inset: the corresponding zoom-in graph showing their white line positions. Reference samples of Ru foil and RuO₂ are also included for comparison;

FIG. 42 shows the R-space EXAFS of 4H/fcc Ru—Ni, 4H/fcc Ru and 2H Ru;

FIG. 43A shows the k²-weighted R space fitting results at Ru K-edge for 4H/fcc Ru—Ni;

FIG. 43B shows the k²-weighted R space fitting results at Ru K-edge for 4H/fcc Ru;

FIG. 43C shows the k²-weighted R space fitting results at Ru K-edge for 2H Ru;

FIG. 43D shows the k²-weighted R space fitting results at Ru K-edge for Ru foil;

FIG. 44 shows the R-space EXAFS fitting of 4H/fcc Ru—Ni, 4H/fcc Ru and 2H Ru;

FIG. 45 shows the contour plots of wavelet transform of 4H/fcc Ru—Ni, 4H/fcc Ru and 2H Ru;

FIG. 46 shows the contour plots for wavelet transforms of Ru foil (left) and RuO₂ (right);

FIG. 47 is a table summarizing the fitting results of Ru K-edge EXAFS spectra for 4H/fcc Ru—Ni, 4H/fcc Ru, 2H Ru and Ru foil (So²=0.92);

FIG. 48 shows the galvanostatic discharge profiles of 4H/fcc Ru—Ni (left) and 2H Ru (right) cathodes in CO₂ or Ar;

FIG. 49 shows the full discharge specific capacities at 50 mA g¹ of the assembled aprotic Li—CO₂ cells with 4H/fcc Ru—Ni, 4H/fcc Ru, 2H Ru and CNT cathodes;

FIG. 50 shows the rate capabilities of the assembled aprotic Li—CO₂ cells with 4H/fcc Ru—Ni, 4H/fcc Ru, 2H Ru and CNT cathodes over the potential window of 2-4.5 V;

FIG. 51A shows the galvanostatic discharge-charge profiles at 50, 100, 250 and 500 mA g⁻¹ for 4H/fcc Ru—Ni cathodes with a curtailing capacity of 500 mAh g⁻¹ in CO₂;

FIG. 51B shows the galvanostatic discharge-charge profiles at 50, 100, 250 and 500 mA g⁻¹ for 4H/fcc Ru cathodes with a curtailing capacity of 500 mAh g⁻¹ in CO₂;

FIG. 51C shows the galvanostatic discharge-charge profiles at 50, 100, 250 and 500 mA g⁻¹ for 2H Ru cathodes with a curtailing capacity of 500 mAh g⁻¹ in CO₂;

FIG. 51D shows the galvanostatic discharge-charge profiles at 50, 100, 250 and 500 mA g⁻¹ for CNT cathodes with a curtailing capacity of 500 mAh g⁻¹ in CO₂;

FIG. 52 shows cyclic voltammetry profiles of 4H/fcc Ru—Ni, 4H/fcc Ru and 2H Ru cathodes at a sweep rate of 0.2 mV s⁻¹ over the potential window of 2.0-4.5 V in CO₂;

FIG. 53 shows the comparison of the discharge-charge profiles of 4H/fcc Ru—Ni and 2H Ru cathodes. The applied current density was set as 50 mA g⁻¹ and the curtailing capacity was set as 500 mAh g⁻¹;

FIG. 54 shows the comparison of the electrochemical cycling behaviours of as-prepared nanometal and CNT cathodes at low rates. The lines represent the discharge/charge profiles of 4H/fcc Ru—Ni, 4H/fcc Ru, 2H Ru and CNT cathodes within the initial 300 h at a current density of 50 mA g⁻¹ with a curtailing capacity of 500 mAh g⁻¹;

FIG. 55 shows the discharge-charge voltage differences of the assembled aprotic Li—CO₂ cells with 4H/fcc Ru—Ni, 4H/fcc Ru, 2H Ru and CNT cathodes over the potential window of 2-4.5 V;

FIG. 56 shows the energy efficiencies of the assembled aprotic Li—CO₂ cells with 4H/fcc Ru—Ni, 4H/fcc Ru, 2H Ru and CNT cathodes over the potential window of 2-4.5 V. The error bars are obtained based on three individual cycles;

FIG. 57 shows the discharge-charge profiles at 500 mA g⁻¹ of the assembled aprotic Li—CO₂ cells with 4H/fcc Ru—Ni, 4H/fcc Ru, 2H Ru and CNT cathodes over the potential window of 2-4.5 V;

FIG. 58 shows the galvanostatic discharge-charge profiles of the assembled aprotic Li—CO₂ cells with 4H/fcc Ru—Ni cathode at the selected cycles at 250 mA g⁻¹;

FIG. 59 shows the long-term cycling stability of the assembled aprotic Li—CO₂ cells with 4H/fcc Ru—Ni, 4H/fcc Ru, 2H Ru and CNT cathodes at the current density of 250 mA g⁻¹ with the curtailing capacity of 500 mAh g⁻¹;

FIG. 60 shows the comparison of the long-term cycling stability of as-prepared nanometal and CNT cathodes at high rates. The lines represent the discharge-charge profiles of 4H/fcc Ru—Ni, 4H/fcc Ru, 2H Ru and CNT cathodes during the long-term cycling at 250 mA g⁻¹ and 500 mAh g⁻¹, respectively;

FIG. 61 shows the comparison of the polarization gaps of as-prepared metallic nanocatalysts and CNT cathodes during long-term cycling stability measurements. The lines with different patterns represent the discharge-charge voltage differences of 4H/fcc Ru—Ni, 4H/fcc Ru, 2H Ru and CNT cathodes during cycling at 50 mA g⁻¹ within 500 mAh g⁻¹;

FIG. 62 shows the digital photographs showing the states of Li anodes extracted from the corresponding Li—CO₂ cells after the collapse of batteries running at 250 (left) and 500 (right) mA g⁻¹, respectively;

FIG. 63 shows the long-term cycling stability of the reconstructed Li—CO₂ cell with 4H/fcc Ru—Ni at 250 mA g⁻¹ with 500 mAh g⁻¹. The 4H/fcc Ru—Ni cathode was taken away carefully from the dead Li—CO₂ cell and then rinsed with DMSO and immersed in it for 3 days for mechanical recharge. After that, this 4H/fcc Ru—Ni cathode and a fresh Li disk were used to assemble a new Li—CO₂ cell;

FIG. 64A shows the comparison of several key electrochemical indexes between unconventional 4H/fcc Ru—Ni and the other representative catalysts for aprotic Li—CO₂ batteries;

FIG. 64B is a table summarizing the electrochemical performance of 4H/fcc Ru—Ni in this work with the other representative solid catalysts reported previously for aprotic Li—CO₂ batteries;

FIG. 65 shows the TEM images of the mixture of 4H/fcc Ru—Ni and commercial CNT at a weight ratio of 3/1 illustrating the distribution of the 4H/fcc Ru—Ni and the commercial CNT, with the magnification scale of 100 nm (left) and 50 nm (right), respectively;

FIG. 66A shows the SEM images of the 4H/fcc Ru—Ni cathodes at the pristine states, with the magnification scale of 5 μm (left) and 2 μm (right), respectively;

FIG. 66B shows the SEM images of the 4H/fcc Ru—Ni cathodes at the 1^{st} discharged states during cycling at 50 mA g⁻¹, with the magnification scale of 5 μm (left) and 2 μm (right), respectively;

FIG. 67A shows the TEM image of aggregations extracted from a 4H/fcc Ru—Ni cathode after discharging to 500 mAh g⁻¹ at 50 mA g⁻¹;

FIG. 67B shows the SAED pattern of aggregations extracted from a 4H/fcc Ru—Ni cathode after discharging to 500 mAh g⁻¹ at 50 mA g⁻¹;

FIG. 67C shows the HRTEM images of aggregations extracted from a 4H/fcc Ru—Ni cathode after discharging to 500 mAh g⁻¹ at 50 mA g⁻¹, with a magnification scale of 10 nm;

FIG. 67D shows the HRTEM images of aggregations extracted from a 4H/fcc Ru—Ni cathode after discharging to 500 mAh g⁻¹ at 50 mA g⁻¹, with a magnification scale of 2 nm;

FIG. 68A shows the HAADF-STEM image of the agglomerations extracted from the 4H/fcc Ru—Ni cathode after discharging;

FIG. 68B is a magnified image of the FIG. 68A;

FIG. 68C shows an EELS spectra of C K-edge acquired from the dashed square marked in FIG. 68B;

FIG. 68D shows an EELS spectra of Li K-edge acquired from the dashed square marked in FIG. 68B;

FIG. 69 the SEM images of the 4H/fcc Ru—Ni cathodes at the 1^{st} recharged states during cycling at 50 mA g⁻¹, with the magnification scale of 5 μm (left) and 2 μm (right), respectively;

FIG. 70 shows the TEM images of the active materials extracted from a 4H/fcc Ru—Ni cathode after fully recharging at 50 mA g⁻¹, with a magnification of 50 nm (left) and 20 nm (right), respectively;

FIG. 71A shows the SEM images of 2H Ru cathodes at the 1^{st} discharged states during cycling at 50 mA g⁻¹, with a magnification scale of 5 μm (left) and 2 μm (right), respectively;

FIG. 71B shows the SEM images of 2H Ru cathodes at the 1^{st} recharged states during cycling at 50 mA g⁻¹, with a magnification scale of 5 μm (left) and 2 μm (right), respectively. Some undecomposed discharge products can be recognized on the 2H Ru cathode surface;

FIG. 72A shows the SEM images of 4H/fcc Ru—Ni cathodes after discharging to 500 mAh g⁻¹ at the current density of 500 mA g⁻¹, with a magnification scale of 10 μm (left) and 2 μm (right), respectively;

FIG. 72B shows the SEM images of 4H/fcc Ru—Ni cathodes after discharging to 2500 mAh g⁻¹ at the current density of 500 mA g⁻¹, with a magnification scale of 10 μm (left) and 2 μm (right), respectively;

FIG. 72C shows the SEM images of 4H/fcc Ru—Ni cathodes after discharging to 5000 mAh g⁻¹ at the current density of 500 mA g⁻¹, with a magnification scale of 10 μm (left) and 2 μm (right), respectively;

FIG. 73A shows the SEM images of 2H Ru—Ni cathodes after discharging to 500 mAh g⁻¹ at the current density of 500 mA g⁻¹, with a magnification scale of 10 μm (left) and 2 μm (right), respectively;

FIG. 73B shows the SEM images of 2H Ru—Ni cathodes after discharging to 500 mAh g⁻¹ at the current density of 2500 mA g⁻¹, with a magnification scale of 10 μm (left) and 2 μm (right), respectively;

FIG. 73C shows the SEM images of 2H Ru—Ni cathodes after discharging to 500 mAh g⁻¹ at the current density of 5000 mA g⁻¹, with a magnification scale of 10 μm (left) and 2 μm (right), respectively;

FIG. 74A shows the Raman spectra of 4H/fcc Ru—Ni cathodes after discharging to 0, 500, 2500, 5000 mAh g⁻¹ and then fully recharging at 500 mA g⁻¹;

FIG. 74B shows the Raman spectra of 2H Ru cathodes after discharging to 0, 500, 2500, 5000 mAh g⁻¹ and then fully recharging at 500 mA g⁻¹;

FIG. 75 shows the XRD patterns of 4H/fcc Ru—Ni (left) and 2H Ru (right) cathodes after discharging to 0, 2500 and 5000 at 500 mA g⁻¹. Inset: a photograph displaying the discharged cathode sealed by polyimide membrane for XRD tests;

FIG. 76A shows the discharge-charge profiles at 500 mA g⁻¹ of the 4H/fcc Ru—Ni cathode with a larger mass loading during this high-rate cycle;

FIG. 76B shows the in-situ Raman spectra of the 4H/fcc Ru—Ni cathode with a larger mass loading during this high-rate cycle;

FIG. 77 shows the high-resolution C is XPS spectra of 4H/fcc Ru—Ni and 2H Ru cathodes after the first discharge process at 500 mA g⁻¹;

FIG. 78 shows the high-resolution Ni 2p XPS spectra of 4H/fcc Ru—Ni cathode at the 1^{st} discharged and recharged states;

FIG. 79A shows the high-resolution Ru 3p XPS spectra of 4H/fcc Ru—Ni (left) and 2H Ru (right) cathodes at the 1^{st} discharged state;

FIG. 79B shows the high-resolution Ru 3p XPS spectrum of 4H/fcc Ru—Ni cathodes at the 1^{st} recharged state;

FIG. 80A shows the SEM images of 4H/fcc Ru—Ni cathodes at the discharged state of the 30^{th} cycle, with a magnification scale of 20 μm (left) and 2 μm (right), respectively;

FIG. 80B shows the SEM images of 4H/fcc Ru—Ni cathodes at the recharged state of the 30^{th} cycle, with a magnification scale of 20 μm (left) and 2 μm (right), respectively;

FIG. 80C shows the SEM images of 4H/fcc Ru—Ni cathodes at the discharged state of the 60^{th} cycle, with a magnification scale of 20 μm (left) and 2 μm (right), respectively;

FIG. 80D shows the SEM images of 4H/fcc Ru—Ni cathodes at the recharged state of the 60^{th} cycle, with a magnification scale of 20 μm (left) and 2 μm (right), respectively;

FIG. 81 shows the high-resolution C is XPS spectrum of the 4H/fcc Ru—Ni cathode after discharging to 500 mAh g⁻¹ at 250 mA g⁻¹ at the 60^{th} cycle;

FIG. 82 shows the SEM images of 4H/fcc Ru—Ni cathodes at the discharged state (left) and the recharged state (right) of the 150^{th} cycle;

FIG. 83A shows the HRTEM images of 4H/fcc Ru—Ni nanostructures after cycling, in which 4H and fcc domains are marked by the white solid arrows and white hollow dashed arrows, respectively;

FIG. 83B shows the HRTEM images and the FFT patterns of the selected-area (d) and (f) marked in the HRTEM images;

FIG. 84 shows the EDS spectrum of the 4H/fcc Ru—Ni cathode after cycling. Inset: a table showing the elemental ratios between Ru and Ni;

FIG. 85 shows the high-resolution Ru 3p (left) and Ni 2p (right) XPS spectra of 4H/fcc Ru—Ni cathodes at the recharged state after 150 cycles;

FIG. 86 shows the in-situ DEMS patterns and the corresponding charge profiles of 4H/fcc Ru—Ni at 250 μA;

FIG. 87 shows the in-situ DEMS patterns and the corresponding charge profiles of 2H Ru at 250 μA;

FIG. 88A shows the CO signal intensity (m/z=28) by the fragments of CO₂ in recorded in the DEMS analysis of CO gas during recharging on 4H/fcc Ru—Ni and 2H Ru cathodes.

FIG. 88B shows the gas evolution rates of CO₂ and real CO after correction on 4H/fcc Ru—Ni (left) and 2H Ru (right) cathodes;

FIG. 89 shows the ¹H NMR spectra of 3 M LiTFSI-DMSO (a) 25%ᵥₒₗ. EmimBF₄-3 M LiTFSI-DMSO (b) 30 mM DMA-25%ᵥₒₗ. EmimBF₄-3 M LiTFSI-DMSO (c) DMSO-d₆ rinse solutions for 2H Ru (d) and 4H/fcc Ru—Ni (e) cells after 50 cycles at 250 mA g⁻¹ and 500 mAh g⁻¹;

FIG. 90 is a schematic diagram illustrating the mechanism differences of Li—CO₂ electrochemistry on 4H/fcc Ru—Ni and 2H Ru;

FIG. 91 shows the rate performances of the as-constructed Li-air cells with 4H/fcc Ru—Ni and 2H Ru;

FIG. 92A shows the galvanostatic discharge-charge profiles of the assembled Li-air cells with 4H/fcc Ru—Ni at 50, 100, 250 and 500 mA g⁻¹ with a curtailing capacity of 500 mAh g⁻¹ in ambient air at Hong Kong;

FIG. 92B shows the galvanostatic discharge-charge profiles of the assembled Li-air cells with 2H Ru at 50, 100, 250 and 500 mA g⁻¹ with a curtailing capacity of 500 mAh g⁻¹ in ambient air at Hong Kong;

FIG. 92C shows the temperature and relative humidity variations during the test period of the constructed Li-air cells. Note that the more detailed weather information during the measurements could be found in the official statistical reports entitled “Monthly Weather Summary for September 2023” (https://www.hko.gov.hk/en/wxinfo/pastwx/mws/mws.htm);

FIG. 93 shows the discharge-charge profiles at 500 mA g⁻¹ of the as-constructed Li-air cells with 4H/fcc Ru—Ni and 2H Ru;

FIG. 94 shows the cycling behaviors of the as-constructed Li-air cells with 4H/fcc Ru—Ni and 2H Ru;

FIG. 95A shows the digital photograph displaying the configuration of the as-fabricated Li-air pouch cell;

FIG. 95B shows the digital photograph displaying a light toy powered by the battery device; and

FIG. 96 shows the digital photographs illustrating a commercial LED screen lightened by the flexible Li-air pouch cell series at different bending angles and after 12-h continuous power supply.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

One of the possible solutions to mitigate the aforementioned shortcomings suffered by the current alkali metal-gas batteries such as Li—CO₂ and Li—O₂/air batteries might be using appropriate redox mediators dissolved in electrolytes. Another possible solution might be using carbon materials such as super P, Ketjen blacks, carbon nanotubes (CNTs) and graphenes as cathode catalysts. However, it is believed that these materials may suffer from low catalytic activities, leading to high charge potential (usually >4.2 V) which enables the decomposition of Li₂CO₃ even at low current densities. There are also some reports on hybridizing the carbon materials with metals/alloys such as Ru, Ir, Ni, Fe, Co, Cu, RuCo, RuRh, etc., and/or metal compounds such as Mo₂C, VN, IrO₂, etc. to promote the reaction kinetics and reversibility of Li—CO₂ electrochemistry.

Without wishing to be bound by theory, the inventors have, through their own researches, trials, and experiments, devised that the kinetics and reversibility of carbon redox reactions (carbon reduction reaction (CO₂RR) and carbon dioxide evolution reaction (CO₂ER)) of the alkali metal-gas batteries may be enhanced/catalyzed by an unconventional heterophase metal-metal Janus nanostructure, particularly an unconventional 4H/face centered cubic (fcc) noble metal-non-precious metal (also known as base metal) Janus nanostructure. As illustrated in the present disclosure, the unconventional 4H/fcc noble metal-non-precious metal Janus nanostructure may act as a bifunctional cathode catalyst to facilitate the reversibility and decomposition kinetics of discharge products in, for example, aprotic Li—CO₂ and Li-air batteries. It is believed that the noble metal of the Janus nanostructure may act as electrophilic sites for CO₂RR and at the same time the non-precious metal of the Janus nanostructure may act as nucleophilic sites for CO₂ER. In other words, the Janus nanostructure may include different sites for CO₂RR and CO₂ER (i.e., decoupled CO₂RR and CO₂ER sites). It is also believed that the unconventional 4H/fcc noble metal-non-precious metal Janus nanostructure may be capable of reducing the leakage of corrosive ¹O₂ and O₂^{·-} species upon charging at high rates. Accordingly, as illustrated in some example embodiments of the present disclosure, the aprotic Li—CO₂ and Li-air batteries with cathode containing the unconventional 4H/fcc noble metal-non-precious metal Janus nanostructure may have a high-rate discharge-charge electrochemical behavior, ultra-small minimum overpotential gap of, e.g., 0.65 V, and long-term cycling stability of at least 150 cycles at least 250 mA g⁻¹.

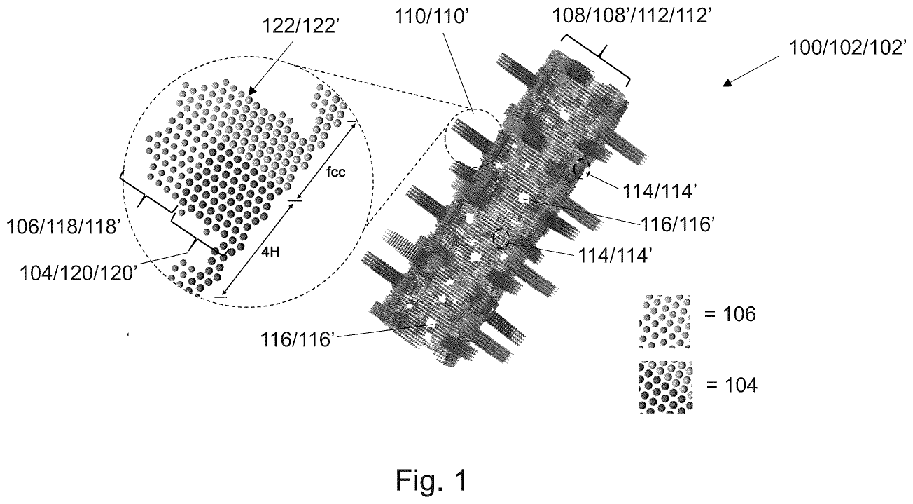

In a first aspect of the present invention, there is provided a catalytic nanomaterial comprising a Janus hollow nanostructure of a heterophase noble metal and a heterophase non-precious metal. The catalytic nanomaterial in accordance with various embodiments of the present invention may have a Janus nanostructure as exemplified in FIG. 1. With reference to FIG. 1, the catalytic nanomaterial 100 may include a Janus hollow nanostructure 102 of a heterophase noble metal 104 and a heterophase non-precious metal 106. The Janus hollow nanostructure 102 may include a tubular structure 108 with one or more protrusions 110 extending from the tubular structure. In particular, the tubular structure and the protrusions may be each being a formation of the heterophase noble metal 104 and a heterophase non-precious metal 106.

In some embodiments, the tubular structure 108 may include a heterophase noble metal tubular formation 112 with scattered heterophase non-precious metal crystal formations 114. In particular, the heterophase noble metal tubular formation may include a wall formed with one or more pores/holes, particularly nanopores/nanoholes 116. In other words, the heterophase noble metal tubular formation may be porous.

The one or more protrusions 110 may axially extend from the tubular structure. In particular, the one or more protrusions may include a heterophase non-precious metal section 118 deposited on a heterophase noble metal section 120, thereby defining an interface 122 between the heterophase non-precious metal section and the heterophase noble metal section.

In some embodiments, the heterophase noble metal may comprise a 4H/face centered cubic (fcc) noble metal and the heterophase non-precious metal comprises a 4H/fcc non-precious metal. In some particular embodiments, the heterophase noble metal may be selected from the group consisting of Ru, Rh, Ir, Pd, and Pt. In some particular embodiments, the heterophase non-precious metal may be selected from the group consisting of Ni, Co, Fe, and Zn.

In an exemplary embodiment, the heterophase noble metal may comprise 4H/fcc Ru and the heterophase non-precious metal may comprise 4H/fcc Ni. Referring to FIG. 1, the catalytic nanomaterial 100 in this embodiment includes a Janus nanostructure 102′, which has a tubular structure 108′ being a porous 4H/fcc Ru nanotube 112′ scattered with 4H/fcc Ni crystals 114′, and has one or more protrusions being dendritic structures 110′ axially protruding from the nanotube. In particular, the 4H/fcc Ni crystals 114′ are epitaxially, particularly quasi-epitaxially deposited on the porous 4H/fcc Ru nanotube 112′. The dendritic structures 110′ include a heterophase non-precious metal section 118′ comprising epitaxial deposition, particularly quasi-epitaxial deposition of 4H/fcc Ni crystals on a heterophase noble metal section 120′ of 4H/fcc Ru, thereby defining a Ru—Ni interface 122′. The porous 4H/fcc Ru nanotube 112′ also comprises a wall formed with a plurality of nanoholes 116′. As used herein, the terms/phrases of “quasi-epitaxial growth/deposition”,” quasi-epitaxially growing/depositing” generally denote that there are some lattice mismatches that leads to the formation of conventional phase of the second metal (e.g. Ni in this embodiment) even on the unconventional phase region of the parent metal (e.g. Ru in this embodiment).

The porous 4H/fcc Ru nanotube 112′ may have a diameter ranging from about 20 nm to about 40 nm, such as 18 nm . . . 18.2 nm . . . 18.6 nm . . . 20.1 nm . . . 22 nm . . . 22.8 nm . . . 23 nm . . . 26 nm . . . 26.4 nm . . . 27 nm . . . 31 nm . . . 35 nm . . . 38 nm . . . 40 nm . . . 40.5 nm . . . 41 nm . . . 42 nm and the like. The nanotube wall of the porous 4H/fcc Ru nanotube may be of about 2 nm thick such as about 1.7 nm, 1.75 nm, 1.8 nm, 1.82 nm, 1.86 nm, 1.9 nm, 1.99 nm, 2 nm, 2.01 nm, 2.1 nm and the like.

The dendritic structures may have an average diameter from about 8 nm to about 10 nm, such as 7 nm . . . 7.5 nm . . . 7.8 nm . . . 8 nm . . . 8.3 nm . . . 8.7 nm . . . 9 nm . . . 9.6 nm . . . 10 nm . . . 10.2 nm . . . 10.4 nm . . . 11 nm and the like.

The atomic ratio of the heterophase noble metal and the heterophase non-precious metal may be tunable in various embodiments of the present invention. In this exemplary embodiment, the Ru and Ni may have an atomic ratio of about 72.5:27.5, such as 72:27.3, 72:27.4, 72.4:27.4, 72.5:27.5, 72.6:27.6 and the like.

The catalytic nanomaterial 100′ is preferably to be in powder form. It is believed that with such a physical form, it may be beneficial for the preparation of flexible cathode.

Without wishing to be bound by theory, it is believed that the 4H/fcc Ru may provide a carbon dioxide reduction reaction (CO₂RR) active site and the 4H/fcc Ni may provide a carbon dioxide evolution reaction (CO₂ER) active site, thereby the catalytic nanomaterial 100 may act as a bifunctional catalyst. In particular, it is believed that the unusual 4H phases of Ru/Ni may effectively lower the energy barriers and promote the intermediate steps of CO₂ redox reactions. It is also believed that the co-existence of these decoupled CO₂RR/CO₂ER sites (i.e., CO₂RR and CO₂ER do not occur on the same metal site but on different sites) may facilitate the reduction of the release of corrosive oxygen species generated during the operation of alkali metal-gas batteries. Thus, it is believed that the catalytic nanomaterial may enable fast recharging, high energy efficiency and long cycle life of the alkali metal-gas batteries. Accordingly, it is believed that the catalytic nanomaterial is particularly suitable for cathodic application in alkali metal-gas batteries.

The method for synthesizing the catalytic nanomaterial as described herein will now be disclosed.

The method may comprise the steps of: epitaxially growing a 4H/fcc noble metal on a 4H/fcc Au nanorod; selectively etching the 4H/fcc Au nanorod to obtain a hollow 4H/fcc noble metal nanotube with a plurality of dendritic structures; and quasi-epitaxially growing a 4H/fcc non-precious metal on the hollow 4H/fcc noble metal nanotube to obtain a Janus hollow nanostructure of the 4H/fcc noble metal and the 4H/fcc non-precious metal.

The epitaxial growing step may include the steps of providing a first reaction mixture containing 4H/fcc Au nanorod, a noble metal precursor, a reductant, and a surfactant; optionally carrying out a first heat treatment to remove low-boiling impurities from the first reaction mixture; and carrying out a second heat treatment for the epitaxial growth of the 4H/fcc noble metal on a 4H/fcc Au nanorod to obtain a 4H/fcc Au@noble metal nanorod.

The noble metal precursor may be in form of a coordination compound of the noble metal. Examples of coordination ligands for the noble metal may include halides, sulfate, carbonyl, ammine, oxalate, acetate, formate, phosphine, diamine, cyclopentadienyl, arenes, etc.

The reductant may be selected from the group consisting of 1,2-hexadecanediol and 1,4-butanediol. In some particular embodiments, the reductant may be 1,2-hexadecanediol. The surfactant may be selected from the group consisting of oleylamine and hexadecylamine. In some particular embodiments, the surfactant may be oleylamine.

The first heat treatment may be carried out under reduced pressure such as under vacuum at a temperature from about 100° C. to about 120° C., about 95° C. to about 120° C., about 98° C. to about 125° C., about 98° C. to about 118° C., about 105° C. to about 120° C., about 105° C. to about 115° C., particularly at about 110° C. In some embodiments, the first heat treatment may be carried out for from about 20 mins to about 30 mins, about 18 mins to about 30 mins, about 20 mins to about 28 mins, about 22 mins to about 30 mins, about 22 mins to about 28 mins, particularly for about 25 mins.

The second heat treatment may be carried out under an inert atmosphere such as under argon or nitrogen, at a temperature from about 215° C. to about 230° C., about 215° C. to about 232° C., about 213° C. to about 230° C., about 218° C. to about 230° C., about 218° C. to about 228° C., about 220° C. to about 230° C., about 222° C. to about 228° C. particularly at about 225 CC.

After the second heat treatment, the 4H/fcc Au@noble metal nanorod may be isolated from the first reaction mixture by way of, for example centrifugation and/or washing with a suitable solvent or solvent mixture.

The selective etching step may be carried out by heat treating a second reaction mixture containing the 4H/fcc Au@noble metal nanorod and an etching agent such as CuCl₂ at a temperature from about 70° C. to about 100° C., about 72° C. to about 100° C., about 70° C. to about 98° C., about 75° C. to about 90° C., about 70° C. to about 90° C., about 75° C. to about 85° C., particularly at about 80° C., for at least 24 hours such as for about 36 hours. After that a hollow 4H/fcc noble metal nanotube with a plurality of dendritic structures may be obtained and may be isolated from the second reaction mixture by way of, for example centrifugation and/or washing with a suitable solvent or solvent mixture.

The quasi-epitaxial growing step may be similar to the epitaxial growing step as described herein. In particular, the quasi-epitaxial growing step may include the steps of providing a third reaction mixture containing the hollow 4H/fcc noble metal nanotube, a non-precious metal precursor, a reductant such as 1,2-hexadecanediol, a surfactant such as oleylamine, and a capping agent-releasing compound such as Mo(CO)₆, W(CO)₆, Cr(CO)₆ and the like for releasing CO as capping agent; optionally carrying out a third heat treatment to remove low-boiling impurities from the third reaction mixture; and carrying out a fourth heat treatment for the quasi-epitaxial growth of the 4H/fcc non-precious metal on the hollow 4H/fcc noble metal nanotube to obtain the Janus hollow nanostructure of the 4H/fcc noble metal and the 4H/fcc non-precious metal (i.e., 4H/fcc noble metal-non-precious metal Janus hollow nanostructure).

The non-precious metal precursor may be in form of a coordination compound of the non-precious metal. Examples of coordination ligands for the non-precious metal may include halides, sulfate, carbonyl, ammine, oxalate, acetate, formate, phosphine, diamine, cyclopentadienyl, arenes, etc.

The capping agent-releasing compound may be dissolved and in solution form in the third reaction mixture. It is appreciated that the capping agent-releasing compound will remain (chemically) stable during the third heat treatment, and will only decompose to release the capping agent (e.g., CO) during the fourth heat treatment.

The third heat treatment may be carried out under reduced pressure such as under vacuum at a temperature from about 70° C. to about 100° C., about 72° C. to about 100° C., about 70° C. to about 98° C., about 75° C. to about 90° C., about 70° C. to about 90° C., about 75° C. to about 85° C., particularly at about 80° C. In some embodiments, the third heat treatment may be carried out for from about 20 mins to about 30 mins, about 18 mins to about 30 mins, about 20 mins to about 28 mins, about 22 mins to about 30 mins, about 22 mins to about 28 mins, particularly for about 25 mins.

The fourth heat treatment may be carried out under an inert atmosphere such as under argon or nitrogen, at a temperature from about 140° C. to about 180° C., about 138° C. to about 180° C., about 140° C. to about 182° C., about 143° C. to about 178° C., about 145° C. to about 180° C., about 148° C. to about 170° C., about 150° C. to about 170° C., about 155° C. to about 180° C., about 155° C. to about 168° C., particularly at about 160° C., for at least 10 mins, such as for 15 mins.

After the fourth heat treatment, the 4H/fcc noble metal-non-precious metal Janus hollow nanostructure may be isolated from the third reaction mixture by way of, for example centrifugation and/or washing with a suitable solvent or solvent mixture.

As described herein, in some embodiments, the noble metal may be selected from the group consisting of Ru, Rh, Ir, Pd, and Pt, and the non-precious metal may be selected from the group consisting of Ni, Co, Fe, and Zn.

In an exemplary embodiment, the noble metal may be Ru and the non-precious metal may be Ni. In this embodiment, the method may be used to preparing the 4H/fcc Ru—Ni Janus hollow nanostructure as described herein. The method may comprise the steps of: epitaxially growing 4H/fcc Ru on the 4H/fcc Au nanorod in the presence of 1, 2-hexadecanediol and oleylamine under heat treatment; selectively etching the 4H/fcc Au nanorod in a solution mixture of 0.1 M CuCl₂ and DMF under heat treatment to obtain a hollow 4H/fcc Ru nanotube with a plurality of 4H/fcc Ru dendritic structures; and quasi-epitaxially growing 4H/fcc Ni on the hollow 4H/fcc Ru nanotube with a plurality of 4H/fcc Ru dendritic structures in the presence of 1, 2-hexadecanediol and oleylamine under heat treatment to obtain the 4H/fcc Ru—Ni Janus hollow nanostructure.

Also pertain to the present invention is an aprotic alkali metal-gas battery comprising the catalytic nanomaterial as described herein, wherein the battery is selected from the group consisting of aprotic Li—CO₂ battery, aprotic Li-air battery, aprotic Na—CO₂ battery, aprotic Na-air battery, aprotic K—CO₂ battery and aprotic K-air battery.

In some embodiments, the aprotic alkali metal-gas battery may comprise a cathode having the catalytic nanomaterial as described herein, and the cathode may be positioned in an aprotic electrolyte along with an alkali metal anode.

The cathode may further include a conductive carbon material and a binder. In some embodiments, the conductive carbon material may be selected from the group consisting of graphene, carbon nanotubes (CNTs), carbon blacks, carbon paper, carbon cloth and a combination thereof. In some particular embodiments, the cathode may further include a support selected from the group consisting of carbon paper, carbon cloth and a combination thereof.

The binder may include Nafion. It is appreciated that any other suitable binder may be used in accordance with practical needs.

In some embodiments, the cathode may have a weight ratio of the catalytic nanomaterial:conductive carbon material:binder may be of about 50-90:10-30:1-20, such as about 2.7:0.9:0.4. In some embodiments, the cathode may also have a mass loading of a mixture of the catalytic nanomaterial and the conductive carbon material of about 0.2 mg cm⁻³ to about 0.3 mg cm⁻³.

The alkali metal anode may vary in accordance with practical needs. For example, it is appreciated that a Li metal anode will be used in a Li-gas battery, a Na metal anode will be used in a Na-gas battery, a K metal anode will be used in a K-gas battery, etc. It is also appreciated that the alkali metal anode may be of various shapes and/or dimensions in accordance with practical needs. For example, the alkali metal anode may be in form of a foil, a plate, a rod, a disk, etc.

The aprotic electrolyte may include an alkali metal salt and an ionic liquid. In particular, the alkali metal salt may vary in accordance with practical needs. For example, a Li salt may be used in a Li-gas battery, a Na salt may be used in a Na-gas battery, a K salt may be used in a K-gas battery and the like. The alkali metal salt may include any one of the following anions: hexafluorophosphate, perchlorate, nitrate, tetrafluoroborate, bistrifluoromethane sulfonimide, difluorosulfonimide, and triflate.

In some embodiments where the aprotic alkali metal-gas battery is a Li-gas battery, the alkali metal salt may be a Li salt selected from the group consisting of lithium hexafluorophosphate (LiPF₆), lithium perchlorate (LiClO₄), lithium nitrate (LiNO₃), lithium tetrafluoroborate (LiBF₄), lithium bistrifluoromethane sulfonimide (LiTFSI), lithium difluorosulfonimide (LiFSI), lithium triflate (LiCF₃SO₃) and a combination thereof.

In some embodiments where the aprotic alkali metal-gas battery is a Na-gas battery, the alkali metal salt may be a Na salt selected from the group consisting of sodium hexafluorophosphate (NaPF₆), sodium perchlorate (NaClO₄), sodium nitrate (NaNO₃), sodium tetrafluoroborate (NaBF₄), sodium bistrifluoromethane sulfonimide (NaTFSI), sodium difluorosulfonimide (NaFSI), sodium triflate (NaCF₃SO₃) and a combination thereof.

In some embodiments where the aprotic alkali metal-gas battery is a K-gas battery, the alkali metal salt may be a K salt selected from the group consisting of potassium hexafluorophosphate (KPF₆), potassium perchlorate (KClO₄), potassium nitrate (KNO₃), potassium tetrafluoroborate (KBF₄), potassium bistrifluoromethane sulfonimide (KTFSI), potassium difluorosulfonimide (KFSI), potassium triflate (KCF₃SO₃) and a combination thereof.

The alkali metal salt may have a concentration of about 0.1 M to about 4 M, such as 0.1 M . . . 0.12 M . . . 0.2 M . . . 0.35 M . . . 0.4 M . . . 1 M . . . 1.1 M . . . 1.5 M . . . 2 M . . . 2.6 M . . . 3 M . . . 3.3 M . . . 4 M and the like. In some particular embodiments, the alkali metal salt may have a concentration of about 3 M.

The ionic liquid may be an imidazolium-based such as a 1-ethyl-3-methylimidazolium-based ionic liquid. In some embodiments, the ionic liquid may be selected from the group consisting of 1-ethyl-3-methylimidazole tetrafluoroborate ([Emim]BF₄), 1-ethyl-3-methylimidazole bistrifluoromethosulfonimide ([Emim]TFSI), 1-ethyl-3-methylimidazole difluorosulfonimide ([Emim]FSI), 1-Ethyl-3-methylimidazolium chloride ([Emim]Cl) and a combination thereof.

In some embodiments, the aprotic electrolyte may include about 5% to about 50%, about 4.5% to about 50%, about 5% to about 51%, about 5% to about 50.5%, about 8% to about 49%, about 10% to about 50%, about 5% to about 45%, about 15% to about 45%, about 20% to about 50%, about 20% to about 35%, about 20% to about 30%, particularly about 25% by volume of the ionic liquid.

In some exemplary embodiments, the aprotic alkali metal-gas battery may be an aprotic Li—CO₂ battery or an aprotic Li-air battery. In these embodiments, these batteries may share a substantially the same configuration, except that each of these batteries is operated under different gaseous environments, i.e., CO₂ for the aprotic Li—CO₂ battery whereas ambient air or compressed air for the aprotic Li-air battery. The aprotic Li—CO₂ or the protic Li-air battery may comprise a Li-based aprotic electrolyte; a Li metal anode such as a Li metal foil; a cathode including the 4H/fcc Ru—Ni Janus hollow nanostructure as described herein; and a separator such as a glass fiber disposed between the Li metal anode and the cathode.

In particular, the Li-based aprotic electrolyte may include a DMSO solution of a Li salt as described herein, and about 5% to about 50% by volume, such as about 25% by volume of an ionic liquid as described herein.

The cathode of the aprotic Li—CO₂ or the aprotic Li-air battery may further include a conductive carbon material as described herein and a binder as described herein. In particular, the cathode may have a weight ratio of 4H/fcc Ru—Ni Janus hollow nanostructure:conductive carbon material:binder of about 2.7:0.9:0.4. The cathode may also have a mass loading of a mixture of the 4H/fcc Ru—Ni Janus hollow nanostructure and the conductive carbon material of about 0.2 mg cm⁻³ to about 0.3 mg cm⁻³.

As mentioned, the catalytic nanomaterial may act as a bifunctional catalyst to facilitate the reversibility and decomposition kinetics of discharge products in aprotic alkali metal-gas batteries such as Li—CO₂ and Li-air batteries. Thus, it is believed that the aprotic alkali metal-gas batteries as described herein may exhibit a higher-rate discharge-charge electrochemical behavior, ultra-small minimum overpotential gap, and long-term cycling stability as discussed in the later part of the present disclosure.

Hereinafter, the present invention is described more specifically by way of examples, but the present invention is not limited thereto.

### EXAMPLES

### Materials

Gold(III) chloride hydrate (HAuCl₄·xH₂O, 52% Au basis), triruthenium dodecacarbonyl (Ru₃(CO)₁₂, AR), ruthenium acetylacetonate (Ru(acac)₃, ACS reagent, ≥99.0%), nickel formate dihydrate (Ni(HCOO)₂·2H₂O, ≥99.0%), copper chloride dihydrate (CuCl₂·2H₂O, ≥99.0%), 1,2-hexadecanediol (1,2-HDD, AR), ascorbic acid (L-AA, ≥99.0%), n-heptane (anhydrous, 99%), oleylamine (OAm, 70%, technical grade), N-ethylcyclohexylamine (AR, 99.9%), n-hexane (anhydrous, 99.5%), ethanol (≥99.9%), Nafion solution (5%), lithium bis-trifluoromethanesulfonimide (LiTFSI, ACS reagent, ≥99.0%), dimethylsulfoxide (DMSO, anhydrous, ≥99.0%), 1-ethyl-3-methylimidazole tetrafluoroborate ([Emim]BF₄, 99% for electrochemistry), N, N-dimethylformamide (DMF, anhydrous, ≥99.0%) and the other chemicals without special mention were purchased from Sigma-Aldrich. Carbon paper (Toray TGP-H-060) and multi-walled carbon nanotubes (CNTs) were purchased from Fuel Cell Earth. Ultrapure Milli-Q water (Milli-Q System, Millipore) was used in the experiments. All the chemicals were used as received without any further purification.

### Characterization

XRD measurements were conducted on a Rigaku SmartLab SE X-ray diffractometer using Cu K_{α} radiation at a wavelength of 1.5406 Å. SEM and EDS data were acquired by a Thermo Fisher Scientific (TFS) Quattro S scanning electron microscope operated at 15 kV. TEM images and EELS results were collected on a field emission JEM-2100F (JEOL, Japan) operated at 200 kV. The HAADF-STEM images and EDS elemental mapping were obtained on a double aberration-corrected Spectra 300 TEM/STEM (TFS, USA) operated at 300 kV and equipped with a Super-X EDS spectrometer (TFS, USA). Raman spectra were recorded on the LabRAM HR Raman spectrometer with laser excitation at 514.5 nm from an Ar ion laser source. XPS analysis was based on a ESCALAB 220i-XL electron spectrometer from VG Scientific using 300 W Al KR radiation (base pressure <10⁻⁵ mbar). The detection of ¹O₂ in electrolyte was carried out using the nuclear magnetic resonance spectroscopy (NMR 300 MHz, Bruker AVANCE III BBO Probe). The XAS data were collected in total fluorescence mode, which was conducted at beamline 12B of Taiwan beamline at Spring-8 of National Synchrotron Radiation Research Center (NSRRC). The electron storage ring was operated at 8.0 GeV with a constant current of ˜400 mA. The incident beam energy was monochromatized by a Si(111) double crystal monochromator.^{[6]} The XAS-related data processing was conducted using Athena and Artemis software packages.

### Electrochemical Measurements

The electrochemical performance of Li—CO₂ batteries was evaluated using CR2032 coin-type cells with several holes on the cathode side to allow CO₂ permeation. A slice of Toray carbon paper (H-060) coated with the obtained metal catalysts was used as the cathode, while a piece of commercial lithium chip acted as the counter and reference electrodes. The glass fiber (Whatman, GF/D) was used as the separator. The electrolyte is 3 M LiTFSI dissolved in DMSO added with 25%ᵥₒₗ. EmimBF₄. Note that 120 μL of the electrolyte were utilized in every Li—CO₂ cell. The assembly of Li—CO₂ battery cells was conducted in an Ar-filled glove box with the H₂O and O₂ concentrations less than 1 ppm. The assembled Li—CO₂ batteries were tested in a dried and sealed chamber which was pumped with pure CO₂ gas at 80 sccm for at least 15 min to ensure the gas purity inside. To ensure the sufficient diffusion of CO₂, it required a rest period of 18 h for stabilization before tests.

Cyclic voltammetry (CV) measurement was conducted on the electrochemical workstation (Ivium-n-Stat, Netherlands) at a scan rate of 0.2 mV s⁻¹ over the potential window of 2.0-4.5 V (vs. Li⁺/Li). The galvanostatic discharge/charge measurements of these Li—CO₂ batteries were carried out on the electrochemical workstation (LAND CT2001 Å) under different experimental parameters at room temperature.

The Li-air cells were assembled and measured along the same process with that of Li—CO₂ cells except for replacing CO₂ gas with commercial compressed air to fill the test chambers.

When conducting long-term cycling stability tests for Li-air batteries, Li anodes protected by artificial solid electrolyte interface (SEI) layers were utilized rather than fresh Li disks to assemble the cells. The artificial SEI layers on Li anodes were generated after the Li—CO₂ cells with CNT cathodes operated at 500 mA g⁻¹ and 500 mAh g⁻¹ for 10 cycles.

In-situ differential electrochemical mass spectrometry (DEMS) test for gas evolution was performed on a Linglu DEMS analysis system, where the coin-type cells using nanometal cathodes with the mass loading of ˜1 mg were firstly discharged at 250 μA for 4 h in the commercial gas containers filled with CO₂ and then transferred into the Swagelok cells for recharging at 250 μA with an Ar carrier gas flow of 0.8 sccm. By monitoring the changes of O₂, CO and CO₂ concentrations, the corresponding gas evolution rates can be obtained.

To detect the release of ¹O₂ from discharge products when charging, 30 mM DMA and 3 M LiTFSI dissolved in DMSO added with 25%ᵥₒₗ. EmimBF₄ was utilized as the electrolyte to assemble coin-type cells with different catalytic cathodes. After cycles, the coin-type cells were disassembled in glove box, of which the battery components were washed carefully by DMSO-d₆. The obtained solutions were then subjected to ¹H NMR characterizations.

### DFT Calculations

To obtain the geometric structures of 4H solid phase of Ru and Ni, the structure prediction was performed using Crystal Structure Analysis by Particle Swarm Optimization (CALYPSO). Based on the analysis of more than 3000 structural phases generated, the common 2H Ru, unusual 4H Ru and 4H Ni modes were found. The mainly-exposed (004) and (110) surfaces of 4H Ru/Ni nanodendrites were established. For comparison, the thermodynamically abundant (002) surface of traditional 2H Ru was considered in the simulations. All the computational simulations were performed on basis of DFT calculations with plane-wave technique which is implemented in the Vienna ab initio simulation package (VASP). Gradient corrected exchange-correlation functional of Perdew, Burke, and Emzerhof (PBE) models was used under the projector augmented wave (PAW) method, with a cut-off kinetic energy of 500 eV for plane wave basis. The convergence criterion of the total energy was set up to be within 1×10⁻⁵ eV, while all the atoms and geometries were optimized until the residual forces became less than 1×10⁻² eV/Å. For 4H Ru and 4H Ni crystals, these optimized energetically most favourable structures after the full geometry relaxation were implemented within a K-point 9×9×3 grid.

For the adsorption energy simulations, the DFT-D3 method with Beck-Jonson damping was used to include the physical Van der Waals interaction. For all the surface-related calculations including the adsorption/dissociation of atoms and molecules on Ru/Ni (004)_{4H}, (110)_{4H} and (002)_{2H} surfaces, they were carried out within a K-point 2×2×1 grid. In the vertical direction, a vacuum layer of 15 Å thick was introduced for all of the surfaces. The adsorption energy of various discharge products and intermediates was defined as E_{ads}=E_{T}−(E_{A}+E_{S}), where E_{A} and E_{S} represent the energy of the specified atoms or molecules and the pristine system, respectively, and E_{T} is the total energy of the corresponding system with specified atoms or molecules adsorbed.

### Example 1

### Synthesis of Unusual 4H/fcc Au Nanorods

The unusual 4H/fcc Au nanorods were synthesized by a modified wet-chemical synthetic strategy. Firstly, 15 mg of HAuCl₄·xH₂O were added into 10 mL of the mixture of OAm and n-heptane with a volume ratio of 1/1, followed by a short sonication for several seconds to get a homogenous transparent solution. After 1000 μL of N-ethylcyclohexylamine were dropped into the aforementioned solution, the obtained solution was rapidly transferred into a 20 mL glass vial. Then the glass bottle containing the growth solution was put in an oil bath and kept at 68° C. for 48 h. Thereafter, the suspension was taken out from the reaction bottle, washed with n-hexane and centrifuged at 4000 rpm for several times until the supernatant liquid became colourless. The obtained unusual 4H/fcc Au nanorods were redispersed into 2 mL of toluene for further use.

### Example 2

### Synthesis of Unconventional 4H/fcc Ru Dendrites on Au Template

4H/fcc Au nanorods were used as hard templates for the epitaxial growth of 4H/fcc Ru dendrites. Specifically, 4 mL of 4H/fcc Au stock solution, 3 mg of Ru₃(CO)₁₂, 50 mg of 1,2-HDD and 10 mL of OAm were successively added into a 25 mL two-neck flask. After that, the flask was connected with the double-bank pipe system for sealing. Before reaction, the mixed solution was stirred under vacuum at 110° C. for 25 min to remove the low-boiling impurities. Next, the flask was purged with nitrogen and heated to 225° C. rapidly under the protection of nitrogen. The solution was kept for 15 min at 225° C. under stirring for the epitaxial growth of 4H/fcc Ru dendrites on Au seeds. When the flask cooled down to room temperature, all the mixed solution was taken out and then added with 20 mL of n-hexane. The sediments were collected by centrifugation at 4000 rpm for 3 min and the supernatant liquid was discarded. The obtained precipitates were washed and purified with 10 mL of pure n-hexane for several times until the supernatant liquid became colourless (centrifugation at 4000 rpm for 1 min every time). The final products were 4H/fcc Au@Ru nanorods.

### Example 3

### Synthesis of Hollow 4H/fcc Ru Nanotubes

The hollow 4H/fcc Ru nanotubes are prepared by selective etching the Au templates. Specifically, the obtained 4H/fcc Au@Ru nanorods were successively washed with the mixtures of chloroform/DMF (v/v=1/1) once, chloroform/DMF (v/v=1/2) twice, and pure DMF once, and then redispersed in 2 mL of DMF. The obtained slurry was transferred into a 20 mL glass bottle, after which 2 mL of 0.1 M CuCl₂-DMF solution and 10 mL of pure DMF were added into the bottle. Thereafter, the bottle was sealed and sonicated for 5 min, followed by heat-treatment at 80° C. for 36 h under stirring. After that, the mixed solution was centrifuged at 10000 rpm for 10 min to collect the sediments, which were then washed with the mixture of n-hexane/ethanol (v/v=1/1) for three times. The obtained 4H/fcc Ru hollow nanotubes were redispersed in 2 mL of toluene for further use.

### Example 4

### Synthesis of 4H/fcc Ru—Ni Heteronanostructures

The 4H/fcc Ru—Ni heteronanostructures are prepared by an orientated growth of 4H/fcc Ni dendrites on 4H/fcc Ru. Specifically, 4 mL of 4H/fcc Ru stock solution, 1 mL of Ni(HCOO)₂ solution (1 mg mL⁻¹, in OAm), 50 mg of 1,2-HDD, 20 mg of Mo(CO)₆ and 9 mL of OAm were successively added into a 25 mL two-neck flask, which was then connected with the double-bank pipe system for sealing. The solution was stirred under vacuum at 80° C. for 25 min to remove the low-boiling impurities. Next, the flask was purged with nitrogen and heated to 160° C. slowly and then kept for 15 min without stirring under the protection of nitrogen. After the reaction, the mixed solution was taken out and then added with 5 mL of n-hexane and 25 mL of ethanol. The products were collected by centrifugation at 10000 rpm for 10 min. After washing with 10 mL of pure degassed ethanol for several times, 4H/fcc Ru—Ni heteronanostructures were obtained.

### Example 5

### Synthesis of the Comparative 2H Ru Nanosheets

The 2H Ru nanosheets are synthesized for comparative studies. The synthesis of the 2H Ru nanosheets involves a one-pot synthesis process. Specifically, 2 mg of Ru(acac)₃ were firstly dissolved in 2 mL of the mixture of benzyl alcohol/OAm (v/v=3/1) through sonication for 30 min. The obtained dark red solution was added into a 4 mL glass bottle, which was then transferred into a sealed 30 mL autoclave for solvothermal growth. After heating at 200° C. for 12 h, the obtained solution was centrifuged at 10000 rpm for 10 min to collect the sediments. A mixture of n-hexane/ethanol (v/v=1/1) was utilized to wash the products for several times. Finally, the obtained black sediments are traditional 2H Ru nanosheets.

### Example 6

### Preparation of Working Electrodes

Before the preparation of cathode electrodes, all of the as-synthesized metal nanomaterials were mixed with commercial CNT powders at a weight ratio of 3/1. After that, the obtained active material mixtures were redispersed in 15 mL of degassed ethanol added with 8 mg of L-AA and stirred overnight at 80° C. to remove the surface ligands. The pre-treated catalysts were collected by centrifugation, washed with ethanol for several times, and then dried at 50° C. in vacuum oven. Next, the obtained catalysts were directly mixed with Nafion (5% wt. in ethanol) at a weight ratio of 9/1. A proper amount of isopropanol was utilized as the solvent to make a homogenous slurry through sonication. The obtained catalyst ink was dropped onto the carbon paper (Toray, H060) disks slowly and homogenously. After dried at 30° C. in vacuum oven over 48 h, the cathode electrodes corresponding to the different Ru/Ni nanostructures were obtained for further use. Without specified or otherwise, the mass loading of active materials was controlled at 0.2 to 0.3 mg per cathode.

### Example 7

### Design of the Catalysts

First-principle calculations was used in the design of the catalysts of the present invention. Five representative noble metals including Ru, Ir, Pd, Pt and Rh, coupled with four non-precious metals including Fe, Co, Ni and Zn, and taking Li₂CO₃+C and Li₂C₂O₄ as the two types of discharge products of Li—CO₂ batteries, are studied.

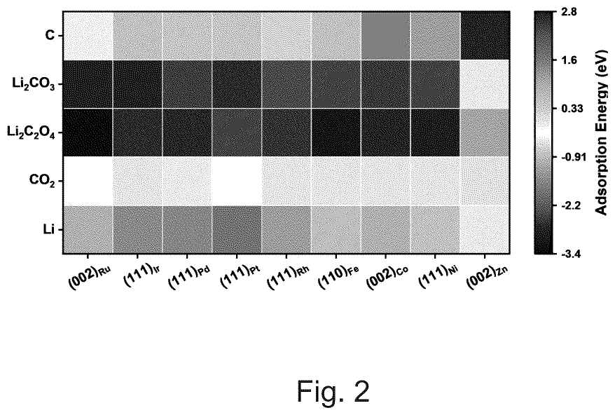

Given that nucleophilic and electrophilic sites are both necessary to stimulate Li—CO₂ electrochemistry, the interactions between proposed metals and reactants/products were firstly investigated, with the calculation results shown in FIGS. 2, 3A-3C and 4.

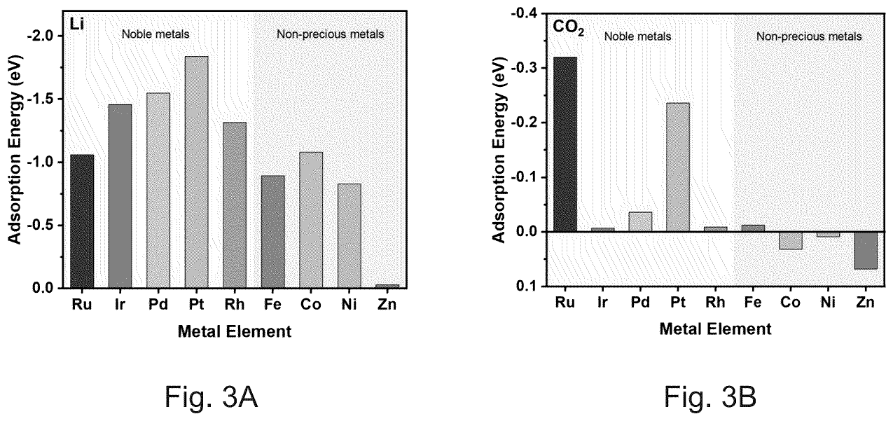

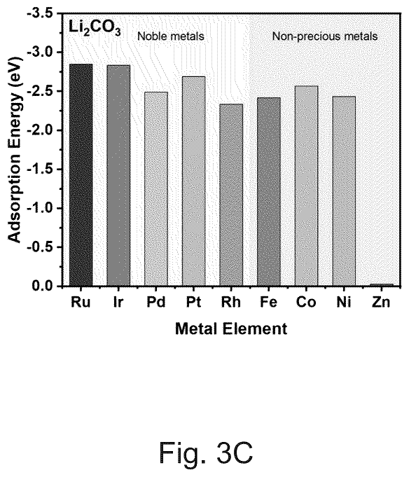

It is observed that noble metals exhibit stronger adsorption energies of Li (E_{ads}(Li)) and CO₂ (E_{ads}(CO₂)) than non-precious metals, on average. Thus, it is believed that noble metals would be more preferable to play as the CO₂RR sites. Besides the better wettability towards Li, the significant difference is observed at CO₂ capture evaluation where the E_{ads}(CO₂) for Ru (−0.32 eV) and Pt (−0.24 eV) outperform the others. In view of the higher difficulty on enhancing electrophilicity, it is believed that Ru may be a better choice to enrich reactants on catalyst surface. Meanwhile, Ru demonstrates the best wettability towards Li₂CO₃ (E_{ads}(Li₂CO₃)=−2.85 eV), C (E_{ads}(C)=−0.08 eV) and Li₂C₂O₄ (E_{ads}(Li₂CO₃)=−3.39 eV) among all the considered metals, suggesting that it is also beneficial for the uniform nucleation and distribution of discharge products (FIG. 3C). Based on the above analysis, it is believed that Ru is the most suitable active center for CO₂RR among the tested noble metals.

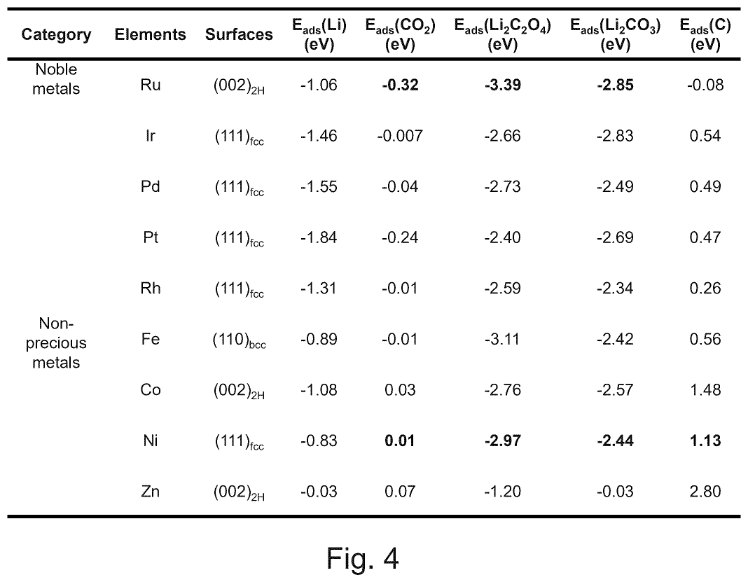

On the contrary, CO₂ER is a process related to the electrochemical degradation of Li₂CO₃ and the release of Li and CO₂. Therefore, ideal CO₂ER centers should have weak affinity towards Li and CO₂, but a moderate adsorption towards Li₂CO₃ is necessary to ensure good interfacial contacts with discharge products to catalyze its decomposition. Compared to noble metals, non-precious metals have such features according to the calculation results (FIG. 4). As shown, Zn shows E_{ads}(Li₂CO₃) of −0.03 eV and E_{ads}(CO₂) of 0.07 eV, whereas Fe, Co and Ni show E_{ads}(Li₂CO₃) of c.a., −2.42 to −2.57 eV and E_{ads}(Li₂C₂O₄) of c.a., −2.76 to −3.11 eV (FIGS. 2 and 3A-3C). In particular, it is noted that Ni has the weakest affinity towards Li (−0.83 eV) among them while performing a slight repulsion against CO₂ (0.01 eV). The E_{ads}(CO₂) of Ni is just between −0.01 eV for Fe (adsorption) and 0.03 eV for Co (repulsion), elucidating that Ni facilitates the CO₂ release in CO₂ER but does not remarkably obstructs the CO₂ enrichment in the former CO₂RR.

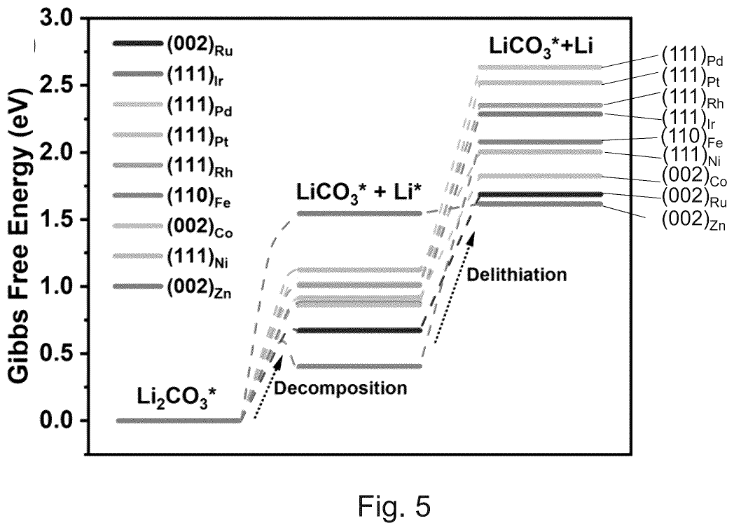

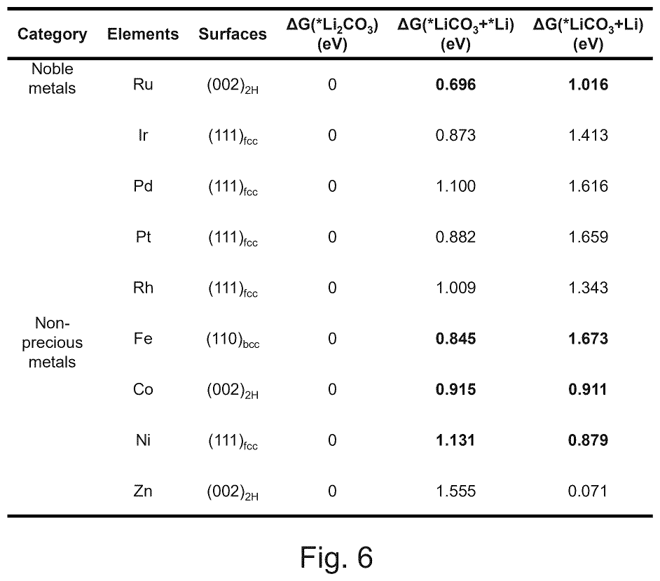

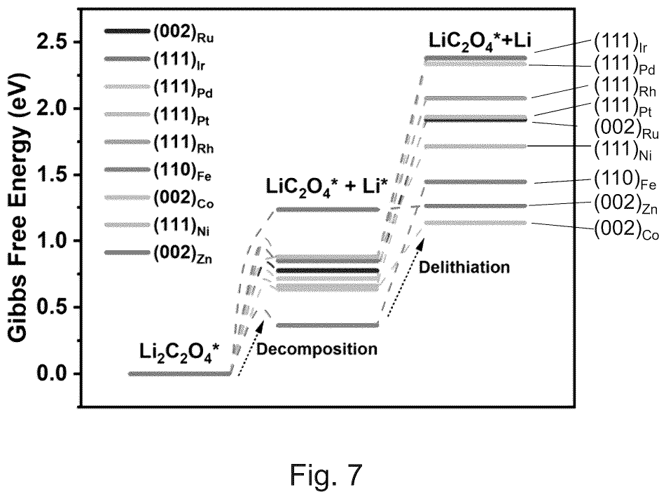

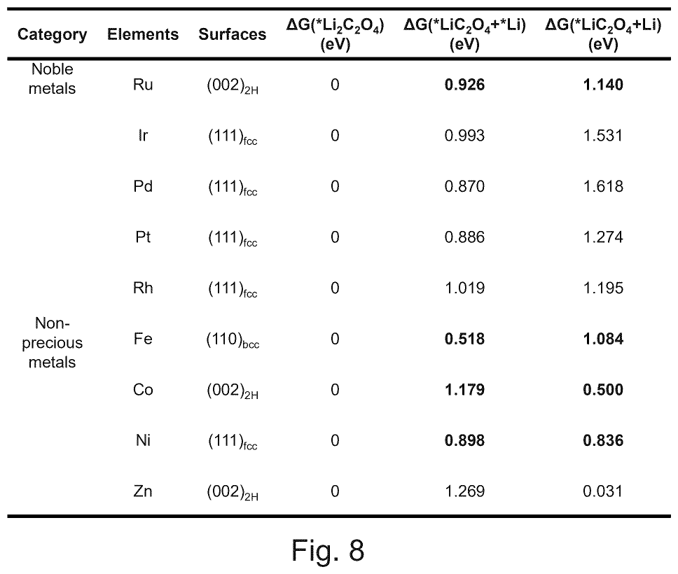

Furthermore, from the viewpoint of kinetics, a climbing-image nudged elastic band (CI-NEB) method was used to simulate the dynamic degradation processes of Li₂CO₃ and Li₂C₂O₄. The CO₂ evolution process from discharge products mainly involves two steps: the fracture of the weakest Li—O bond (Stage I) and the delithiation of the generated Li ion (Stage II). Because the crystallinity difference between these two species (commonly seen in practical cases) is not considered here for simulations, these two degradation processes should be analyzed individually. From FIGS. 5 and 6, Ru exhibits the both smallest decomposition energy barrier (0.696 eV) of adsorbed Li₂CO₃ and dilithiation energy barrier (1.016 eV) of dissociated Li atom among the five selected noble metals. The four non-precious metals have their own special advantages in different stages, with Co and Ni being capable of exhibiting two moderate values during the entire process. Meanwhile, from FIGS. 7 and 8, Ru and Ni can also exhibit moderate decomposition energy barriers (0.926 eV for Ru and 0.898 eV for Ni) while keeping relatively-low Li dissociation energy barriers (1.140 eV for Ru and 0.836 eV for Ni) in consideration of Li₂C₂O₄ degradation. The above thermodynamic and dynamic simulations imply that Ni is optimal for acting as effective CO₂ER centers.

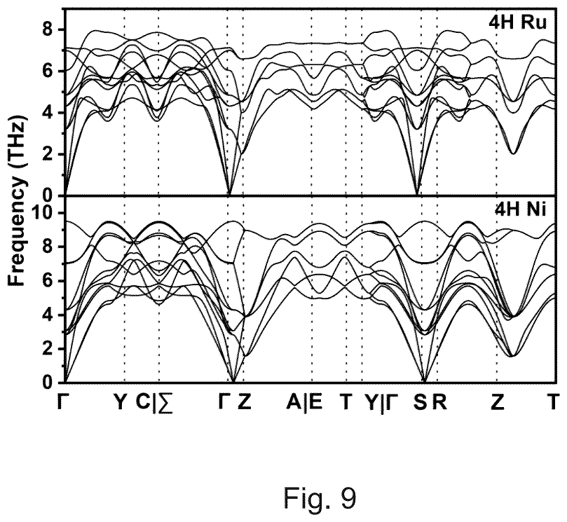

After selecting Ru and Ni as the components of desirable dual-site electrocatalysts, the CO₂RR and CO₂ER behaviors on the thermodynamically stable and metastable Ru/Ni crystals were simulated for designing the phase of the electrocatalyst. 2H, unconventional fcc and 4H phases were selected for Ru, and usual fcc and unconventional 4H phases were selected for Ni. The commonly exposed (002) facet for 2H phase, (111) facet for fcc phase and (004)/(110) facets for 4H phase are considered. Due to the lack of systematic understanding on 4H phases, phonon spectra were simulated to check the dynamic stability of 4H Ni and 4H Ru crystals obtained by CALYPSO. The lack of imaginary frequency certificates that both of them possess good dynamical stability theoretically (FIG. 9), satisfying the prerequisites of subsequent thermodynamical simulations.

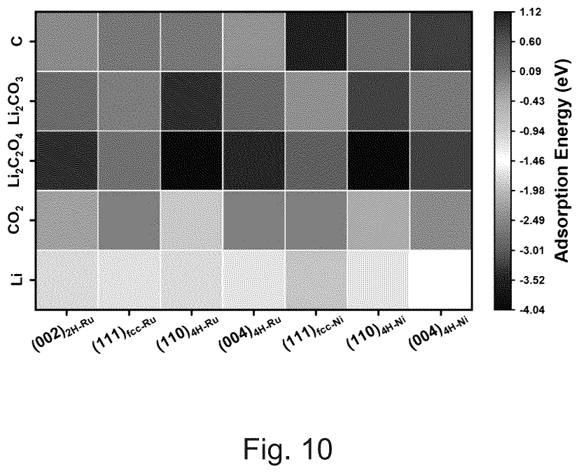

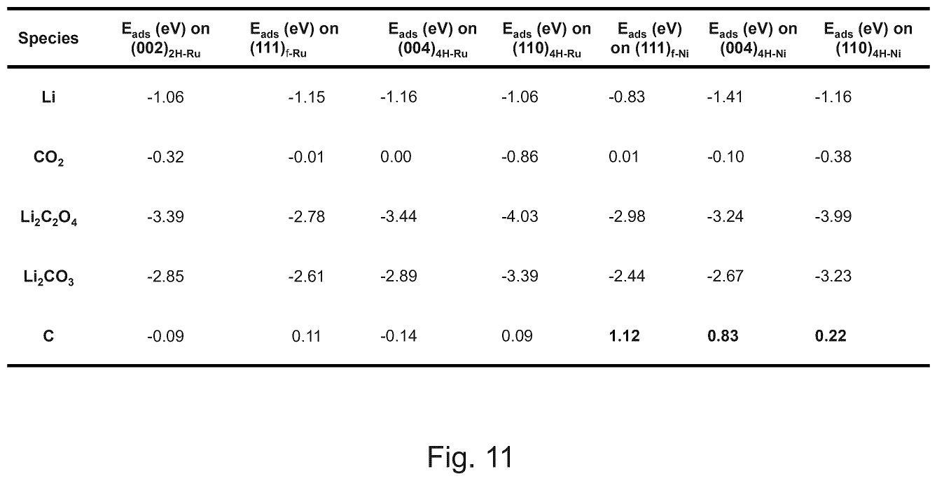

For the CO₂RR side, the wettability of different Ru/Ni crystal phases towards reactive materials and possible discharge products was investigated. As shown in FIGS. 10 and 11, the E_{ads}(Li), E_{ads}(CO₂) and E_{ads}(Li₂CO₃) on unusual (110)_{4H-Ru} surface are obviously stronger than those on traditional (002)_{2H-Ru} and unusual (111)_{f-Ru} surfaces, suggesting that the former unusual surface has better wettability towards reaction precursors coupled with discharge products and hence boost the entire CO₂RR kinetics. It is noteworthy that 4H Ni also affects the CO₂RR behaviors rather than only plays as the CO₂ER sites. Because E_{ads}(C) on (110)_{4H-Ni} (0.22 eV) and (004)_{4H-Ni} (0.83 eV) facets are prominently positive values, 4H Ni is adverse for carbon deposition, different from the situations on various Ru facets. Based on the reaction equilibrium, the formation of Li₂CO₃ as discharge product should be restrained by Ni. Simultaneously, as a critical intermediate, Li₂C₂O₄, prefers to deposit on 4H Ru/Ni rather than 2H or fcc Ru and fcc Ni. The E_{ads}(Li₂C₂O₄) shows more distinct advantages over E_{ads}(Li₂CO₃) and E_{ads}(C) on 4H phases. These results suggest that 4H phase may help to stabilize Li₂C₂O₄ intermediate as the final discharge product.

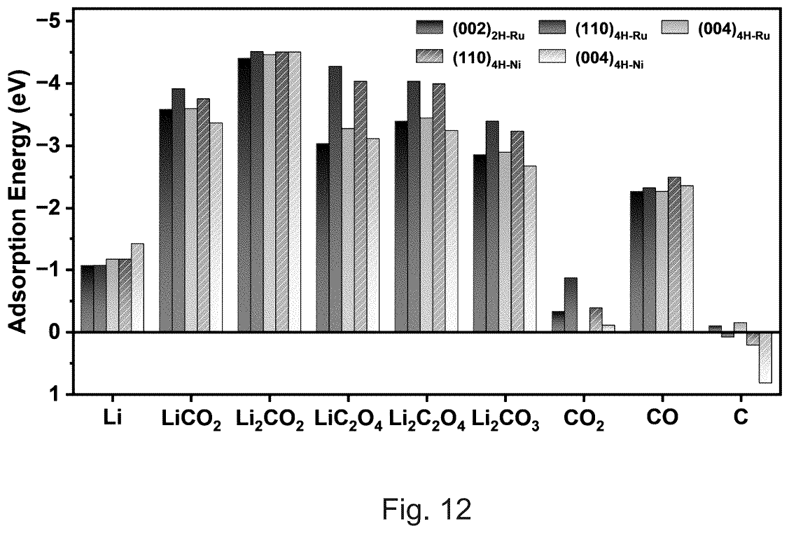

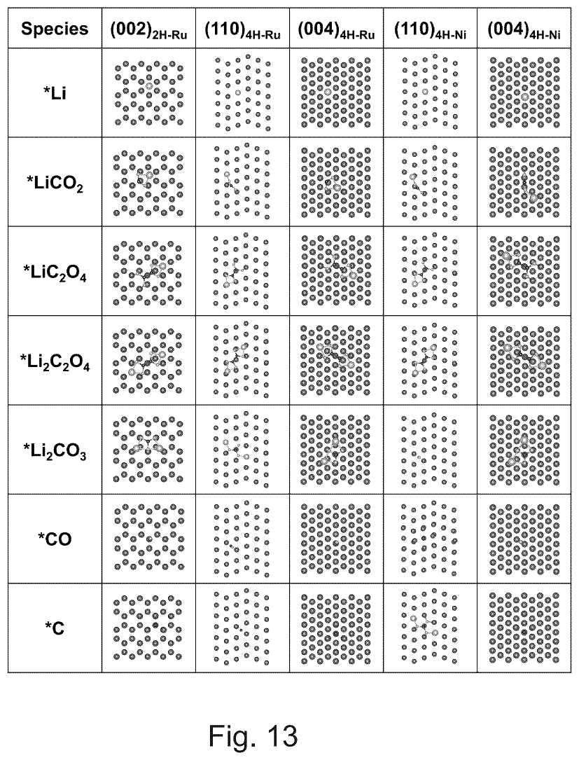

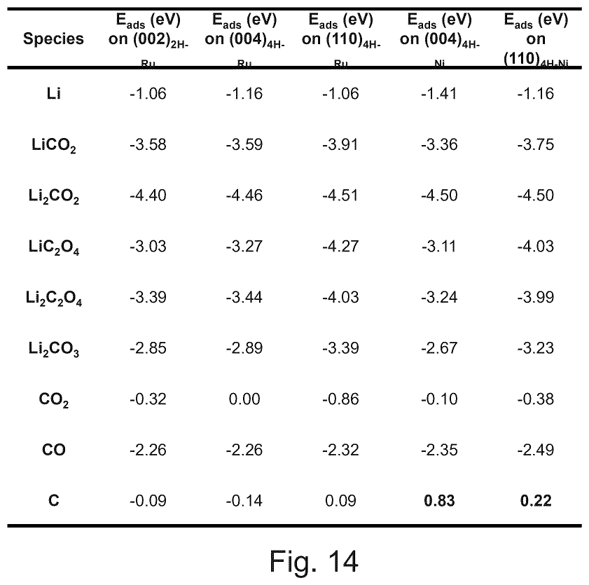

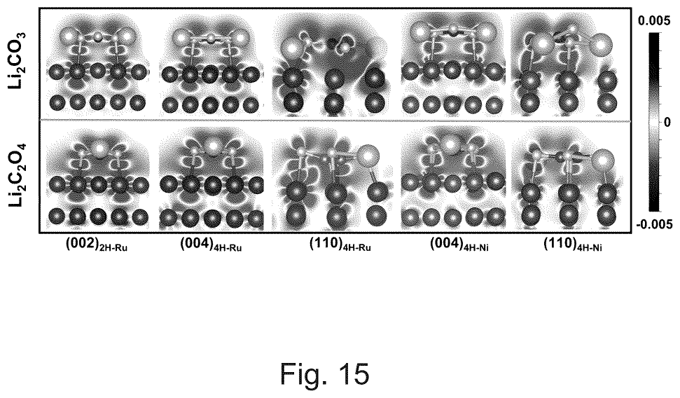

Five representative unconventional and common Ru/Ni facets were picked out to explore the possible CO₂RR pathways. In general, it is believed that 4H Ru/Ni crystals demonstrate better wettability towards key intermediates of Li—CO₂ electrochemistry when compared with 2H Ru (FIGS. 12-14). The most obvious differences lie in the adsorption step of LiC₂O₄ and Li₂C₂O₄, where (110)_{4H-Ru} and (110)_{4H-Ni} surfaces demonstrate the apparent priority for deposition of these two intermediates than the common (002)₂H—Ru basal plane. This observation is further supported by charge density difference analysis, in which the electron interactions between Li₂C₂O₄/Li₂CO₃ and (110)/(004) surfaces of 4H Ru and 4H Ni crystals are significantly stronger (FIG. 15).

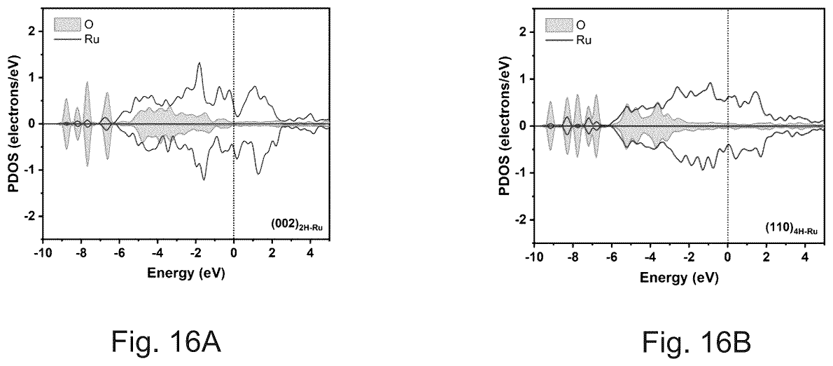

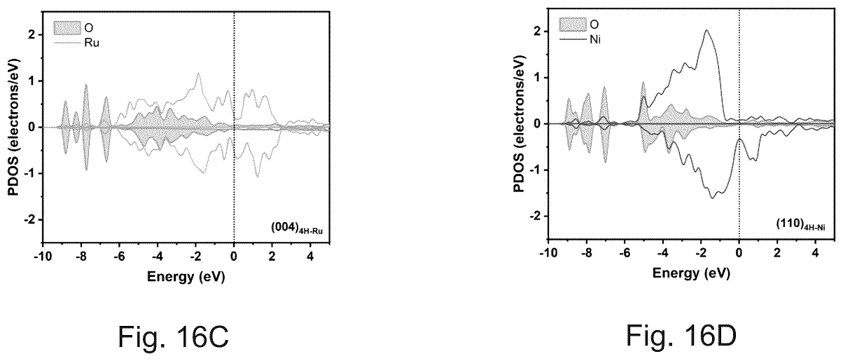

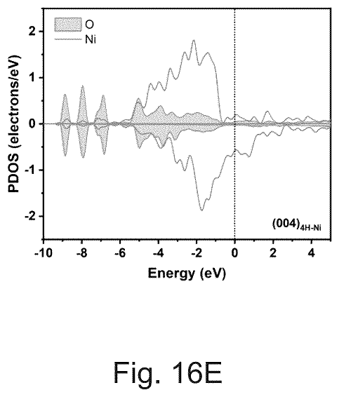

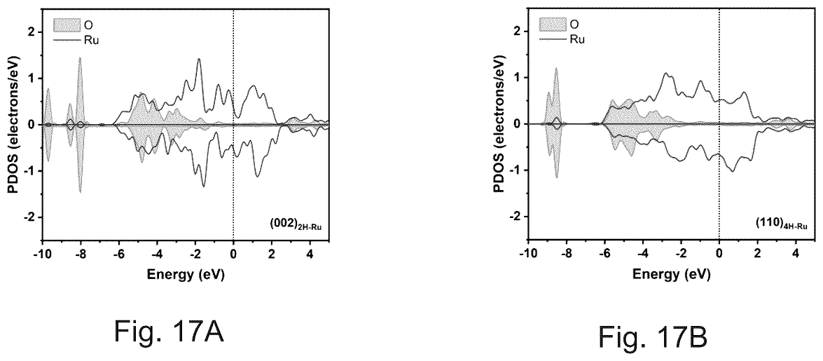

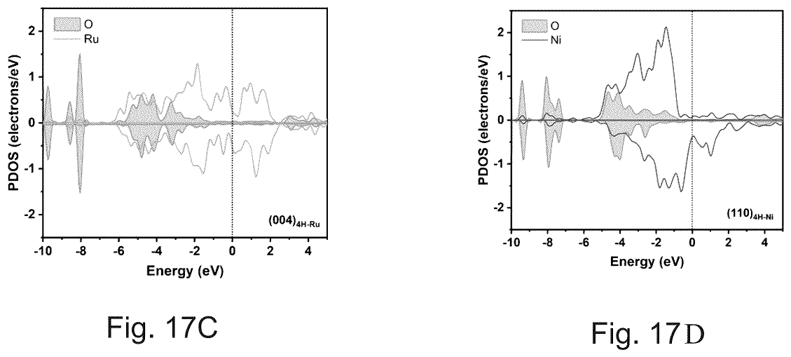

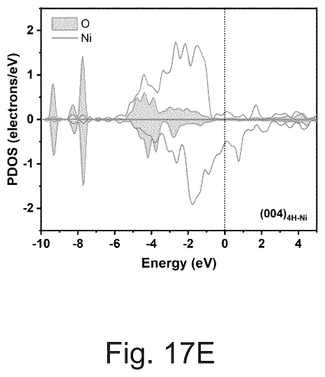

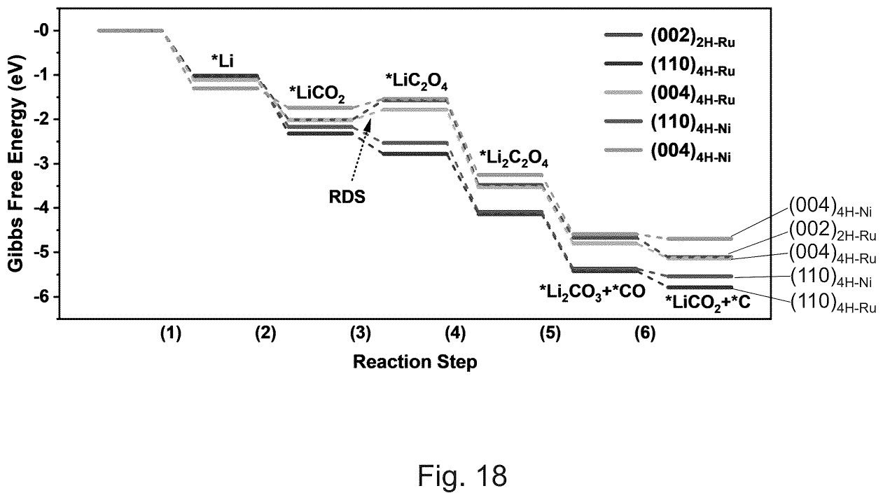

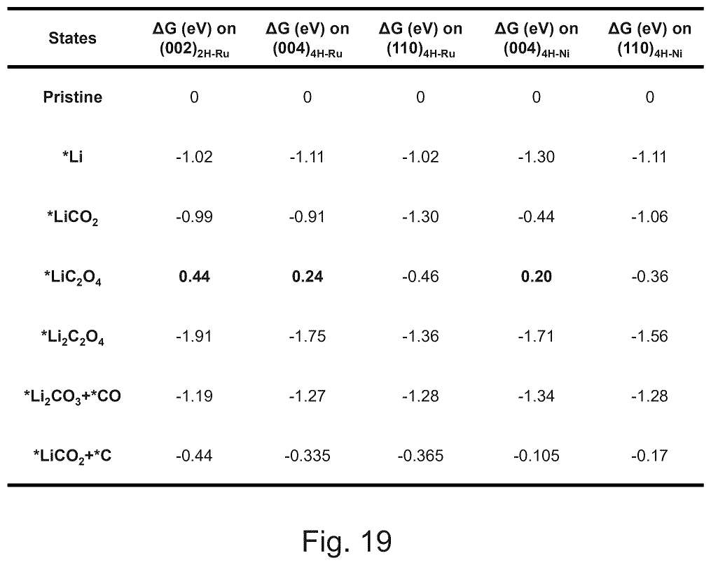

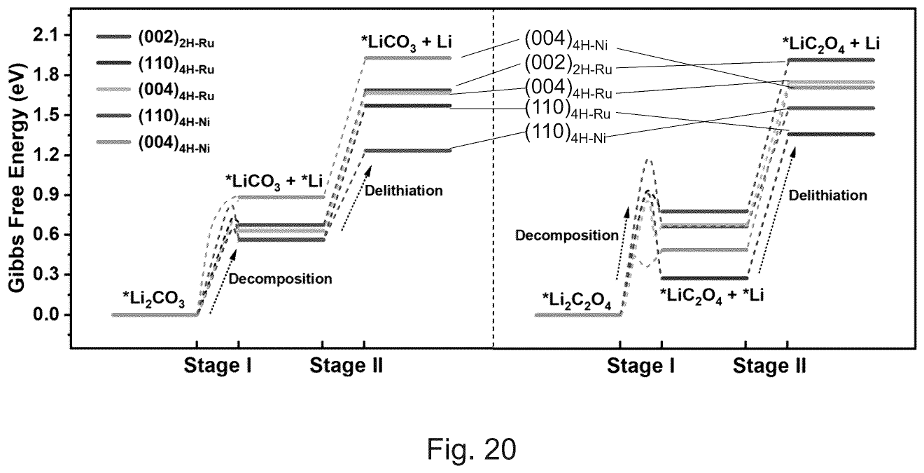

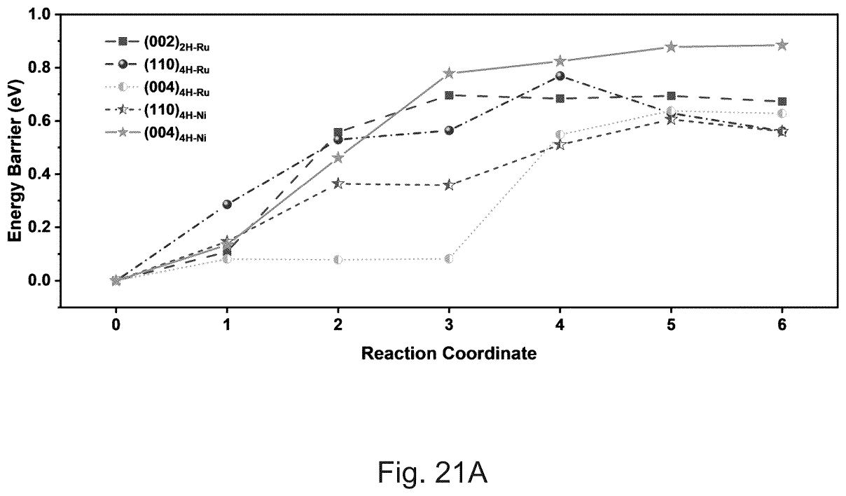

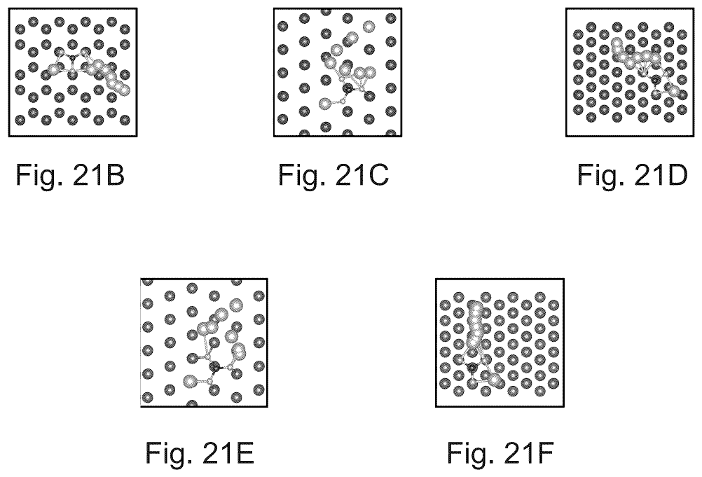

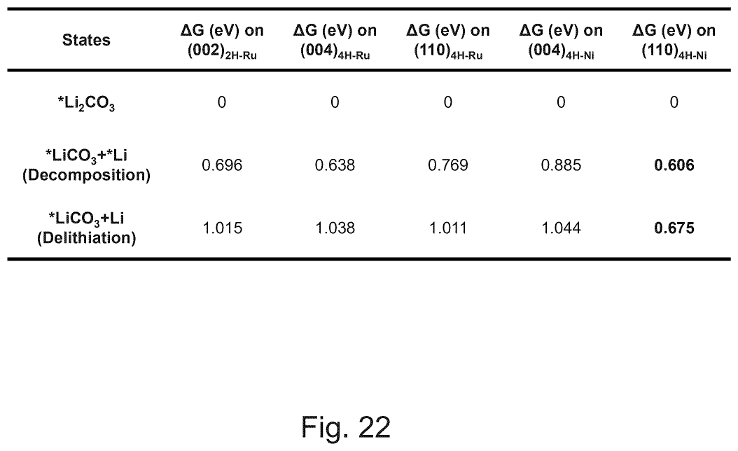

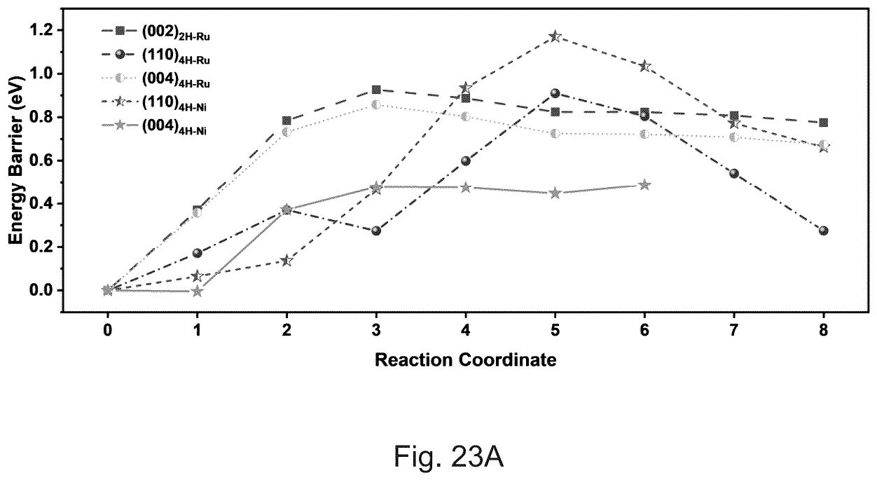

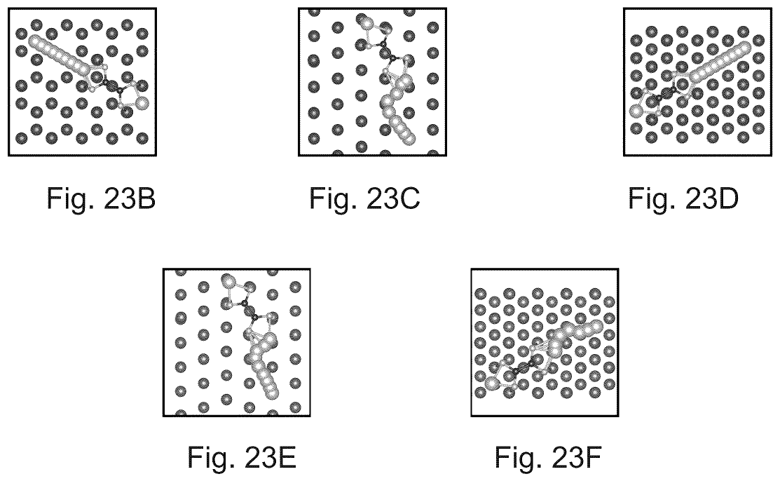

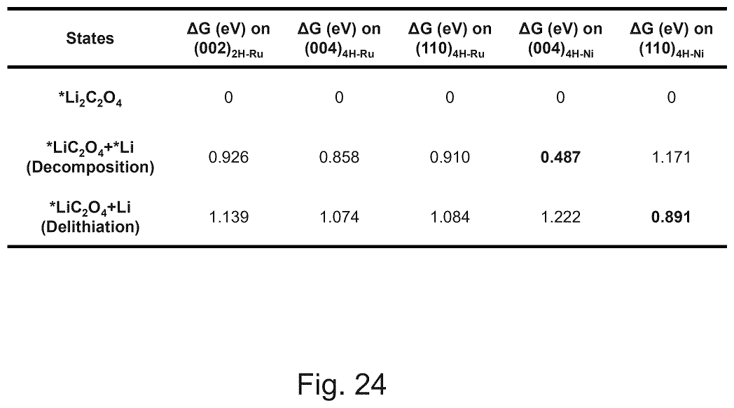

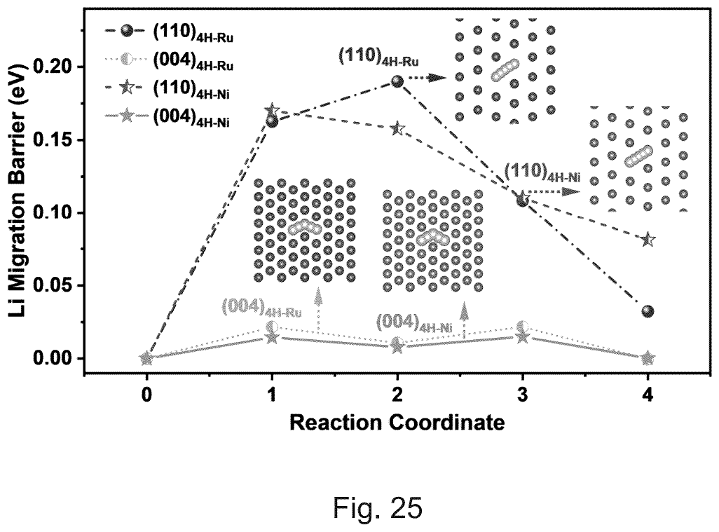

Simultaneously, the introduction of 4H Ni crystal is in favor of metal-oxygen couplings between the metal catalysts and the detected discharge products, according to the partial electronic density of states (PDOS) displayed in FIGS. 16A-16E and 17A-17E. The Gibbs free energy barrier (ΔG) evolutions unravel CO₂RR is much more preferable to proceed on (110)_{4H-Ru} and (110)_{4H-Ni} facets, due to their energetically downhills of AG at every intermediate step (FIGS. 18 and 19). The dynamic degradation simulations for Li₂CO₃ and Li₂C₂O₄ have been also implemented on these Ru/Ni crystals with different phases. As shown in FIGS. 20 (left panel), 21A-21F and 22, (110)_{4H-Ni} facet exhibits the smallest decomposition energy barrier (0.606 eV) of adsorbed Li₂CO₃ and delithiation energy barrier (0.675 eV) of dissociated Li ion simultaneously among five surfaces. There is a similar positive effect on (004)_{4H-Ru} facet (0.638 eV for decomposition and 1.038 eV for delithiation), but its improvement is slightly inferior than that on (110)_{4H-Ni} facet. During the dynamic Li₂C₂O₄ degradation process (FIGS. 23A-23F and 24), it was observed that (004)_{4H-Ru}, (110)_{4H-Ru} and (004)_{4H-Ni} surfaces are more beneficial towards facilitating the oxidation of Li₂C₂O₄ in comparison with the traditional (002)₂H—Ru surface (FIG. 20, right panel). As can be seen in the dynamic Li migration simulations (FIG. 25), there should be a relay catalysis during the discharge-charge cycle along

$$L {i}^{+} {⟷}^{{( 004 )}_{4 H}} * L i + * C {O}_{2} {⟷}^{{( 110 )}_{4 H}} * L {i}_{2} C {O}_{3} / * L {i}_{2} {C}_{2} {O}_{4}$$

(i.e., Li ions may be firstly seized by (004) surfaces of 4H Ru/Ni crystals and then quickly immigrate to their (110) surfaces (CO₂-rich regions) to participate in the subsequent CO₂ electroreduction process. Similarly, an inverse order of delithiation and Li⁺ migration happens on the corresponding surfaces to proceed with CO₂ evolution when charging).

Based on the above, it is believed that these simulation results highlight the significance of Ru—Ni dual sites and unconventional 4H phases in promoting the round-trip CO₂RR and CO₂ER kinetics. Combining with the desired feature of high atomic utilization efficiency for catalysts towards aprotic metal-gas electrochemistry, a hollow and ultrathin Ru—Ni heteronanostructures with unconventional 4H phases as efficient bifunctional catalysts for Li—CO₂ batteries is thus designed.

### Example 8

### Synthesis and Characterization of the Catalyst

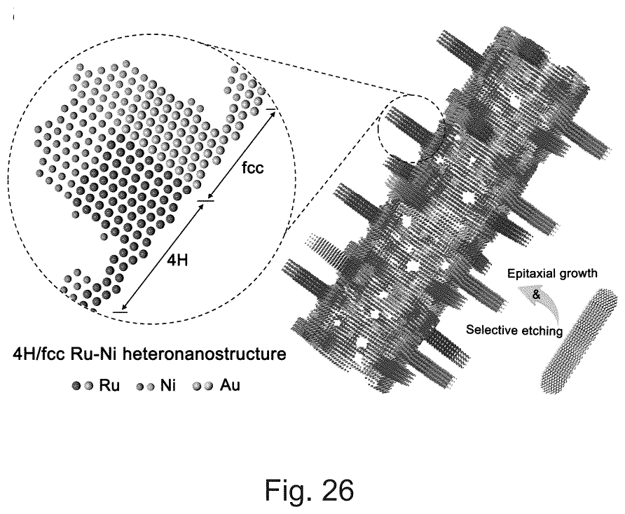

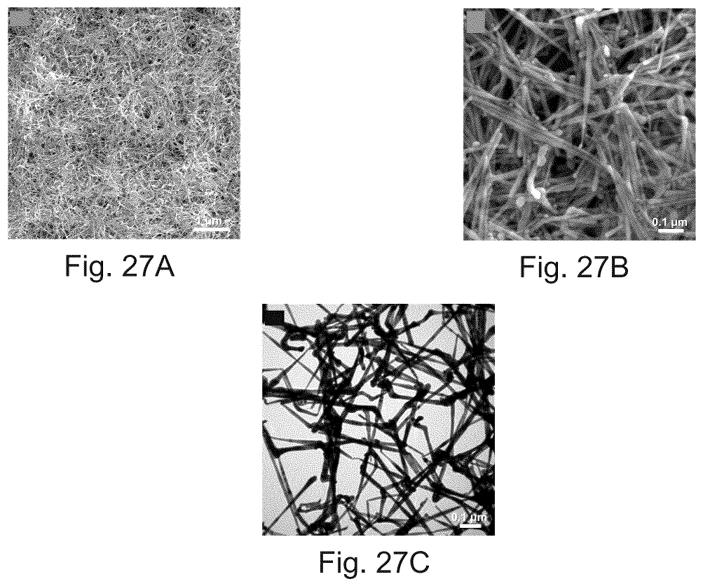

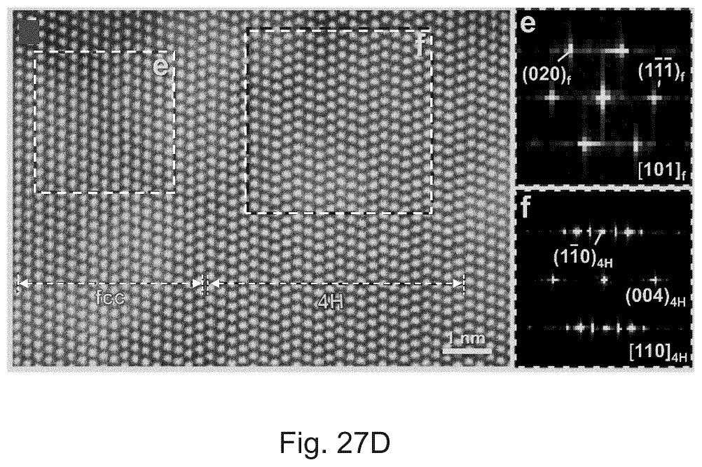

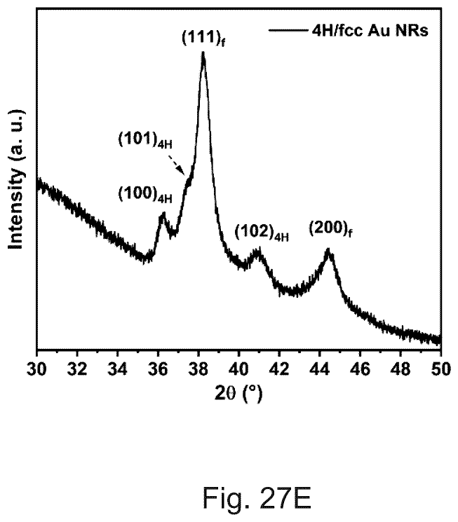

It is believed that it may be difficult to avoid the formation of concomitant fcc domains during practical preparation of 4H phases, the synthesized hollow and ultrathin Ru—Ni heteronanostructures thus adopted a 4H/fcc heterophase (denoted as 4H/fcc Ru—Ni). FIG. 26 shows the synthetic procedure and atomic arrangement models of 4H/fcc Ru—Ni. In general, it was obtained via a two-step epitaxial growth and selective etching method. Briefly, it involves the epitaxial growth of 4H/fcc Ru dendrites on heterophase 4H/fcc Au nanorods (seeds) (4H/fcc Au@Ru), which were utilized as the sacrificial template (FIGS. 27A-27E). Next, the as-prepared 4H/fcc Au@Ru is subjected to selective etching under heat treatment to obtain 4H/fcc Ru nanotubes. After that, the 4H/fcc Ru nanotubes were utilized as the substrates for the deposition of Ni along a quasi-epitaxial-growth process.

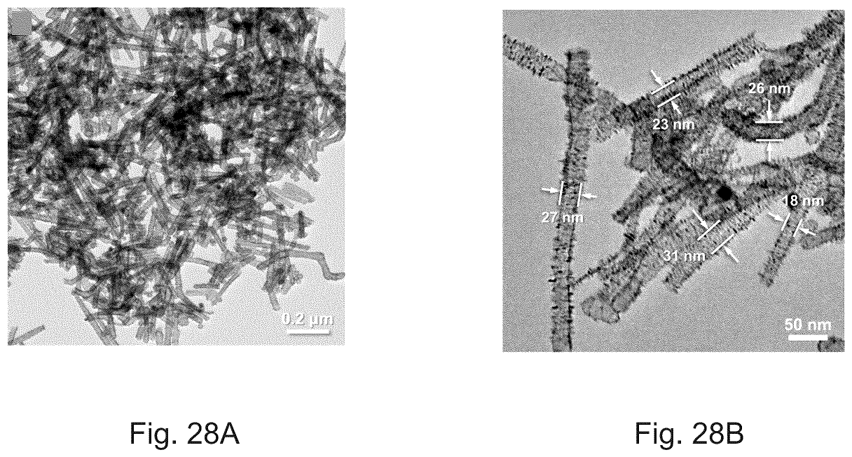

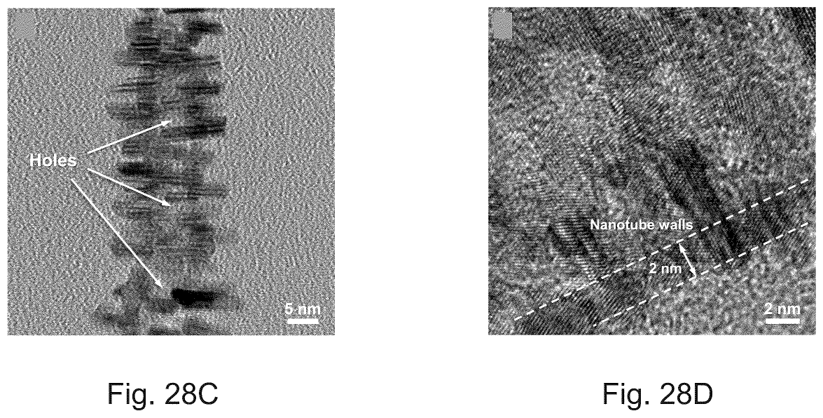

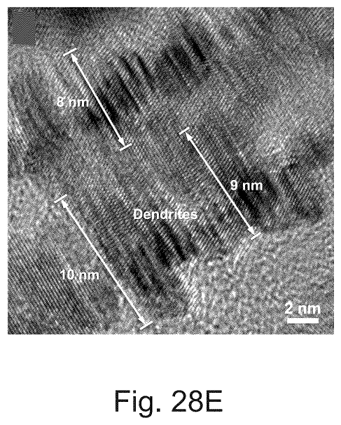

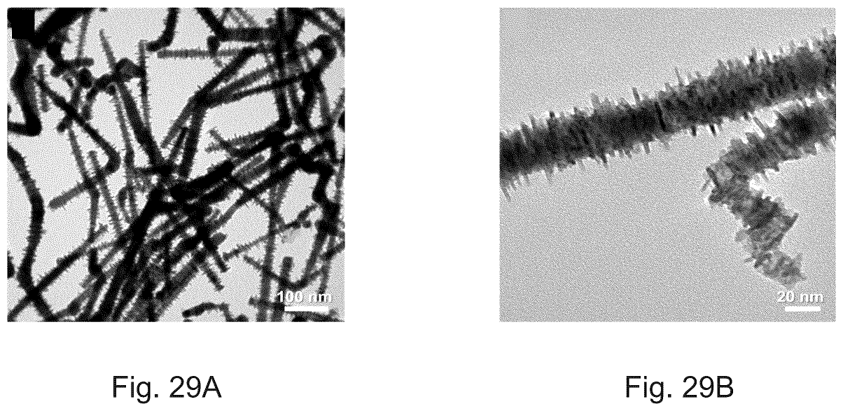

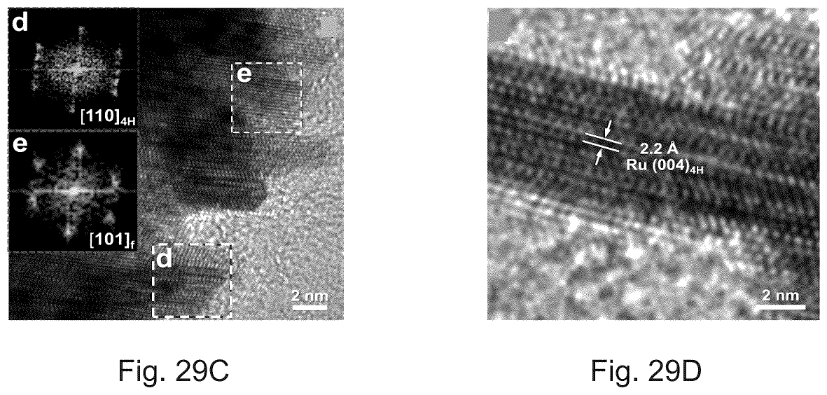

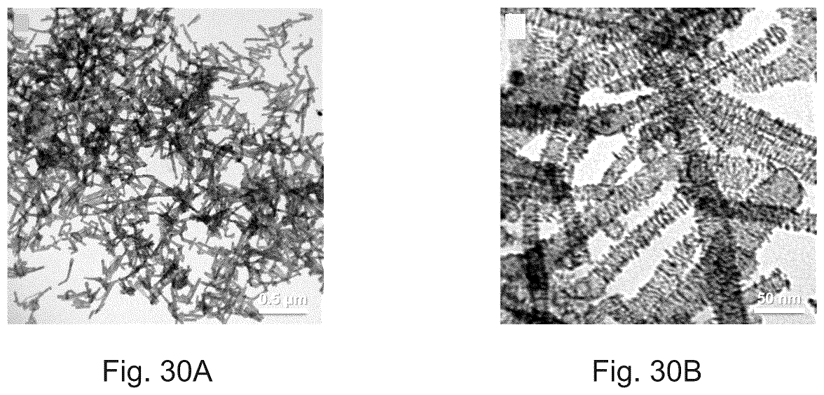

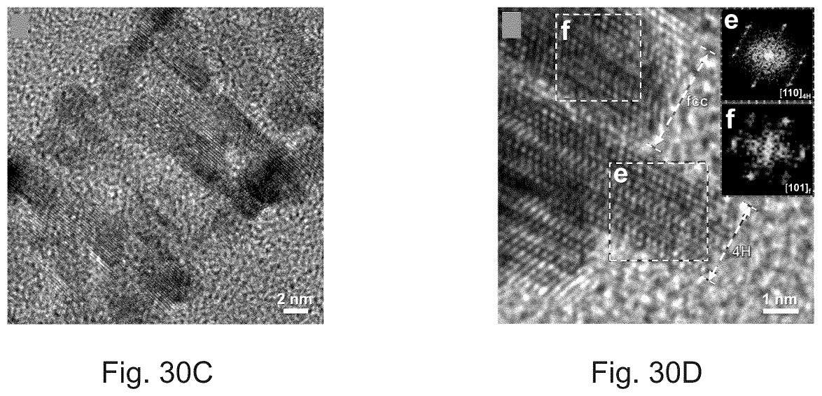

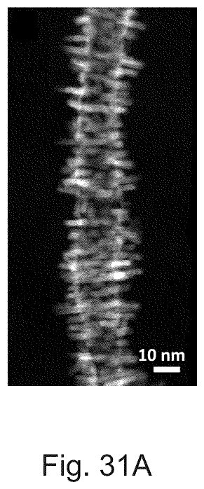

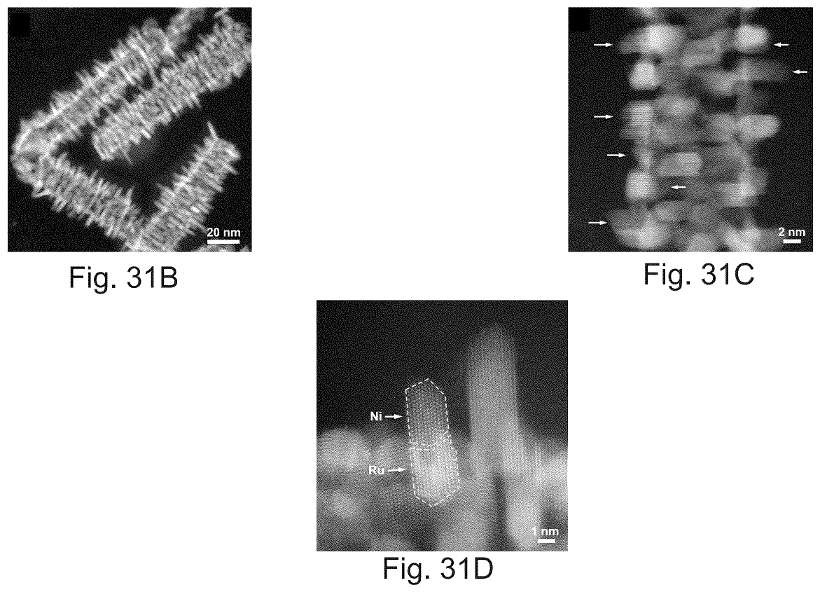

Transmission electron microscopy (TEM) and aberration-corrected high-angle annular dark-field scanning TEM (HAADF-STEM) show that the as-synthesized 4H/fcc Ru—Ni exist as hollow nanotubes, of which the majority possesses a diameter ranging from 20 to 40 nm (FIGS. 28A and 28B). There are abundant dendrites with an average length of 8-10 nm anchored on the nanotubes and plenty of nanoholes embedded in the nanotube walls (FIGS. 28C-28E), similar to the 4H/fcc Ru nanotubes obtained from the first-step epitaxial growth of Ru (FIGS. 29A-29D) and subsequent etching of the Au template (FIGS. 30A-30D). Besides, Ni components are found at the ends of Ru dendrites, along with a well-defined interface (FIGS. 31A-31D), indicating the formation of Ru—Ni heteronanostructures instead of solid solution alloys.

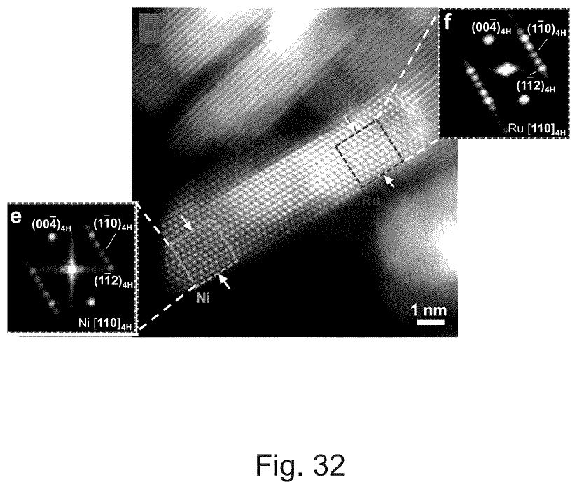

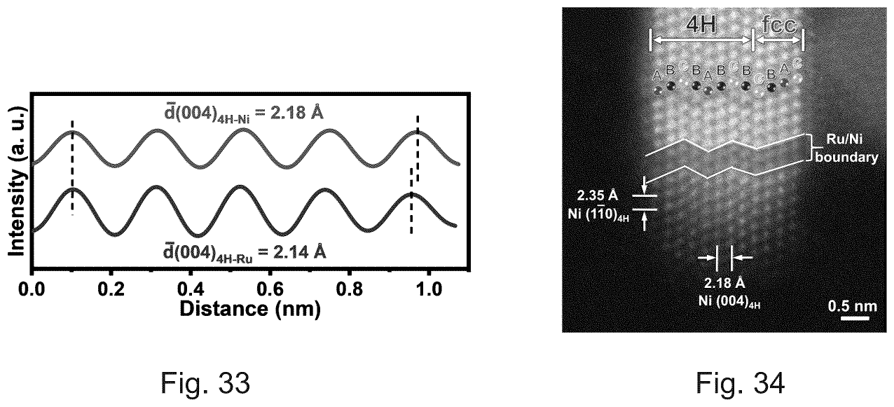

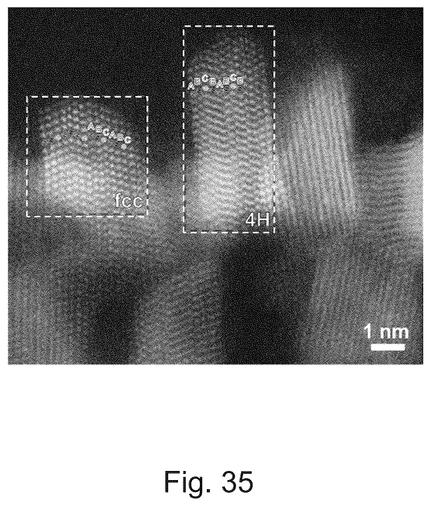

Importantly, the corresponding fast Fourier transform (FFT) patterns reveal the formation of 4H phases in both Ru and Ni regions (FIG. 32). The average interplanar distances were measured to be 2.14 and 2.18 Å for (004)_{4H-Ru} and (004)_{4H-Ni} planes (FIG. 33), respectively, while the interplanar spacing of (110)_{4H-Ni} planes was 2.35 Å (FIG. 34). The observation of atomic stacking sequences of “ABCB” and “ABC” along the close-packed [001]4H/[111]f directions indicates the co-existence of 4H and fcc phases (FIGS. 34 and 35).

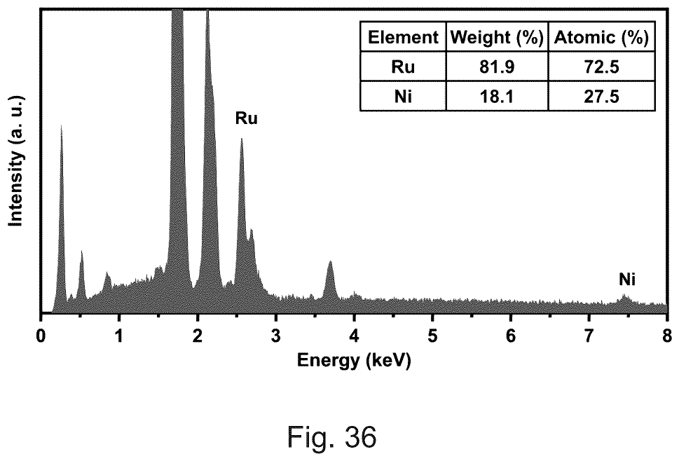

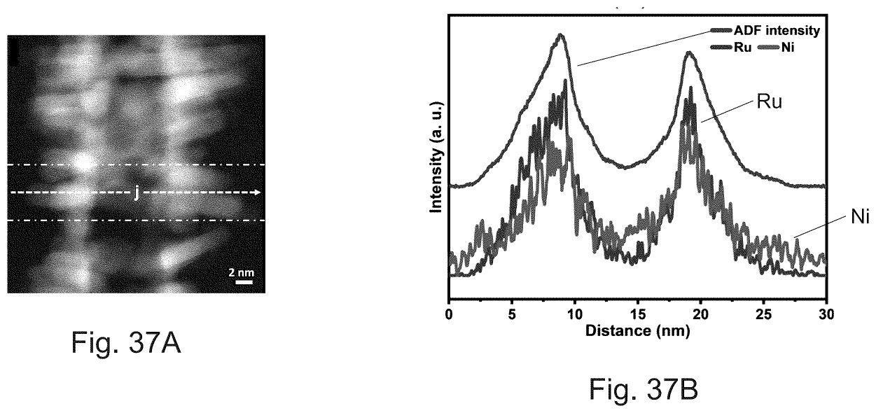

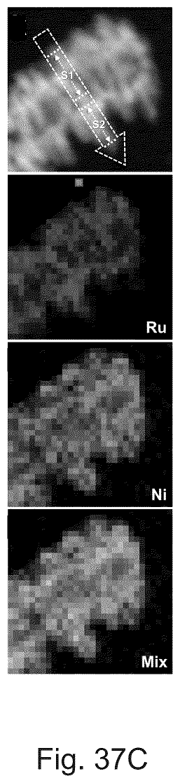

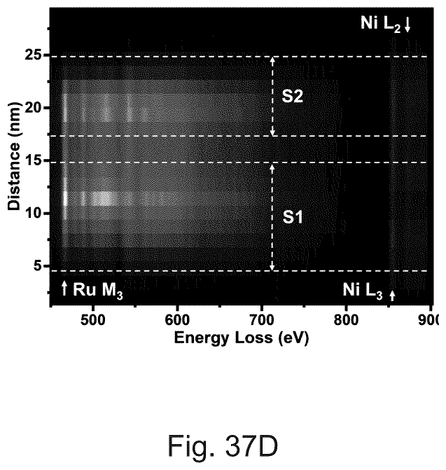

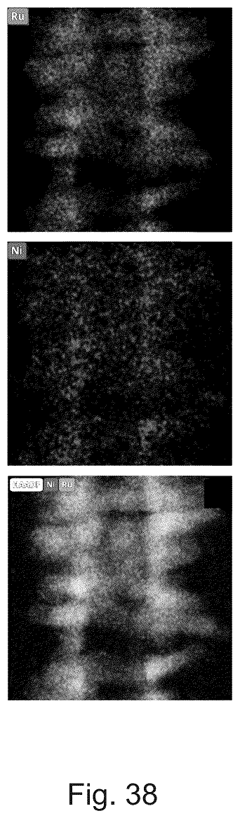

The energy dispersive X-ray spectroscopy (EDS) result elucidates the Ru/Ni atomic ratio of 72.5/27.5 in the 4H/fcc Ru—Ni heteronanostructures (FIG. 36). Based on the EDS line scanning, elemental mapping and corresponding electron energy loss spectroscopy (EELS) analysis, the disparate distribution of metallic Ru and Ni, especially near the edge areas of composite dendrites, further corroborates the unique heteronanostructures of as-prepared Ru—Ni metal catalysts (FIGS. 37A-37D and 38).

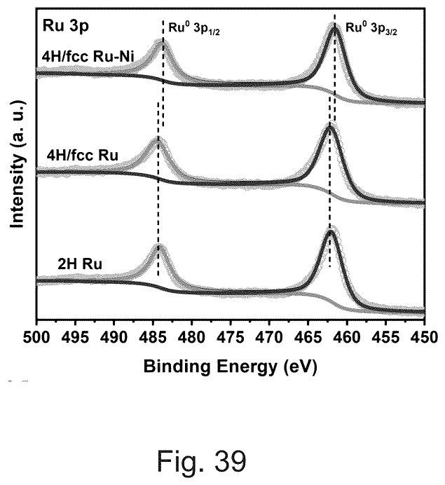

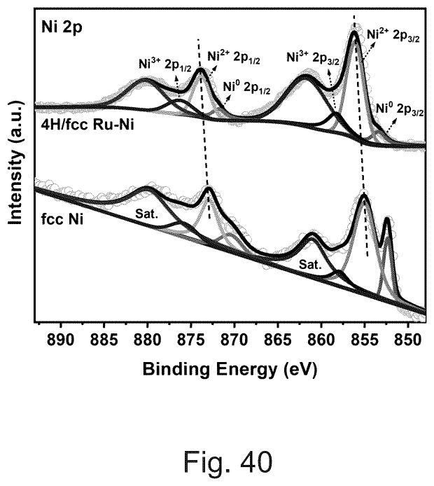

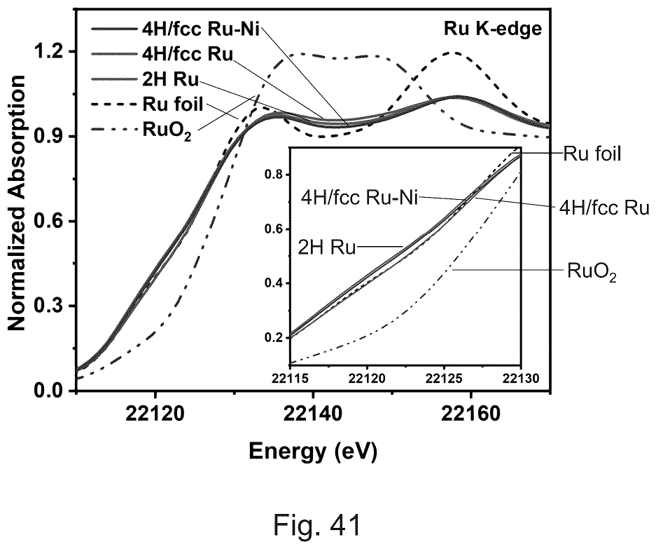

The chemical state and coordination environment of 4H/fcc Ru—Ni heteronanostructures were analyzed by X-ray photoelectron spectroscopy (XPS) and X-ray absorption spectroscopy (XAS). In the high-resolution Ru 3p XPS spectra (FIG. 39), two peaks are identified at around 483.8 and 461.6 eV attributed to the 3p1/2 and 3p3/2 doublets of metallic Ru in all three Ru-based samples. Noteworthily, there is a slight decrease of Ru valence in 4H/fcc Ru—Ni compared with 4H/fcc Ru and 2H Ru (FIG. 39) because of the introduced Ni as electron donor. This is further supported by the increased Ni valence of 4H/fcc Ru—Ni in contrast to that of the synthesized fcc Ni nanoparticles (FIG. 40). These electronegative Ru sites can act as electrophilic centers while the electropositive Ni sites are able to serve as nucleophilic centers, which simultaneously facilitate the ion/gas diffusion and electron transfer.

The above results are well consistent with subsequent XAS analysis. The Ru K-edge X-ray absorption near-edge structure (XANES) of 4H/fcc Ru—Ni, 4H/fcc Ru and 2H Ru shows the near-edge absorption energy approaching Ru foil rather than RuO₂, but 4H/fcc Ru—Ni exhibits a white line position at the slightly lower energy region than 4H/fcc Ru (FIG. 41).

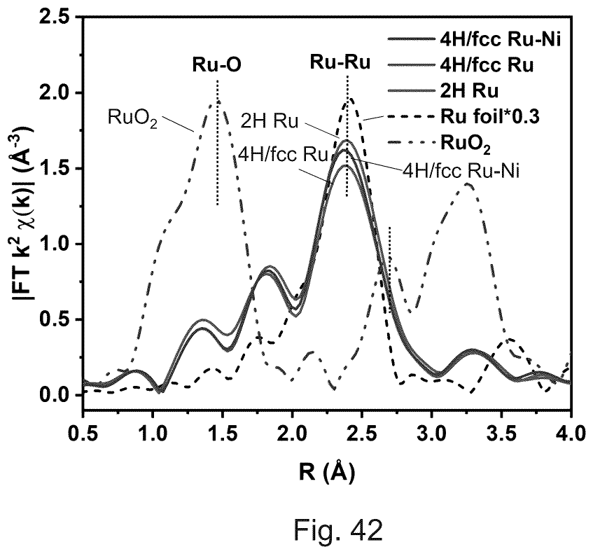

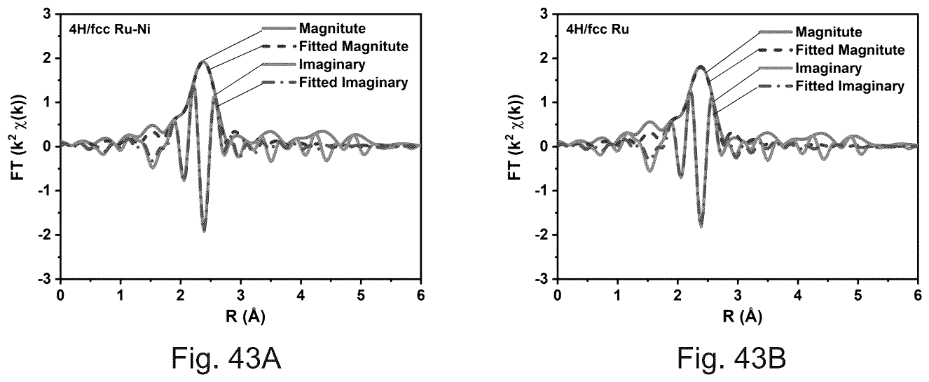

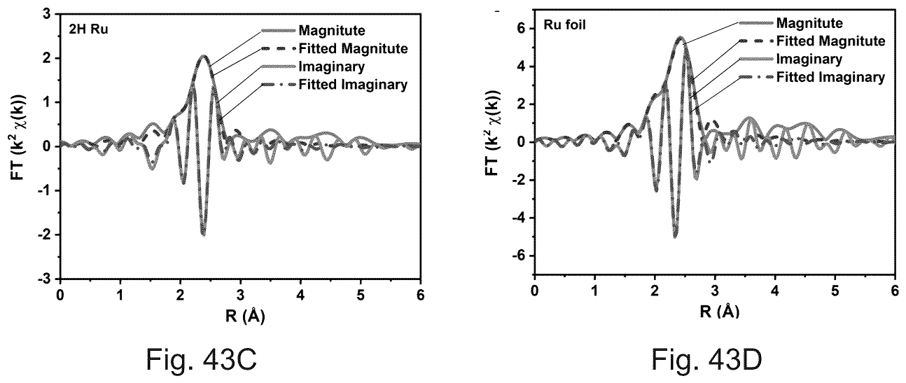

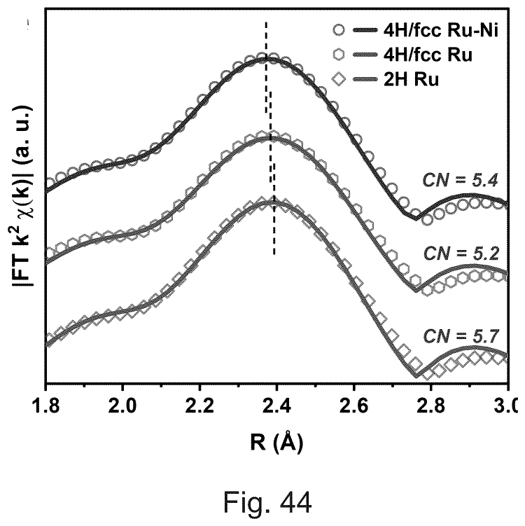

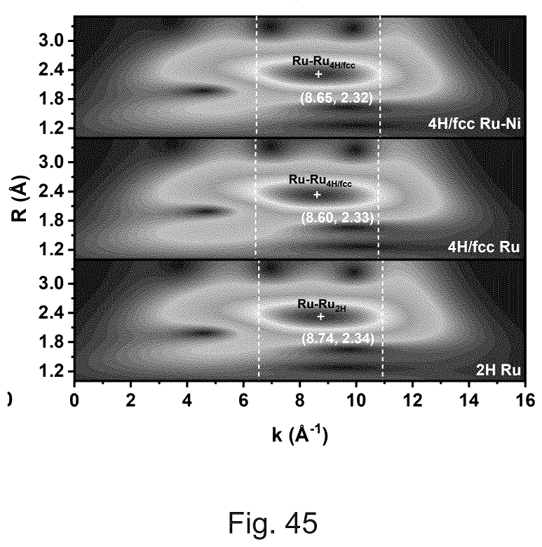

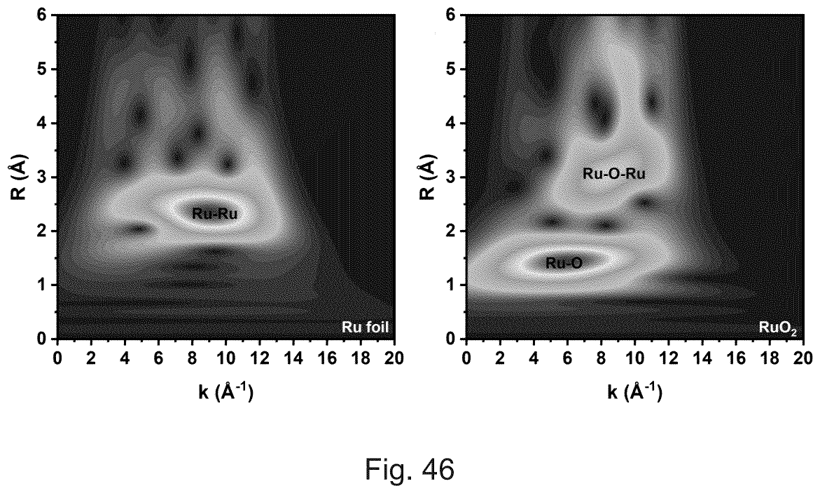

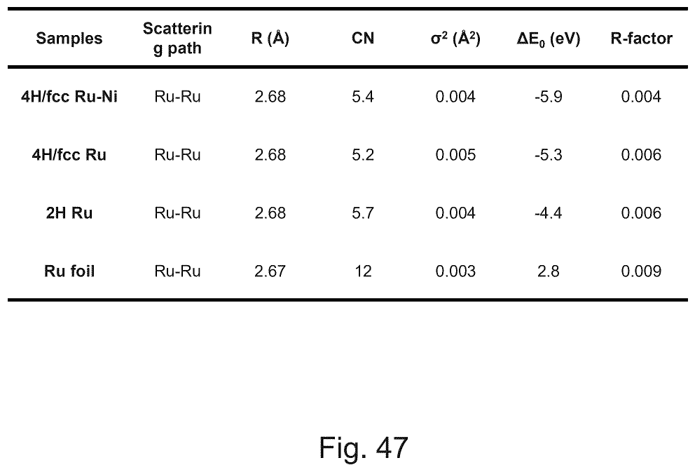

Based on the corresponding Fourier transformed (FT) k²-weighted extended X-ray absorption fine structure (EXAFS) spectra (FIGS. 42 and 43A-43D), unconventional 4H/fcc Ru—Ni and 4H/fcc Ru both presents one dominant peak located at ˜2.37 Å, which is ascribed to the Ru—Ru scattering path of the first shell. This value is a little lower than that (˜2.40 Å) of their common 2H counterpart. The epitaxial growth of Ni on 4H/fcc Ru nanotubes does not affect the coordination numbers (CN) of Ru obviously (5.4 for 4H/fcc Ru—Ni and 5.2 for 4H/fcc Ru), and meanwhile the synthesized traditional 2H Ru exhibits a similar CN of 5.7 (FIG. 44). Moreover, wavelet transform (WT) of Ru EXAFS oscillations was further performed to uncover the more detailed coordination environment differences on these three samples. 4H/fcc Ru—Ni, 4H/fcc Ru and 2H Ru demonstrate the similar WT patterns to that of Ru foil, which are different from that of RuO₂ (FIGS. 45 and 46). For both 4H/fcc Ru—Ni and 4H/fcc Ru, their centers of maximum intensity show a decrease in both k and R ranges compared to that of 2H Ru. After the epitaxial growth of Ni, there is a narrow distribution of intensity ascribed to the Ru—O scattering path for 4H/fcc Ru—Ni. These fine WT contour plot differences should derive from the diverse atomic arrangements of unusual heterophase 4H/fcc Ru—Ni and their common phase nanocrystals. The detailed structural parameters obtained through EXAFS fitting are presented in FIG. 47.

### Example 9

### Electrochemical Performance of the Catalyst in Aprotic Li—CO₂ Battery/Cell

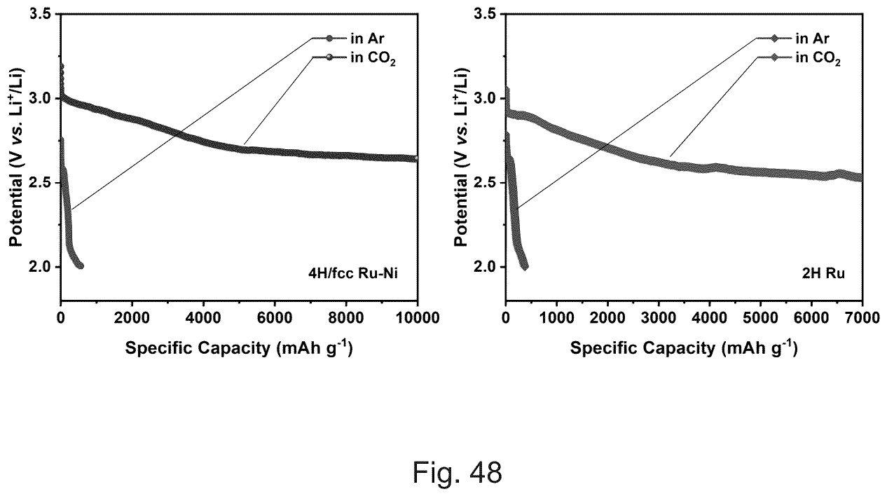

Without specified or otherwise, all the aprotic Li—CO₂ cells in this work were assembled using coin-type rather than Swagelok configuration. Benefitting from the high atomic utilization efficiency of 4H/fcc Ru—Ni, all the applied current densities and capacities were normalized to the total weight of metal nanostructures and carbon nanotube (CNT) additives (i.e., mA g⁻¹_{metal+CNT}, mAh g⁻¹_{metal+CNT}) loaded on cathodes. Before measurements, it was confirmed that there is negligible capacity contribution by Li intercalation and pseudo-capacitance (FIG. 48).

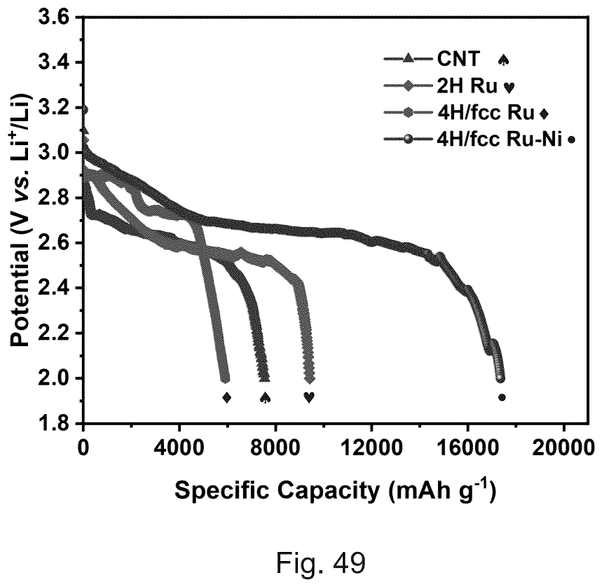

Galvanostatic discharge was first applied to evaluate the electrochemical performances of as-assembled aprotic Li—CO₂ cells. Upon fully discharged to 2 V, 4H/fcc Ru—Ni delivers a large specific capacity of 17360.1 mAh g⁻¹ at 50 mA g⁻¹, which is about 2.94, 1.84 and 2.30 times those of 4H/fcc Ru, 2H Ru and bare CNT, respectively (FIG. 49). Combined with the highest average working plateau at ˜2.7 V, 4H/fcc Ru—Ni has reached an ultrahigh energy density of 45996.5 Wh kg⁻¹_{cat}, much superior over the other control samples.

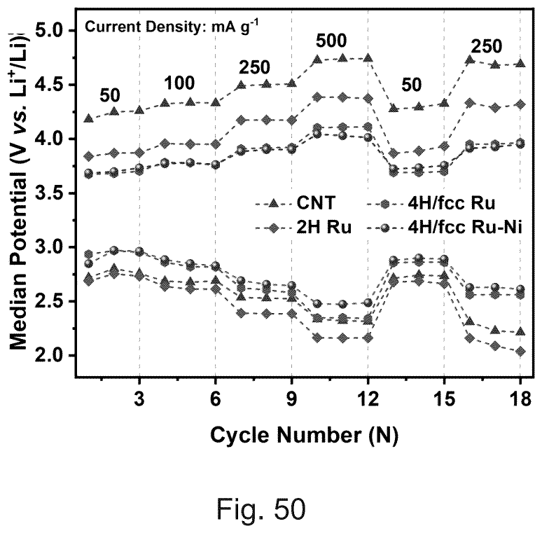

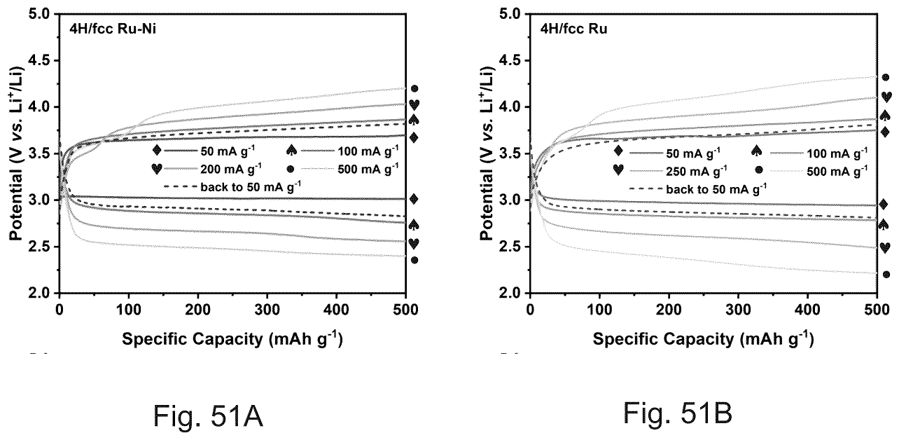

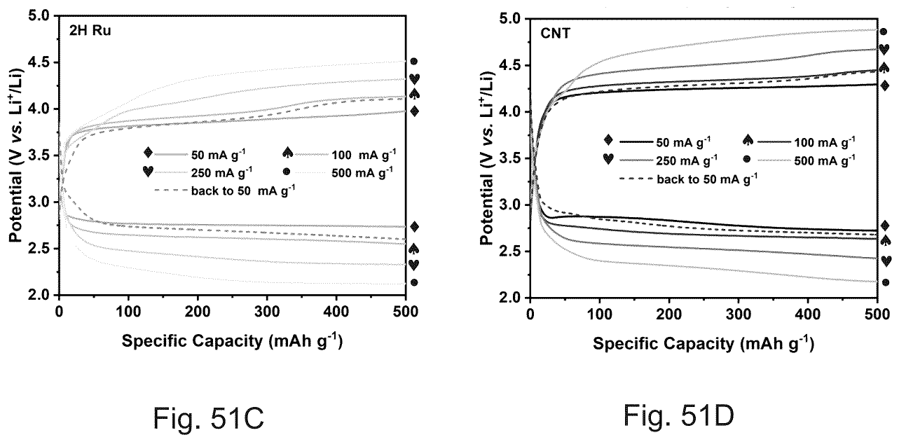

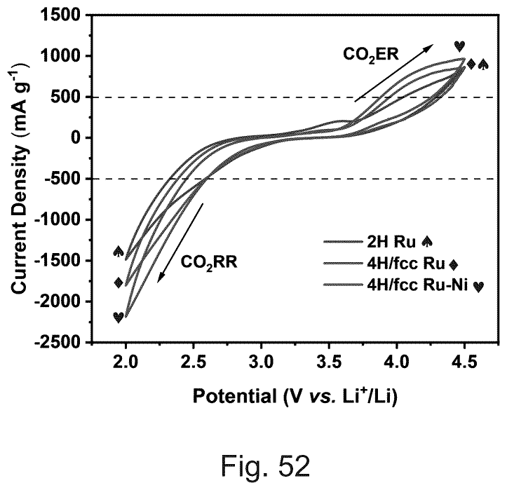

Subsequently, rate capability measurements were conducted to unravel the electroactivity of as-synthesized Ru-based catalysts at various rates. From FIG. 50, it can be seen that both unconventional 4H/fcc Ru and common 2H Ru can facilitate the decomposition of discharge products but the former is more efficient and meanwhile capable of accelerating CO₂RR, in contrast to CNTs. On the basis of 4H/fcc Ru, the construction of 4H/fcc Ru—Ni heteronanostructures contributes to further decreasing the round-trip discharge/charge overpotentials especially at high rates (FIGS. 51A-51D). In detail, for 4H/fcc Ru—Ni, the discharge plateaus are around 3.01, 2.85, 2.66 and 2.49 V at the current densities of 50, 100, 250 and 500 mA g⁻¹, respectively. It is also noticeable that the discharge and charge potentials of 4H/fcc Ru—Ni can return to the initial states when the current density goes back to 50 mA g⁻¹ and then 250 mA g⁻¹. However, distinct performance decay can be observed on 2H Ru and CNT cathodes. The higher cathodic and anodic current densities of 4H/fcc Ru—Ni cathode within the corresponding CO₂RR and CO₂ER potential ranges in cyclic voltammetry (CV) measurements further corroborate its faster round-trip reaction kinetics for aprotic Li—CO₂ electrochemistry (FIG. 52).

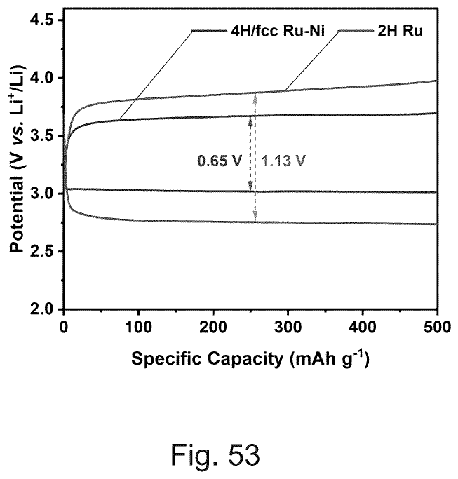

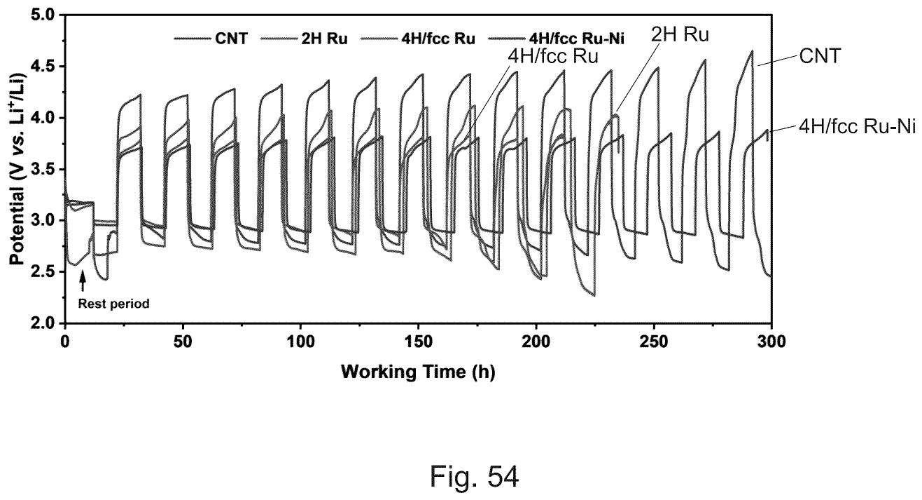

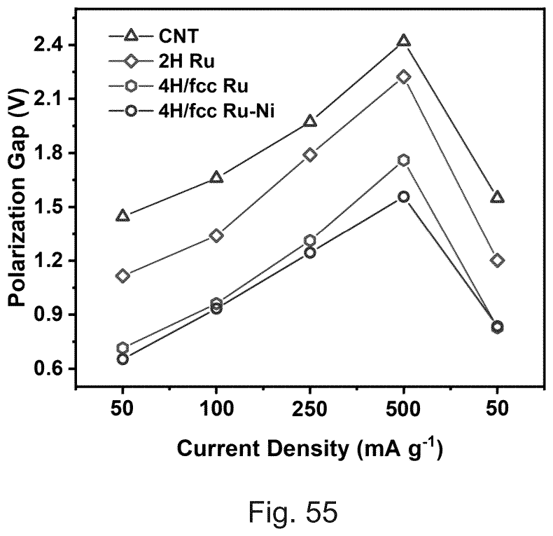

Benefitting from the lower energy barriers of CO₂RR and CO₂ER, 4H/fcc Ru—Ni demonstrates an ultrasmall discharge-charge voltage difference of 0.65 V at 50 mA g⁻¹, while this value for common 2H Ru is as high as 1.13 V at the same conditions and its voltage polarization is much more rapid with cycles (FIGS. 53 and 54). When the current density increases to 500 mA g⁻¹, the advantage of 4H/fcc Ru—Ni in lowering overpotential gap becomes more obvious (1.55, 1.76, 2.22 and 2.42 V for 4H/fcc Ru—Ni, 4H/fcc Ru, 2H Ru and CNT, respectively), as shown in FIG. 55.

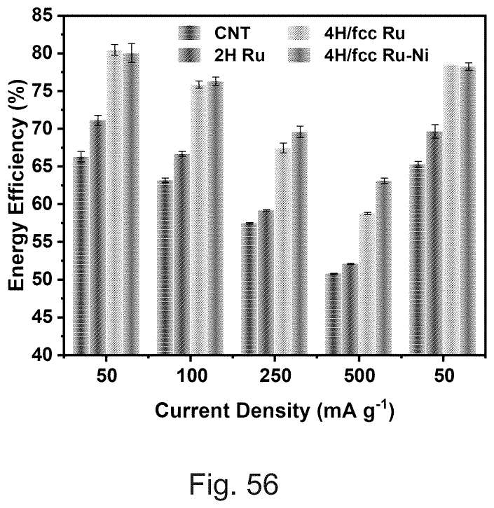

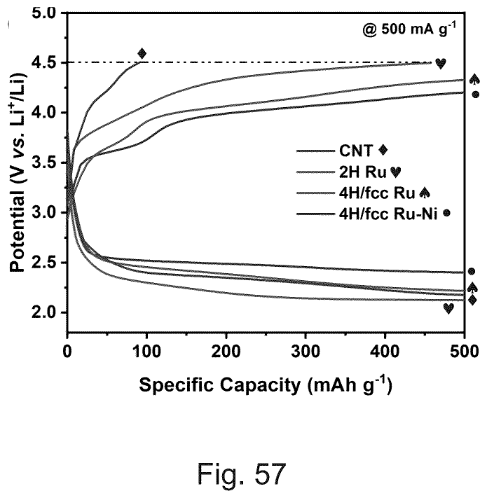

As a reflection of the aforementioned favorable indexes, the Li—CO₂ cells with 4H/fcc Ru—Ni exhibit a small decline on energy efficiency from ˜80.0% at 50 mA g⁻¹ to ˜63.1% at 500 mA g⁻¹, surpassing all the other cells with bare Ru nanostructures and commercial CNTs (FIG. 56). In particular, if 4.5 V is assumed as the upper cut-off potential, the incorporation of 4H/fcc Ru—Ni into cathode catalysts enables recharging at high rates (e.g., 500 mA g⁻¹), which is impossible for the cells with traditional 2H Ru and bare CNTs (FIG. 57).

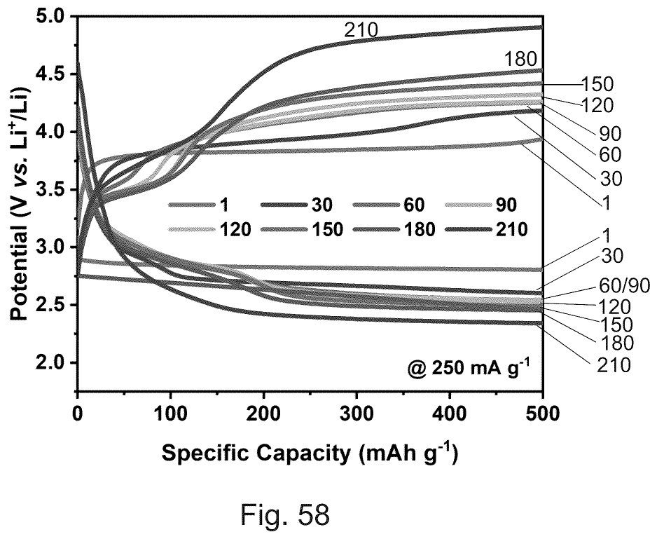

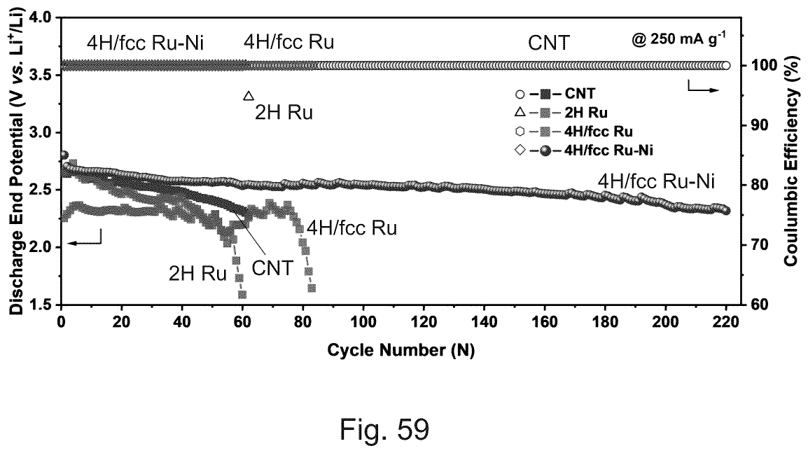

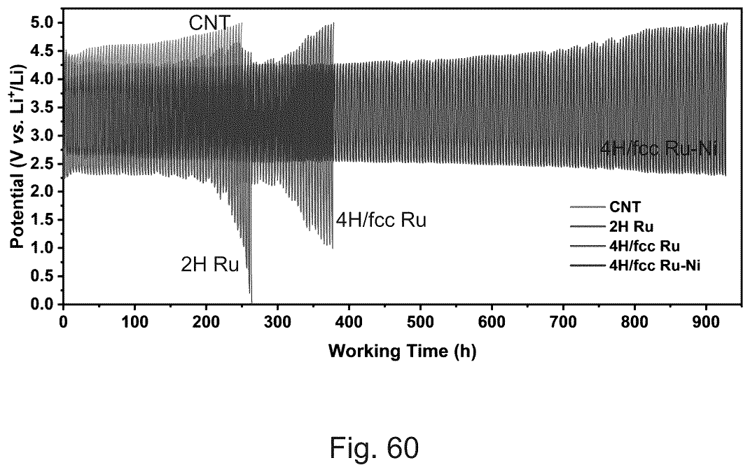

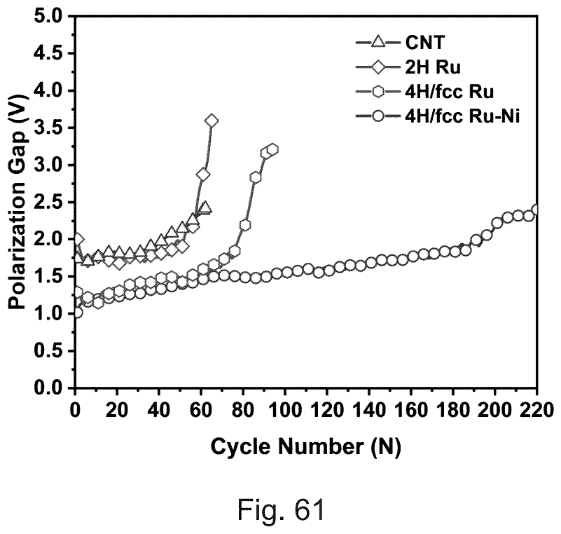

It is believed that long-term cycling stability is an important indicator to assess the reversibility of Li—CO₂ electrochemistry. As shown in FIG. 58, 4H/fcc Ru—Ni demonstrates relatively stable discharge-charge profiles during cycling at 250 mA g⁻¹ with the curtailing capacity of 500 mAh g⁻¹. Although the 4H/fcc Ru—Ni based Li—CO₂ cell undergoes such large current impacts, it can always deliver discharge plateaus at around 2.5 V and steadily last for 220 cycles (>800 h). For comparison, there are continuous potential decays in other cells and sudden death occurs at the 83^{th} cycle for 4H/fcc Ru, the 60^{th} cycle for 2H Ru and the 62^{th} cycle for CNTs under the same working conditions (FIGS. 59-61).

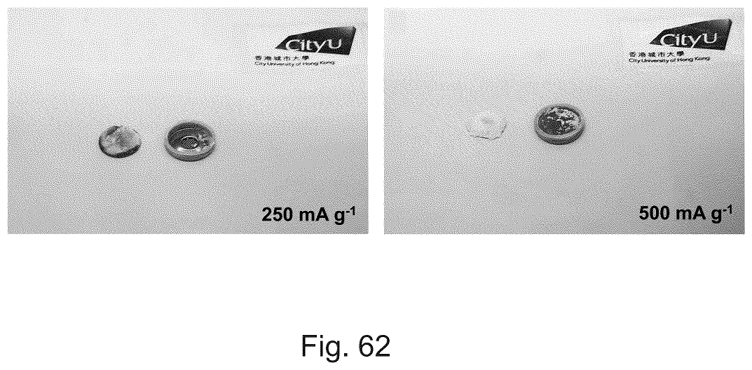

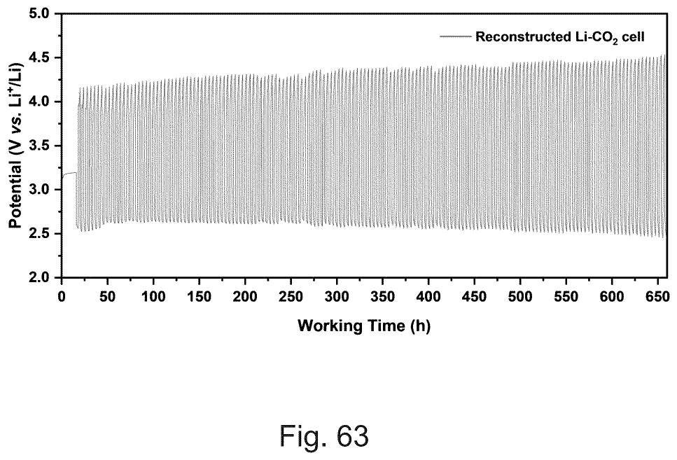

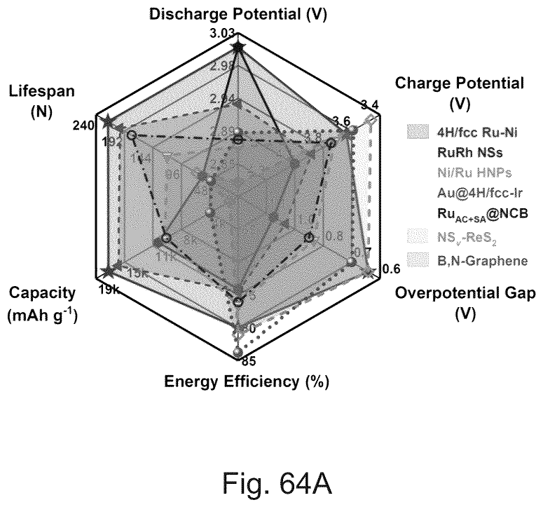

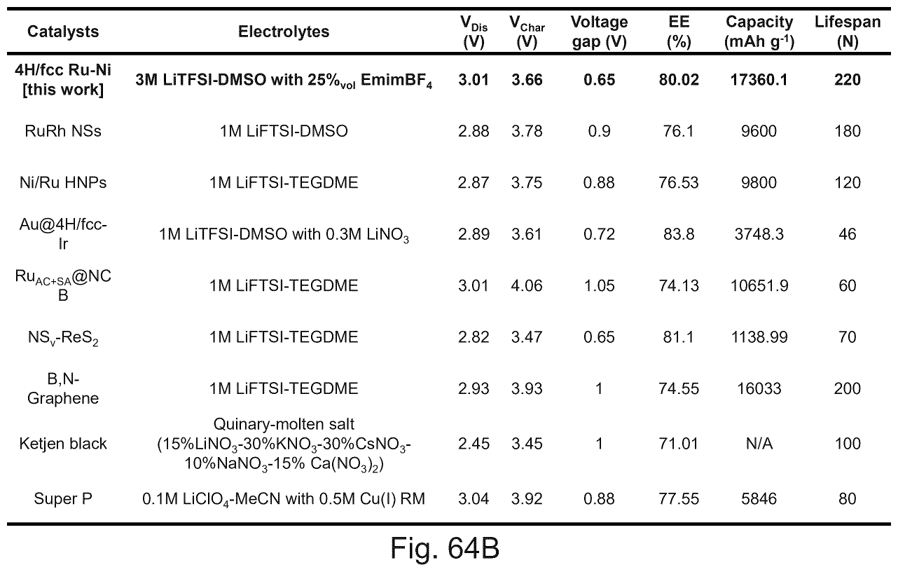

Failure analysis reveals that the lithium anode corrosion (attacked by CO₂ and free electrolyte solvent) would be the main factor resulting in the battery collapse (FIG. 62), given that the same 4H/fcc Ru—Ni cathode extracted from the collapsed cell can enable normal operation after mechanical recharge for at least another 150 cycles (FIG. 63). As illustrated in FIGS. 64A and 64B, few solid catalysts reported previously for aprotic Li—CO₂ batteries can demonstrate comprehensive performances comparable to 4H/fcc Ru—Ni.

Based on the above, it is believed that the unconventional phase metal-metal heteronanostructures of the present invention is able to boost the redox reaction kinetics of Li—CO₂ batteries.

### Example 10

Analysis of the Discharge Products from the Aprotic Li—CO₂ Battery/Cell

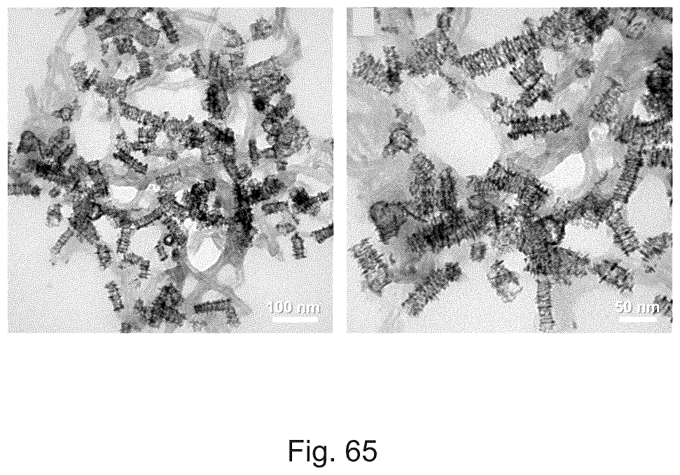

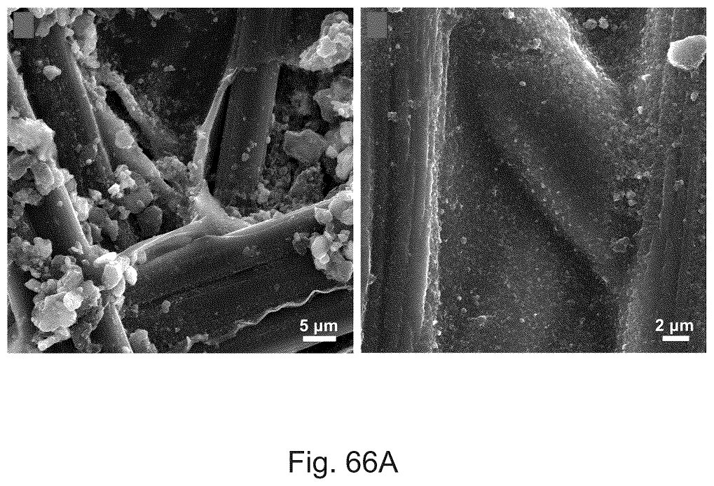

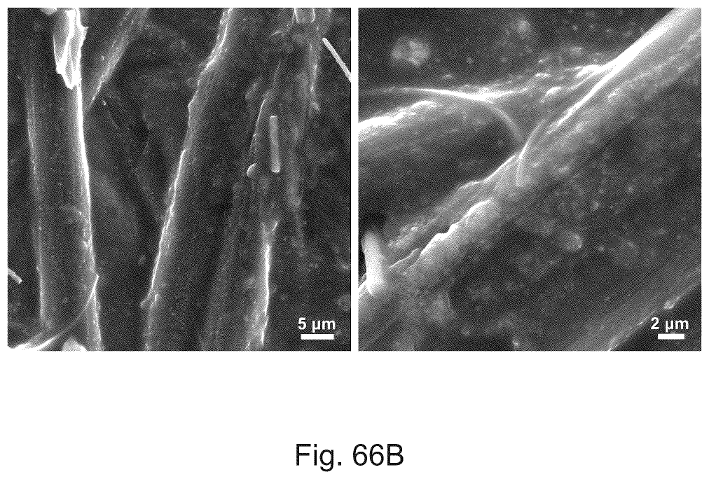

Discharge product analysis was conducted to reveal the mechanism differences of Li—CO₂ electrochemistry modulated by unconventional 4H/fcc Ru—Ni and common 2H Ru nanostructures. Different from the clean surface of fresh electrodes (FIGS. 65 and 66A), it shows plenty of soft film-like discharge products covering catalysts on 4H/fcc Ru—Ni cathodes after discharging to 500 mAh g⁻¹ at a low rate of 50 mA g⁻¹ (FIG. 66B).

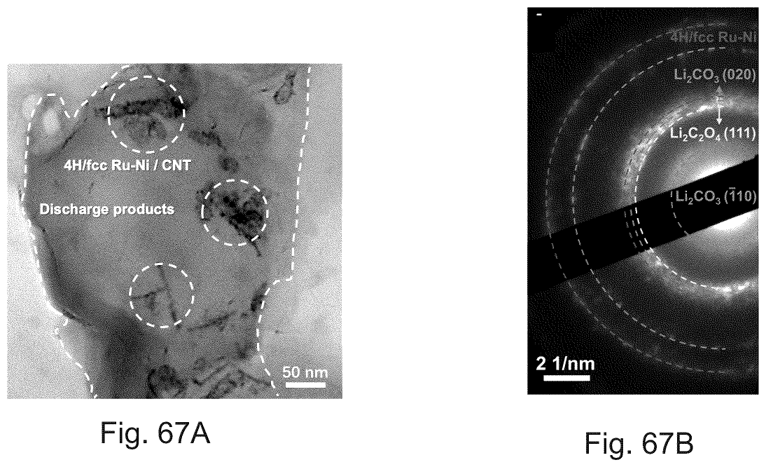

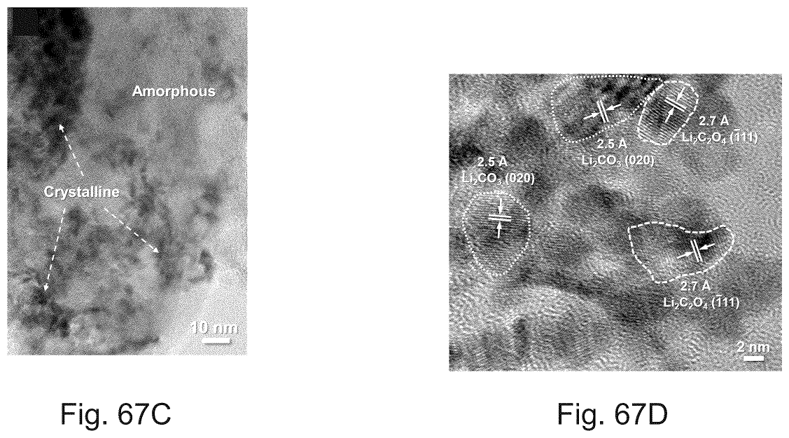

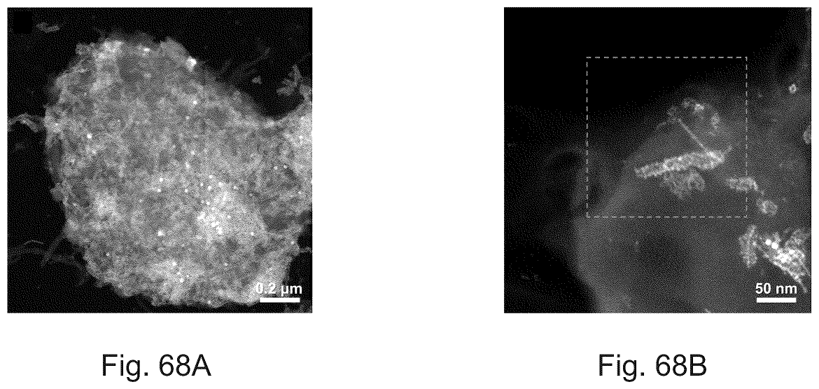

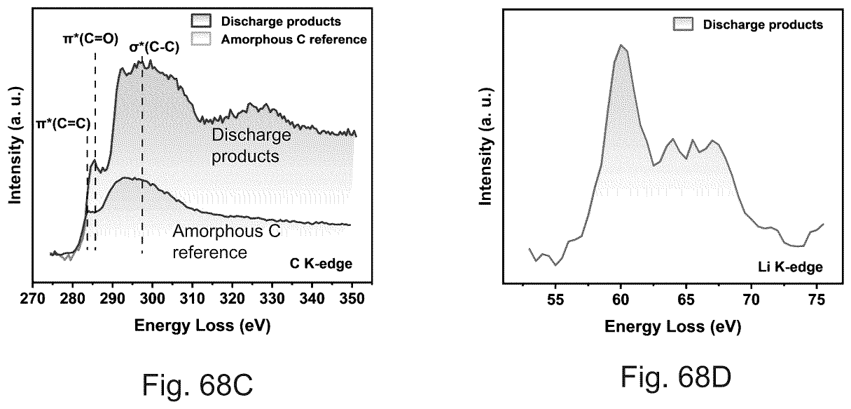

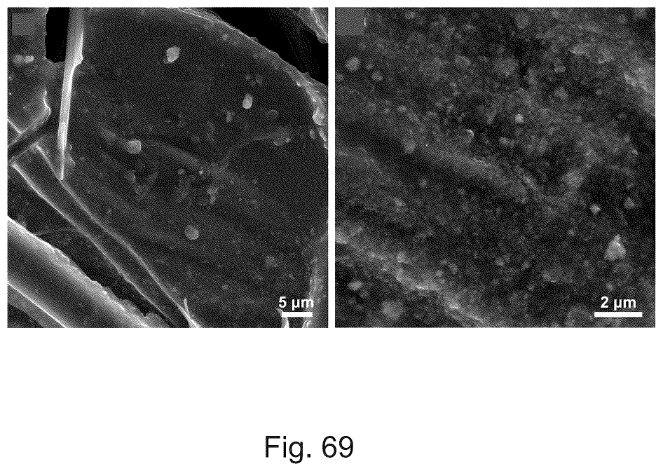

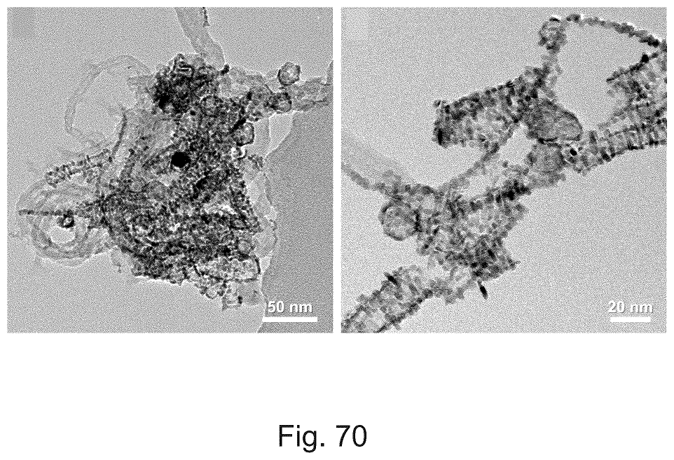

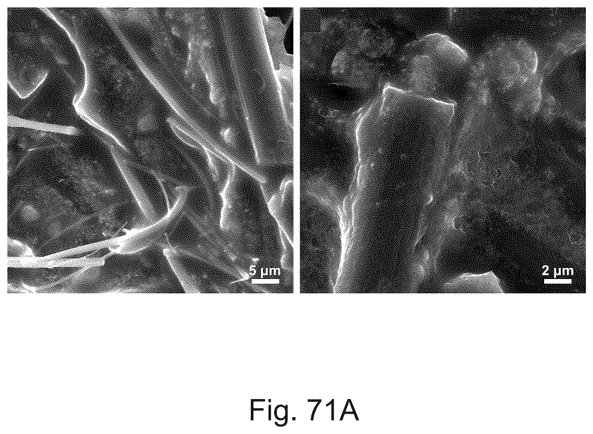

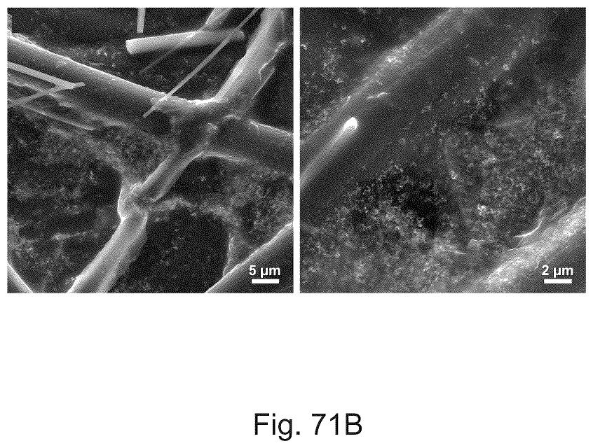

TEM and selected-area electron diffraction (SAED) characterizations indicate that amorphous and low-crystalline Li₂CO₃/carbon agglomerates associated with Li₂C₂O₄ constitute the discharge products (FIGS. 67A-67D). The π* (C═O) and Li signals in EELS spectra further confirm the generation of lithium oxycarbides (FIGS. 68A-68D). Upon fully recharged, these discharge products were decomposed completely (FIGS. 69 and 70). On 2H Ru cathodes, analogous discharge products were generated at the same discharged state, but there were bits of undegraded residues found at the recharged state (FIGS. 71A and 71B).

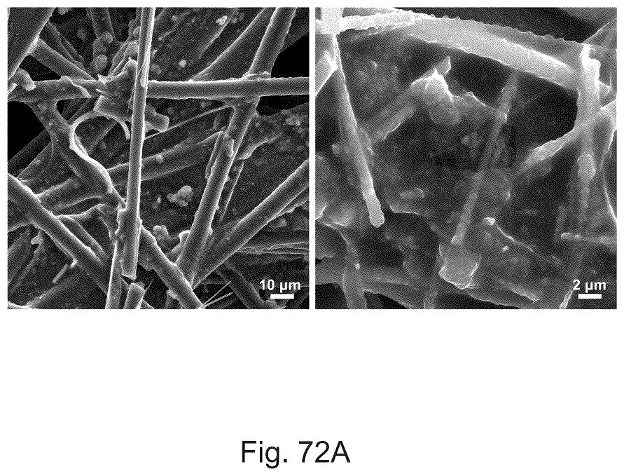

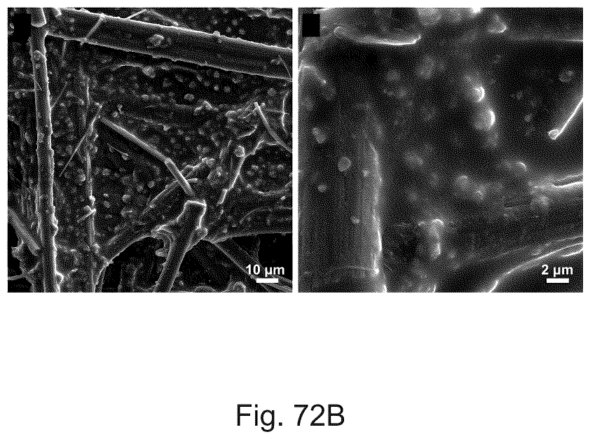

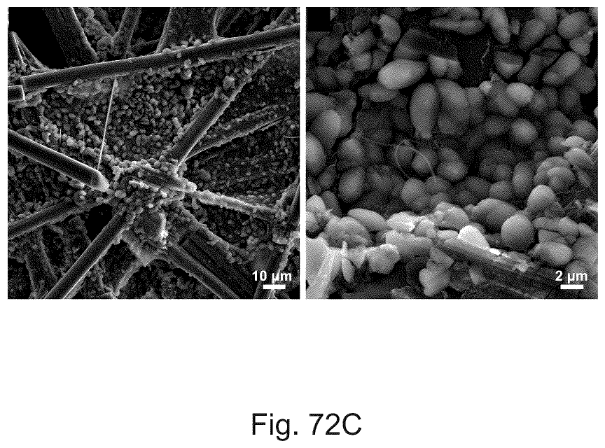

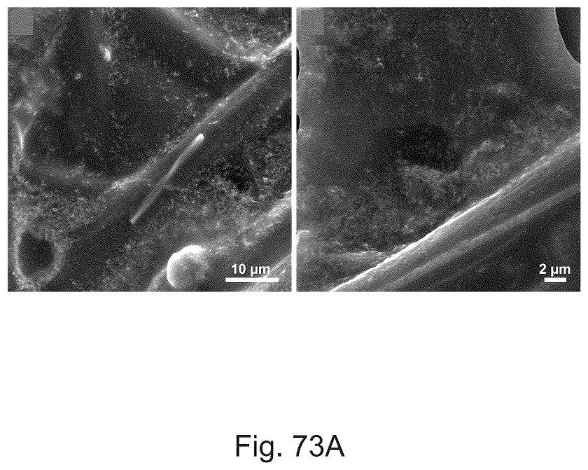

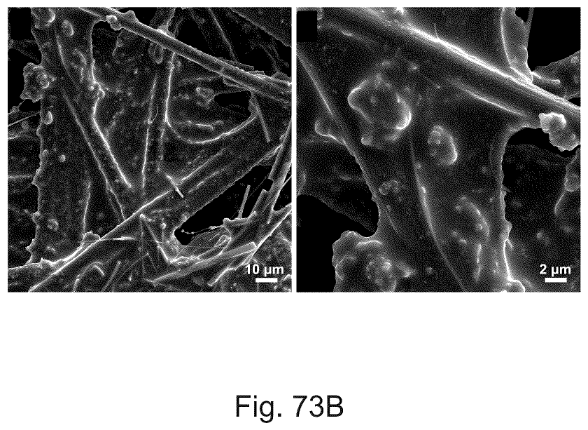

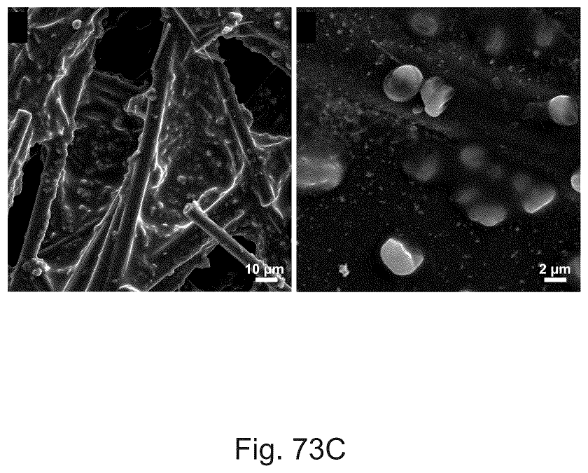

The properties of discharge products at different discharge depths at 500 mA g⁻¹ were examined. After the cells were discharged to 500 mAh g⁻¹, discharge products on 4H/fcc Ru—Ni cathodes exist as waved gels anchored with submicron-sized islands (FIG. 72A). As the curtailing capacity increased, those islands gradually grow towards particles embedded in gels (2500 mAh g⁻¹) (FIG. 72B) and then fully switch to micron-sized ellipsoids (5000 mAh g⁻¹) (FIG. 72C). However, different phenomena were found on 2H Ru cathodes, where the film-like discharge products always dominate at the same discharge depth and only limited large-sized particles can be recognized at 5000 mAh g⁻¹ (FIGS. 73A-73C).

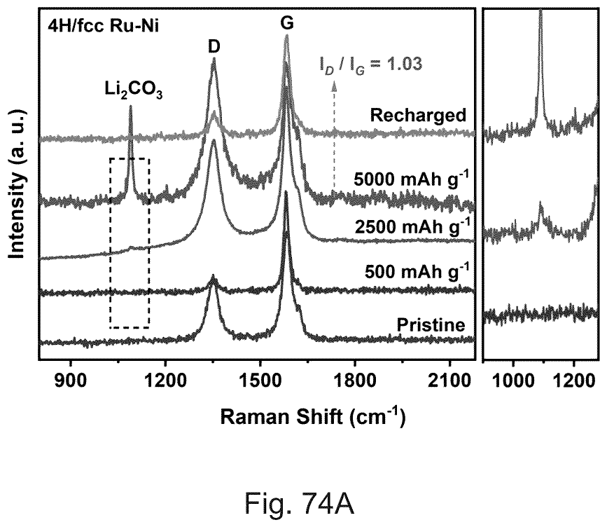

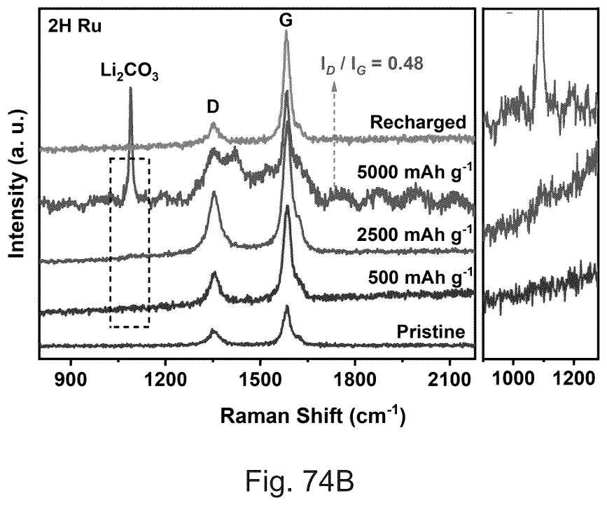

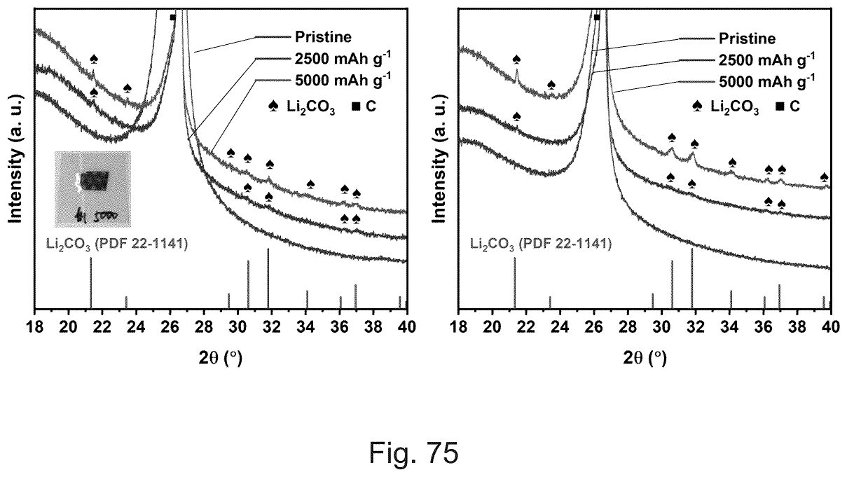

According to the Raman and XRD results (FIGS. 74A-74B and 75), at least Li₂CO₃ and C exist in the discharge products on both cathodes at 2500 mAh g⁻¹ and 5000 mA h⁻¹, but the formed carbon has lower crystallinity and more abundant defects on 4H/fcc Ru—Ni cathodes given the much higher ID/IG ratio. These observations suggest that 4H/fcc Ru—Ni is able to activate the outer Helmholtz plane near electrode surface, thus producing discharge products mainly via the solution mechanism rather than the surface mechanism to achieve a much greater specific capacity.

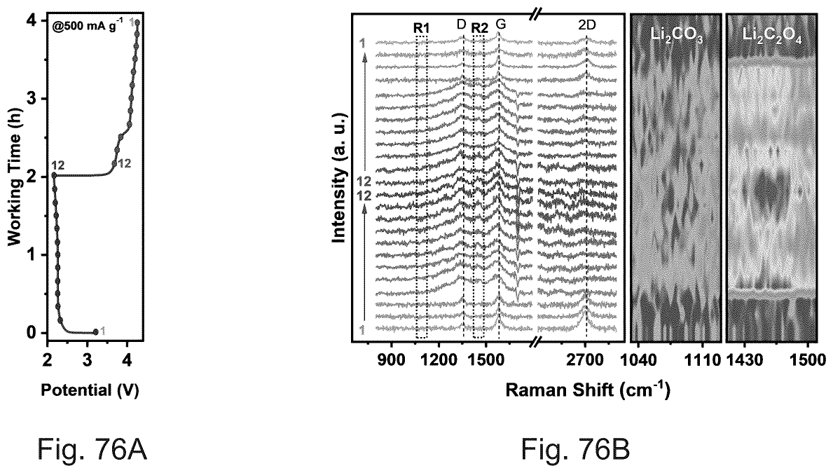

The in-situ Raman was utilized to investigate the product evolution on 4H/fcc Ru—Ni cathodes with a larger mass loading during cycling at 500 mA g⁻¹ within 1000 mAh g⁻¹, in light of the absence of signals in above ex-situ characterizations for standard cathodes (FIGS. 76A and 76B). Unexpectedly, besides the D, G and 2D bands ascribed to carbon species, a wide stretching peak at around 1465 cm⁻¹ (marked by R2) gradually appears and then disappears as the discharge-charge process proceeds, indicating the reversible formation and decomposition of Li₂C₂O₄.

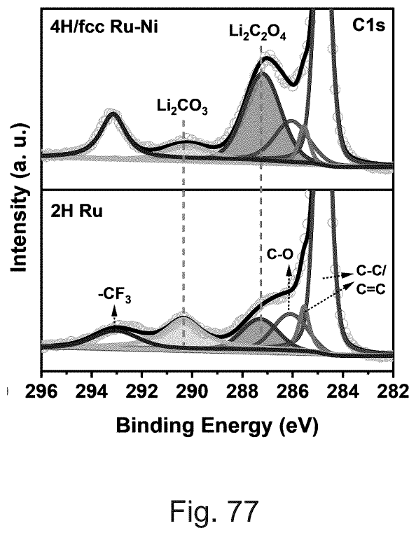

For comparison, the Li₂CO₃ signal, a characteristic peak at ˜1085 cm⁻¹ (marked by R1), shows a weak intensity variation. It means that the Li—CO₂ electrochemistry happening on 4H/fcc Ru—Ni cathode does not only depend on usual Li₂CO₃+C as the main discharge products within the initial high-rate discharge stage, which is in good agreement with the predictions by DFT calculations. This is further evident by XPS analysis. From the high-resolution C is spectra in FIG. 77, it shows two obvious peaks ascribed to CO₃²⁻ and C₂O₄²⁻ on standard 2H Ru cathodes after discharging to 500 mAh g⁻¹ at 500 mA g⁻¹, while a much stronger C₂O₄²⁻ peak together with a very weak CO₃²⁻ peak is recognized on 4H/fcc Ru—Ni cathode at the same discharged state. The integral area ratio between C₂O₄²⁻ and CO₃²⁻ peaks is calculated to be 3.38 for 4H/fcc Ru—Ni, which is over 4 times that (0.84) for the common 2H Ru. It suggests that 4H/fcc Ru—Ni can stabilize partial Li—CO₂ reactions at the 2-electron transfer stage generating intermediate Li₂C₂O₄ at high rates, in contrast to 2H Ru on which plenty of Li₂C₂O₄ converts to Li₂CO₃ spontaneously through disproportionation reactions.

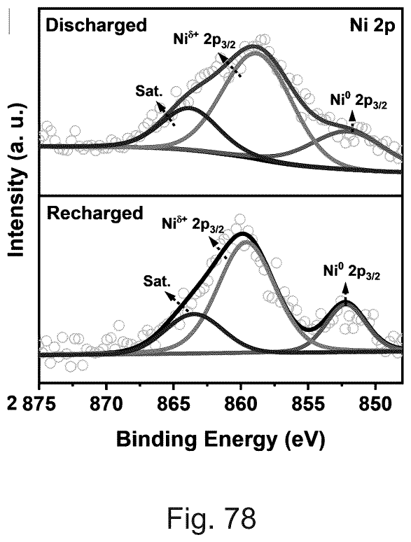

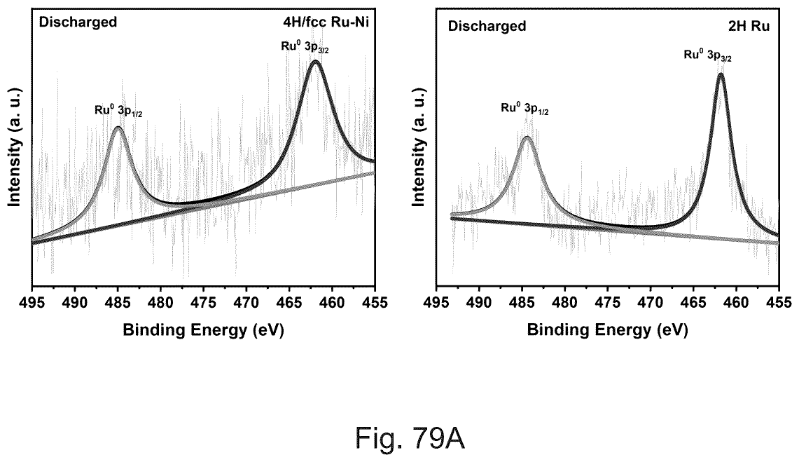

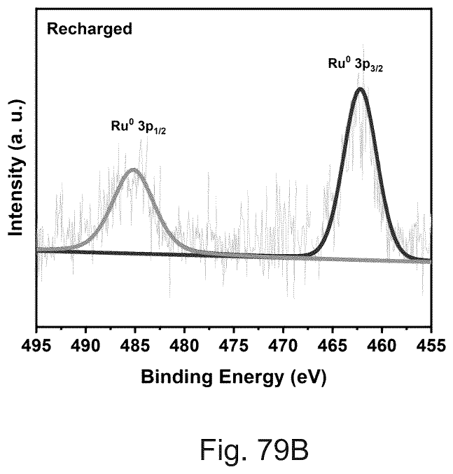

When further exploring the chemical states of metal elements, it reveals a lower proportion of zero-valent Ni at the discharged state than that at the recharged state (FIG. 78), while there is not an obvious valence change of Ru on 4H/fcc Ru—Ni and 2H Ru cathodes during cycling (FIGS. 79A and 79B). Hence, it is believed that the introduced Ni component in 4H/fcc Ru—Ni plays a critical role of “metal-oxygen coupling” to stabilize Li₂C₂O₄ through coordinative electron transfer, and the Ru component should be mainly responsible for enhancing the adsorption towards reactive materials and facilitating the uniform deposition of low-crystalline film/gel-like discharge products along the Frank-van der Merwe mode.

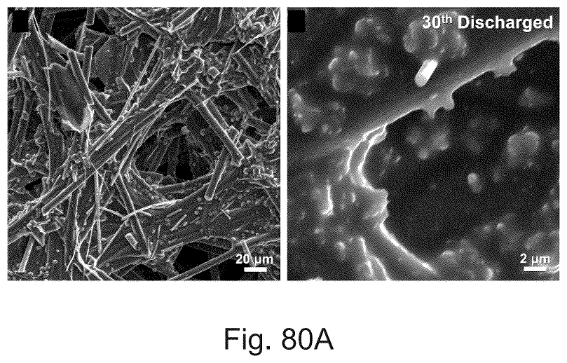

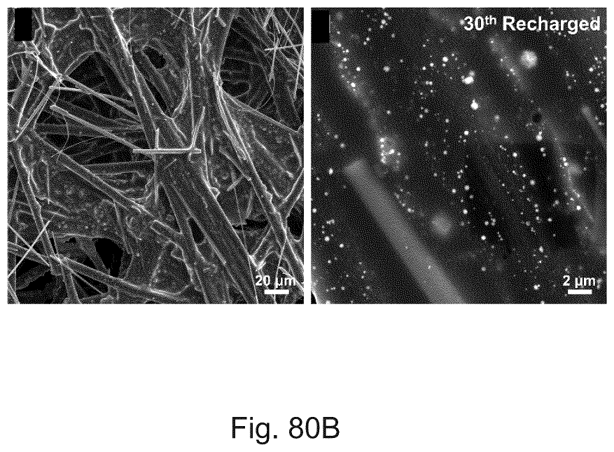

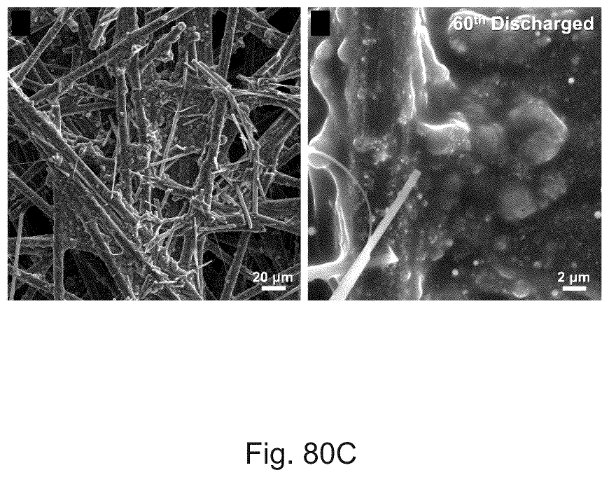

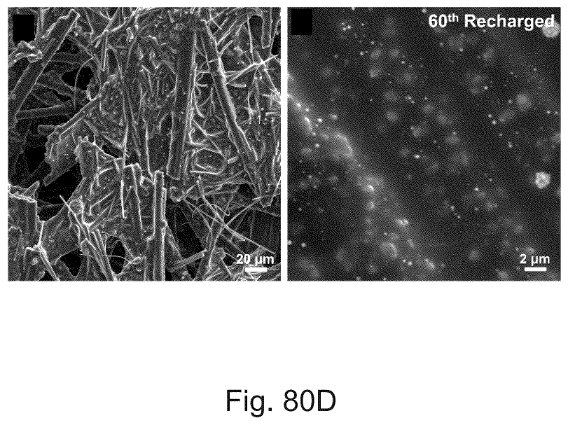

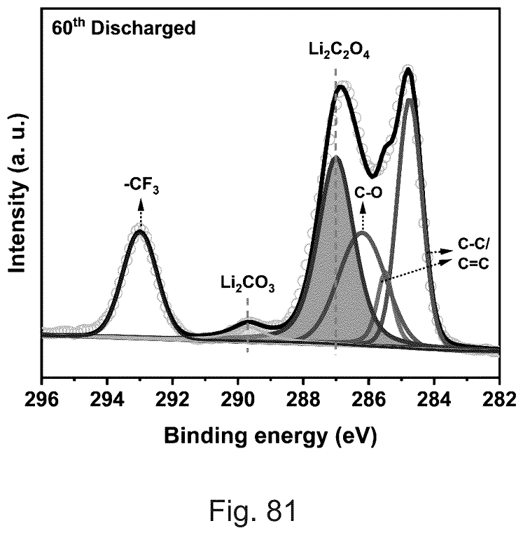

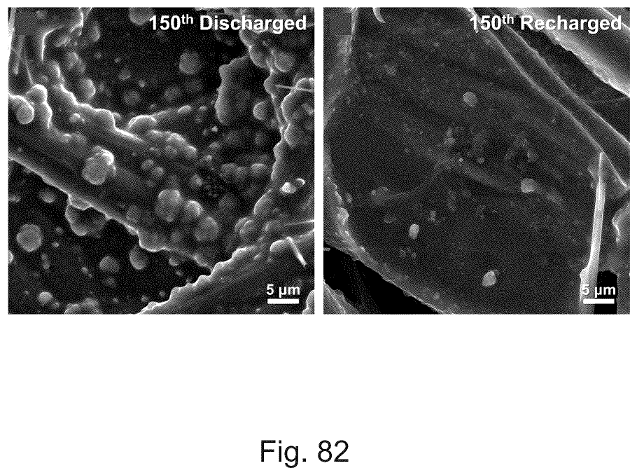

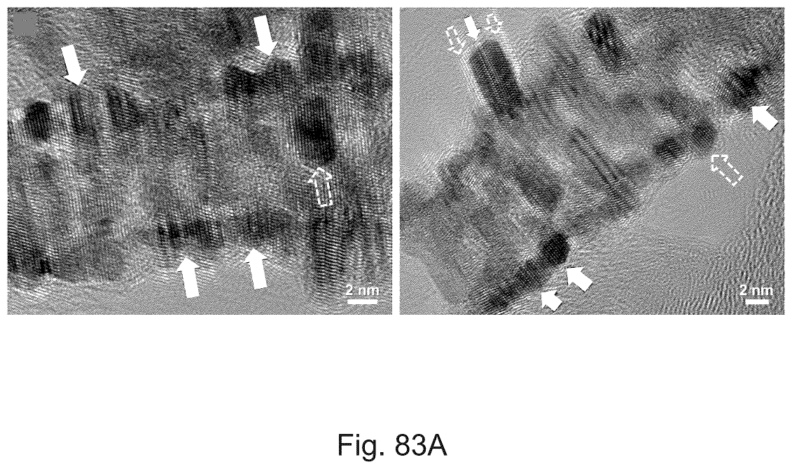

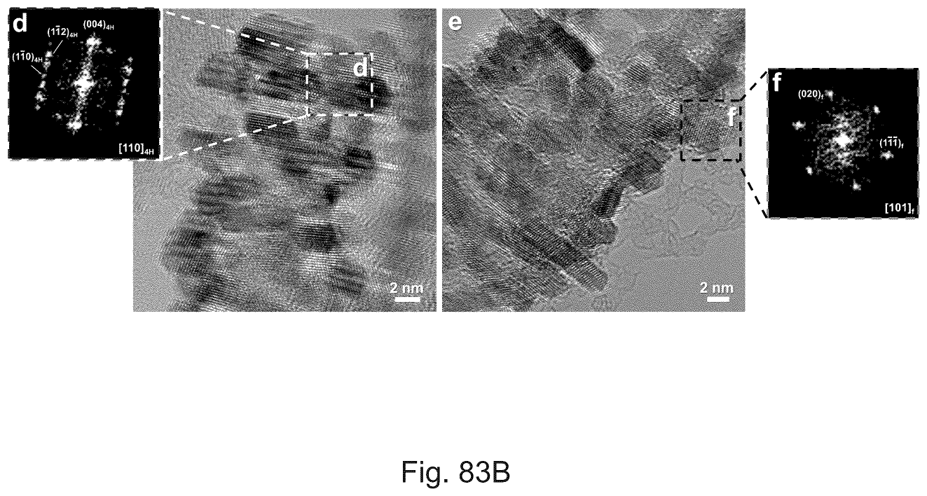

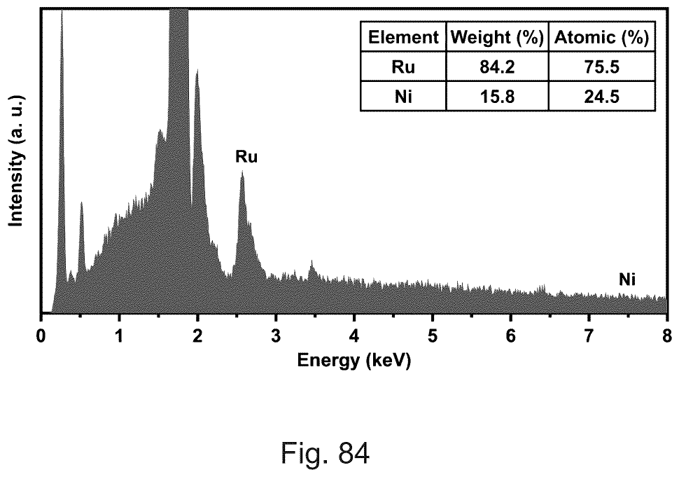

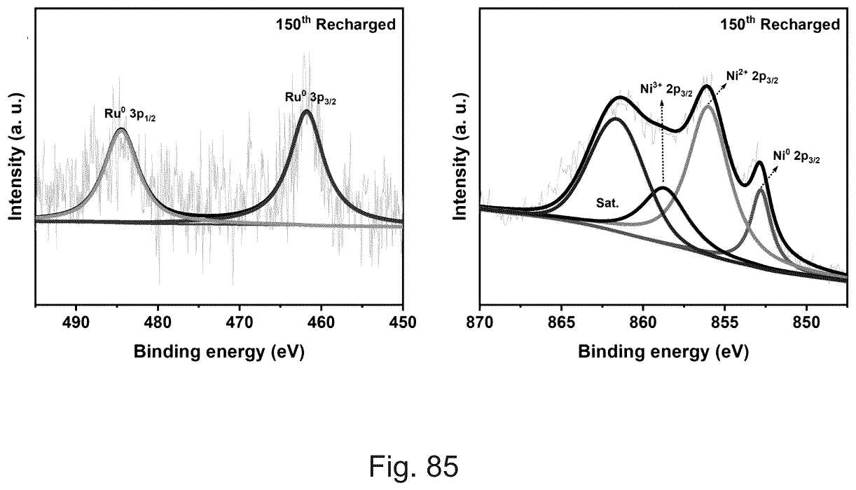

The morphology evolution of 4H/fcc Ru—Ni cathodes has been further checked at the 30^{th} and 60^{th} cycle (FIGS. 80A-80D), of which the observation is very similar to that at the initial cycle. XPS analysis reveals that Li₂C₂O₄ still dominates the discharge products after the 60^{th} discharge process (FIG. 81). No obvious residues of discharge products can be recognized on the catalyst surface even after 150 cycles (FIG. 82). Noteworthily, the microstructure, crystal phase, composition and surface state of 4H/fcc Ru—Ni are well maintained after the long-term cycling (FIGS. 83A-83B, 84 and 85).

To further understand the underlying CO₂ER mechanisms, in-situ differential electrochemical mass spectrometry (DEMS) measurements during charging were carried out. At the present stage, it is believed that there are three possible decomposition ways of discharge products when charging. It is believed that the completely reversible oxidation is the most ideal pathway via equation (1), but there are reports suggesting that that the synergistic degradation of Li₂CO₃—C mixture seems not to be an elementary reaction with proper stoichiometric numbers.

$$2 L {i}_{2} C {O}_{3} + C \to 4 L {i}^{+} + 3 C {O}_{2} + 4 {e}^{-} \qquad ( 1 )$$

It is believed that a multiple-step process composed of the preliminary decomposition of Li₂CO₃ should be involved, via electrochemical reactions of equation (2) and equation (3) and the following oxidation of concomitant C into CO and CO₂ by singlet oxygen (¹O₂) or superoxide radicals (O₂^{·-}) via spontaneous chemical reactions of equation (4) (Note that it is an illustration rather than a stoichiometric reaction).

$$2 L {i}_{2} C {O}_{3} \to 4 L {i}^{+} + 2 C {O}_{2} + {}^{1} {O}_{2} + 4 {e}^{-} \qquad ( 2 )$$

$$2 L {i}_{2} C {O}_{3} \to 4 L {i}^{+} + 2 C {O}_{2} + {O}_{2}^{\cdot -} + 3 {e}^{-} \qquad ( 3 )$$

$${O}_{2}^{\cdot -} ( {}^{1} {O}_{2} ) + m C \to ( 2 m - 2 ) C O + ( 2 - m ) C {O}_{2} \qquad ( 4 )$$

When cells are operated at high rates, it is believed that O₂^{·-} and ¹O₂ easily overflow from discharge products and attack carbon additives/electrolyte, leading to rapid collapse or even sudden death of batteries. Nevertheless, if discharge behavior can be tuned towards the Li₂C₂O₄ path, there are not similar concerns, because the Li₂C₂O₄ decomposition occurs at a lower overpotential and only produces moderate species via equation (5).

$$L {i}_{2} {C}_{2} {O}_{4} \to 2 L {i}^{+} + 2 C {O}_{2} + 2 {e}^{-} \qquad ( 5 )$$

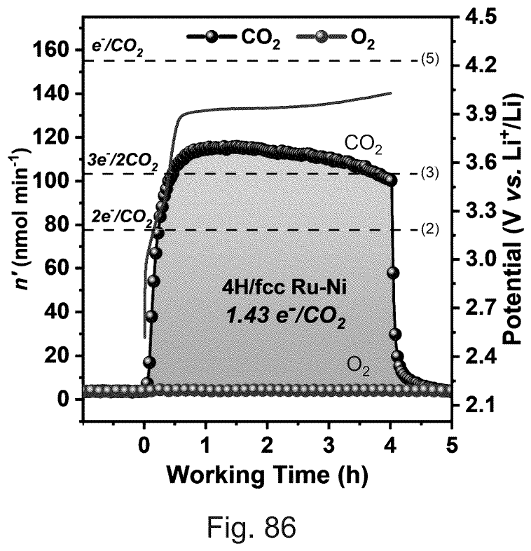

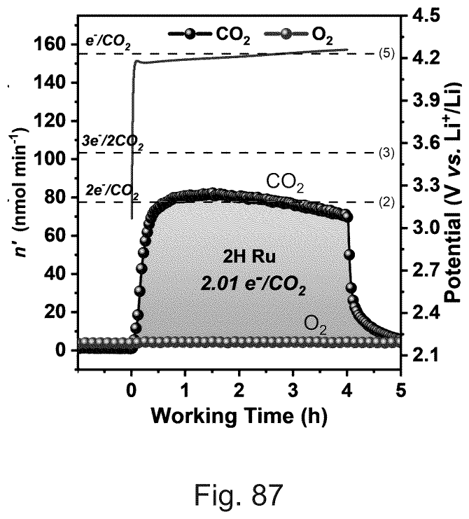

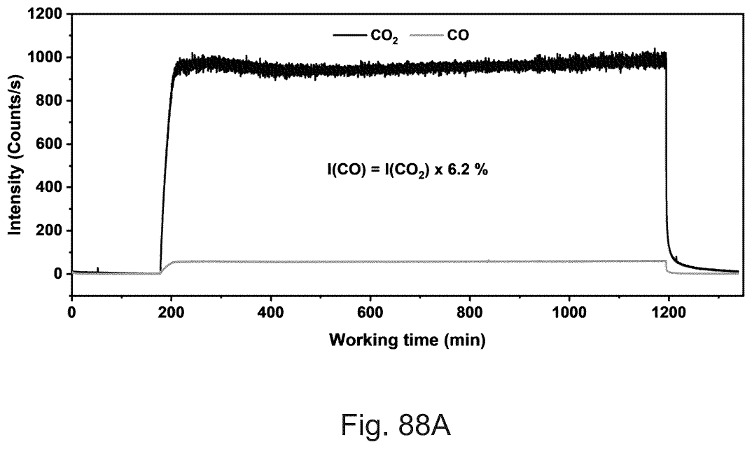

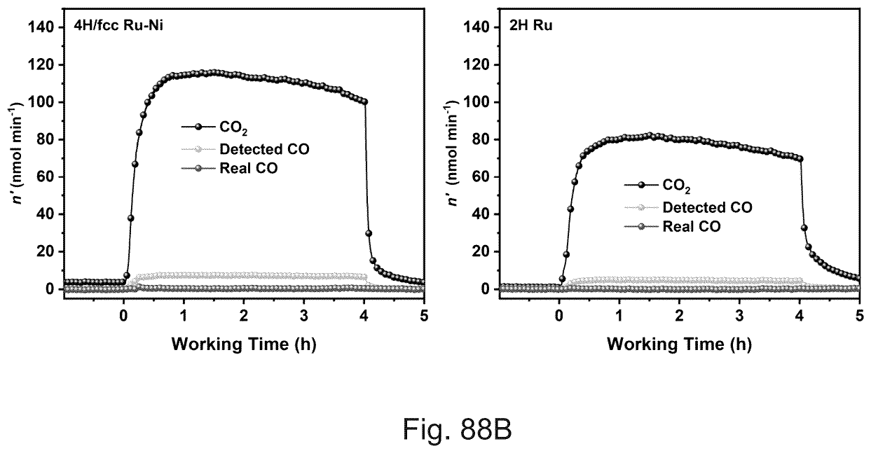

From FIG. 86, the balanced CO₂ evolution rate profile on 4H/fcc Ru—Ni cathode lies in the middle of the standard lines ascribed to 2e⁻/CO₂ and 1e⁻/CO₂ (charge-to-mass ratio), higher than the one representing 3e⁻/2CO₂. It suggests that CO₂ER happening on 4H/fcc Ru—Ni should contain the synchronous decomposition of Li₂CO₃ and Li₂C₂O₄. For 2H Ru, its balanced CO₂ evolution rate profile is slightly higher but close to 2e⁻/CO₂ (FIG. 87), which indicates that Li₂CO₃ degradation dominates. The negligible CO evolutions in both 4H/fcc Ru—Ni and 2H Ru suggest there is no obvious oxidation of carbon to CO by O₂^{·-} and ¹O₂ (FIGS. 88A and 88B).

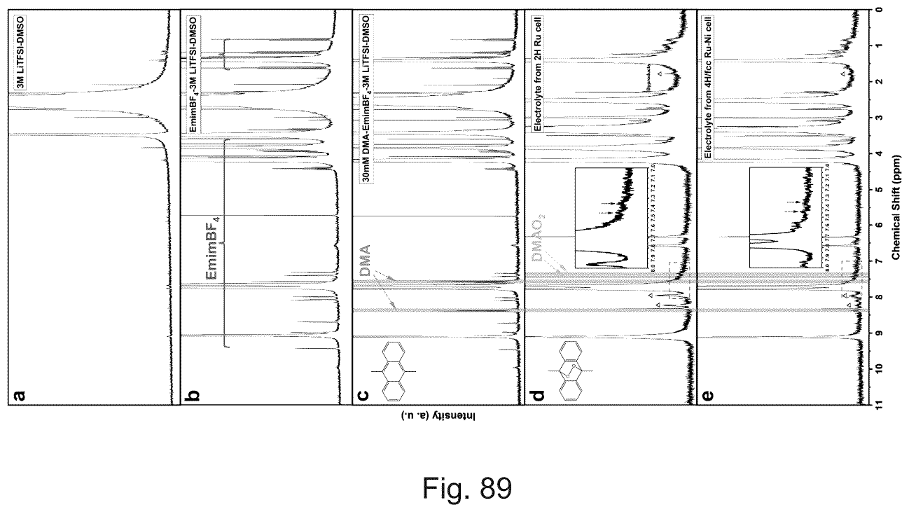

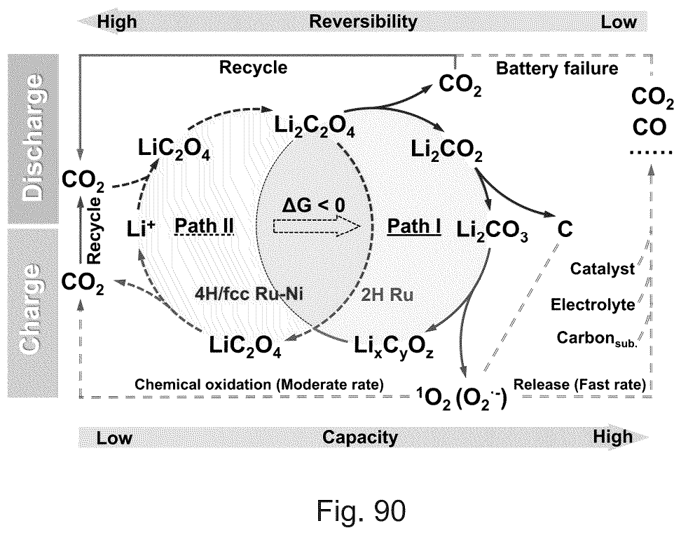

The overall charge-to-mass ratios are calculated to be 1.43 e⁻/CO₂ for 4H/fcc Ru—Ni and 2.01 e⁻/CO₂ for 2H Ru, implying that more efficient CO₂ evolution is electrochemically driven by 4H/fcc Ru—Ni cathodes. Besides, there is less ¹O₂ leakage into the electrolyte of the cells with 4H/fcc Ru—Ni compared to the one with 2H Ru, according to the results of NMR tests using 9,10-dimethylanthracene (DMA) as the molecular trap (FIG. 89). Based on the above analysis, it is believed that 4H/fcc Ru—Ni is beneficial for suppressing the release of aggressive O₂^{·-} and ¹O₂ from Li₂CO₃/C agglomerations upon charging through the reversible formation of Li₂C₂O₄ as partial discharge products. Consequently, there are much less undesired oxidative attacks towards catalysts and electrolytes, as depicted in the schematic illustration of FIG. 90. It is therefore believed that such a unique electrochemical mechanism accounts for the outstanding long-term cycling stability of Li—CO₂ cells with 4H/fcc Ru—Ni.

### Example 11

### Electrochemical Performance of the Catalyst in Aprotic Li-Air Battery/Cell

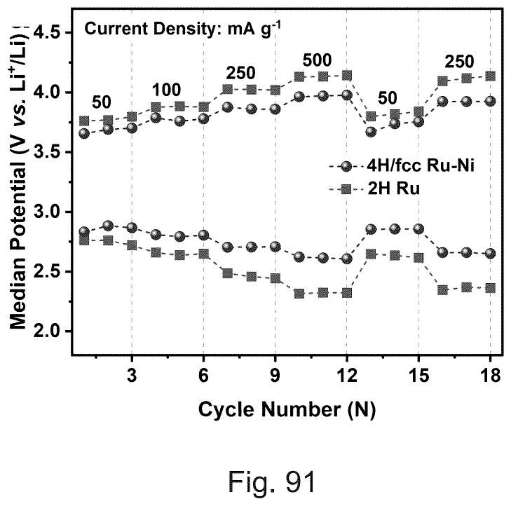

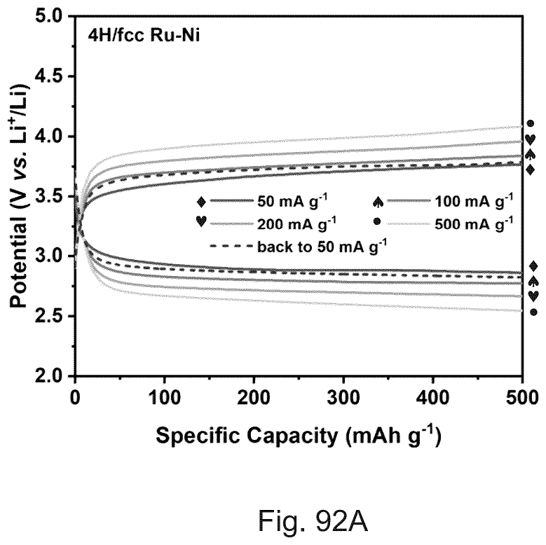

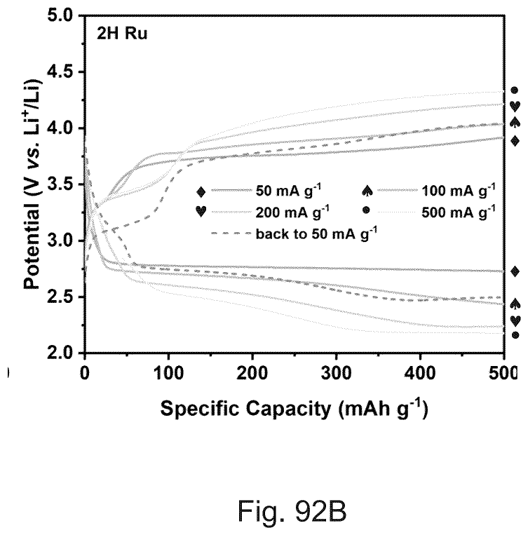

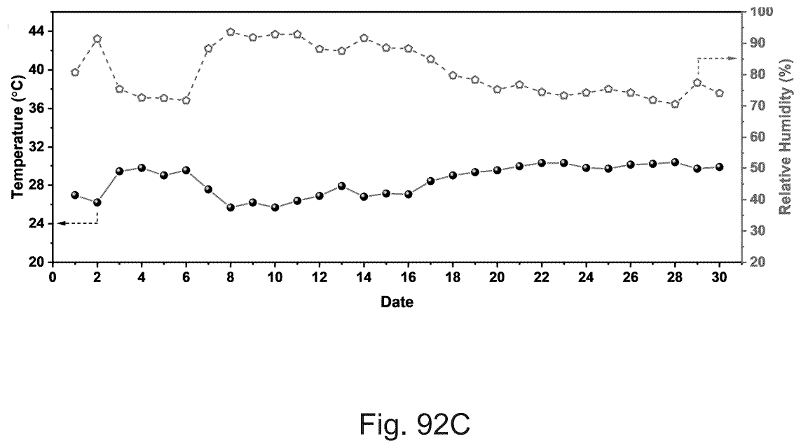

The capability of bifunctionality of the 4H/fcc Ru—Ni in Li-air batteries was also investigated. Li-air batteries were therefore assembled to check whether it is able to facilitate Li—O₂ electrochemistry in real air atmosphere with CO₂ and moisture as the main contaminations. FIG. 91 shows the comparison of rate capabilities of Li-air cells with 2H Ru and 4H/fcc Ru—Ni. It can be seen that 4H/fcc Ru—Ni shows much superior electrochemical performance over the traditional 2H Ru in boosting the reaction kinetics of both Li⁺-mediated oxygen reduction and evolution reactions. The average discharge and charge plateau are 2.88 and 3.65 V for 4H/fcc Ru—Ni at 50 mA g⁻¹, respectively, while the two values are 2.76 and 3.77 V for 2H Ru (FIGS. 92A-92C).

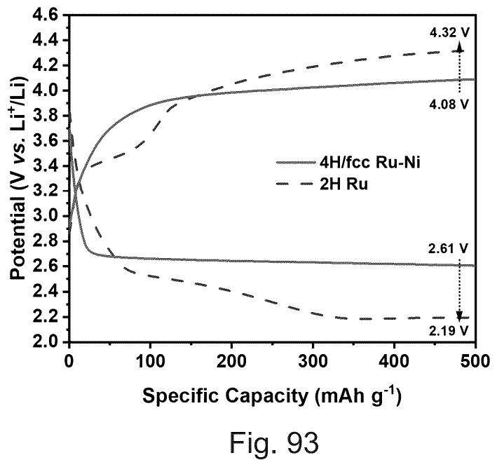

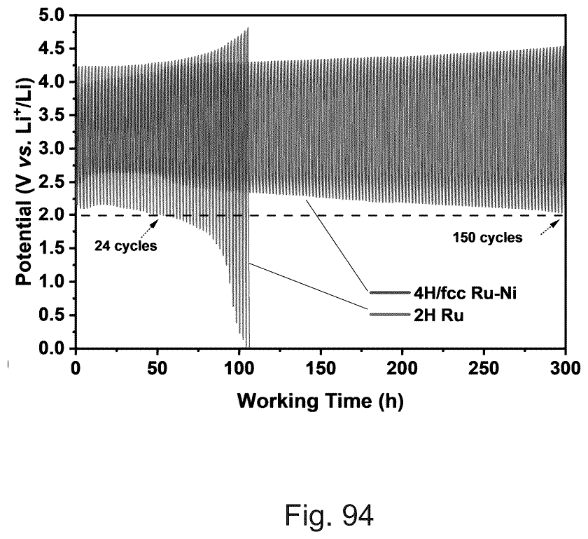

When the current density increases to 500 mA g⁻¹, 4H/fcc Ru—Ni can still deliver a high discharge plateau of 2.61 V, resulting in a low voltage gap of 1.47 V. In sharp contrast, the voltage gap for 2H Ru is as large as 2.13 V (FIG. 93). After the cell returns to low-rate states, 4H/fcc Ru—Ni cathode reproduces the initial discharge-charge behaviors, indicating its good catalytic durability. The different discharge-charge plateau characteristics between Li—CO₂ and Li-air cells with 2H Ru should be caused by inadequate 02 at the electrode/electrolyte interfaces or multistage reaction mechanism of CO₂-involved Li—O₂ electrochemistry. Meanwhile, the Li-air cell with 4H/fcc Ru—Ni has delivered a much more longer cycling lifespan (>300 h) than that (˜110 h) of the 2H Ru at 500 mA g⁻¹. When the discharge voltage reaches 2.0 V, the frequently-used lower limit of voltage window for Li—O₂ electrochemistry, the 4H/fcc Ru—Ni based Li-air cell has undergone 150 cycles, while the 2H Ru based one has only lasted for 24 cycles (FIG. 94). The voltage decay rate is as low as 0.13% per cycle for 4H/fcc Ru—Ni.

### Example 12

### Application of the Catalyst in Flexible Aprotic Li-Air Battery/Cell

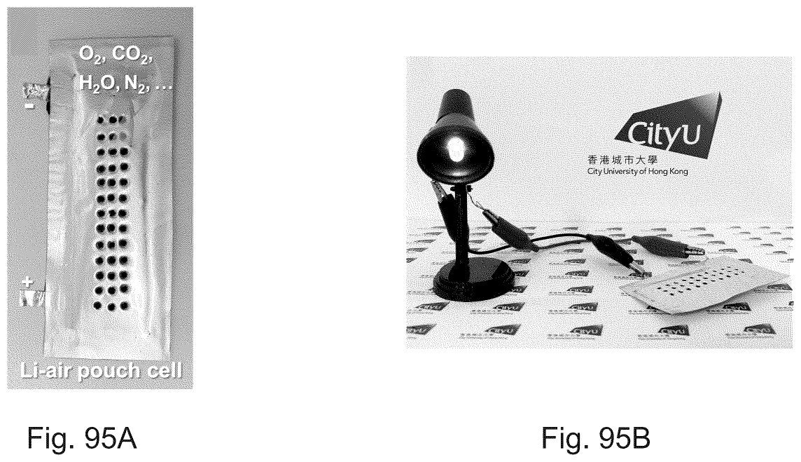

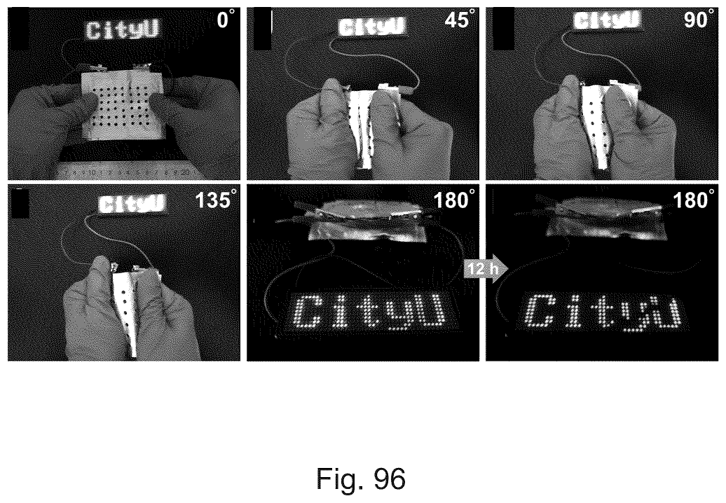

To demonstrate the application potentials, flexible Li-air pouch cells have been constructed using carbon cloth-supported 4H/fcc Ru—Ni as the flexible cathodes. According to the start-up powers of electronics, flexible Li-air pouch cells can be easily fabricated at appropriate mass loadings of catalysts. Here, a mini-type Li-air pouch loaded with ca. 1 mg of active materials is able to run a desk lamp toy (FIGS. 95A and 95B). Three flexible Li-air batteries in parallel connection with a total mass loading of ca. 5 mg are able to power a commercial LED screen operated at 100 mW. These batteries can maintain normal functions during dynamic high-angle deformations and steadily run for above 12 h under the folded state (FIG. 96).

The invention has been given by way of example only, and various other modifications of and/or alterations to the described embodiment may be made by persons skilled in the art without departing from the scope of the invention as specified in the appended claims.

1. A catalytic nanomaterial comprising a Janus hollow nanostructure of a heterophase noble metal and a heterophase non-precious metal.

2. The catalytic nanomaterial as claimed in claim 1, wherein the Janus hollow nanostructure includes a tubular structure with one or more protrusions.

3. The catalytic nanomaterial as claimed in claim 2, wherein the tubular structure and the protrusion each being a formation of the heterophase noble metal and the heterophase non-precious metal.

4. The catalytic nanomaterial as claimed in claim 3, wherein the protrusion includes a heterophase non-precious metal section deposited on a heterophase noble metal section.

5. The catalytic nanomaterial as claimed in claim 3, wherein the tubular structure includes a heterophase noble metal tubular formation with scattered heterophase non-precious metal crystal formations.

6. The catalytic nanomaterial as claimed in claim 3, wherein the protrusion axially extends from the tubular structure.

7. The catalytic nanomaterial as claimed in claim 4, wherein an interface is defined between the heterophase non-precious metal section and the heterophase noble metal section.

8. The catalytic nanomaterial as claimed in claim 5, wherein the heterophase noble metal tubular formation is porous.

9. The catalytic nanomaterial as claimed in claim 1, wherein the heterophase noble metal comprises a 4H/fcc noble metal and the heterophase non-precious metal comprises a 4H/fcc non-precious metal.

10. The catalytic nanomaterial as claimed in claim 1, wherein the heterophase noble metal is selected from the group consisting of Ru, Rh, Ir, Pd, and Pt.

11. The catalytic nanomaterial as claimed in claim 1, wherein the heterophase non-precious metal is selected from the group consisting of Ni, Co, Fe, and Zn.

12. The catalytic nanomaterial as claimed in claim 9, wherein the heterophase noble metal comprises 4H/fcc Ru and the heterophase non-precious metal comprises 4H/fcc Ni.

13. The catalytic nanomaterial as claimed in claim 2, wherein the tubular structure is a porous 4H/fcc Ru nanotube scattered with 4H/fcc Ni crystals and the one or more protrusions are dendritic structures axially protruding from the nanotube.

14. The catalytic nanomaterial as claimed in claim 13, wherein the 4H/fcc Ni crystals are epitaxially deposited on the porous 4H/fcc Ru nanotube.

15. The catalytic nanomaterial as claimed in claim 13, wherein the heterophase non-precious metal section comprises epitaxial deposition of 4H/fcc Ni crystals on the heterophase noble metal section of 4H/fcc Ru, thereby defining a Ru—Ni interface.

16. The catalytic nanomaterial as claimed in claim 13, wherein the porous 4H/fcc Ru nanotube comprises a wall formed with a plurality of nanoholes.

17. The catalytic nanomaterial as claimed in claim 13, wherein Ru and Ni have an atomic ratio of about 72.5:27.5.

18. The catalytic nanomaterial as claimed in claim 13 is in powder form.

19. The catalytic nanomaterial as claimed in claim 13, wherein the 4H/fcc Ru provides a carbon dioxide reduction reaction active site and the 4H/fcc Ni provides a carbon dioxide evolution reaction active site, thereby acting as a bifunctional catalyst.

20. A method for synthesizing the catalytic nanomaterial as claimed in claim 1, comprising the steps of:
epitaxially growing a 4H/fcc noble metal on a 4H/fcc Au nanorod;
selectively etching the 4H/fcc Au nanorod to obtain a hollow 4H/fcc noble metal nanotube with a plurality of dendritic structures;
quasi-epitaxially growing a 4H/fcc non-precious metal on the hollow 4H/fcc noble metal nanotube to obtain a Janus hollow nanostructure of the 4H/fcc noble metal and the 4H/fcc non-precious metal.

21. The method as claimed in claim 20, wherein the noble metal is selected from the group consisting of Ru, Rh, Ir, Pd, and Pt, and the non-precious metal is selected from the group consisting of Ni, Co, Fe, and Zn.

22. The method as claimed in claim 20, wherein the noble metal is Ru and the non-precious metal is Ni.

23. The method as claimed in claim 22, comprising the steps of:
epitaxially growing 4H/fcc Ru on the 4H/fcc Au nanorod in the presence of 1, 2-hexadecanediol and oleylamine under heat treatment;
selectively etching the 4H/fcc Au nanorod in a solution mixture of 0.1 M CuCl₂ and DMF under heat treatment to obtain a hollow 4H/fcc Ru nanotube with a plurality of 4H/fcc Ru dendritic structures;
quasi-epitaxially growing 4H/fcc Ni on the hollow 4H/fcc Ru nanotube with a plurality of 4H/fcc Ru dendritic structures in the presence of 1,2-hexadecanediol and oleylamine under heat treatment to obtain a 4H/fcc Ru—Ni Janus hollow nanostructure.

24. An aprotic alkali metal-gas battery comprising the catalytic nanomaterial as claimed in claim 1, wherein the battery is selected from the group consisting of aprotic Li—CO₂ battery, aprotic Li-air battery, aprotic Na—CO₂ battery, aprotic Na-air battery, aprotic K—CO₂ battery and aprotic K-air battery.

25. The aprotic alkali metal-gas battery as claimed in claim 24 comprising a cathode having the catalytic nanomaterial, the cathode being positioned in an aprotic electrolyte along with an alkali metal anode.

26. The aprotic alkali metal-gas battery as claimed in claim 25 wherein the battery is selected from the group consisting of an aprotic Li—CO₂ battery and an aprotic Li-air battery.

27. The aprotic alkali metal-gas battery as claimed in claim 26 comprising:
a Li-based aprotic electrolyte;
a Li metal anode;
a cathode including a 4H/fcc Ru—Ni Janus hollow nanostructure including a heterophase noble metal comprising 4H/fcc Ru and a heterophase non-precious metal comprising 4H/fcc Ni; and
a separator disposed between the Li metal anode and the cathode.

28. The aprotic alkali metal-gas battery as claimed in claim 27, wherein the Li-based aprotic electrolyte includes a DMSO solution of a Li salt, and an ionic liquid.

29. The aprotic alkali metal-gas battery as claimed in claim 28, wherein the Li salt is selected from the group consisting of lithium hexafluorophosphate (LiPF₆), lithium perchlorate (LiClO₄), lithium nitrate (LiNO₃), lithium tetrafluoroborate (LiBF₄), lithium bistrifluoromethane sulfonimide (LiTFSI), lithium difluorosulfonimide (LiFSI), lithium triflate (LiCF₃SO₃) and a combination thereof.

30. The aprotic alkali metal-gas battery as claimed in claim 28, wherein the Li salt has a concentration of about 0.1 M to about 4 M.

31. The aprotic alkali metal-gas battery as claimed in claim 28, wherein the ionic liquid is selected from the group consisting of 1-ethyl-3-methylimidazole tetrafluoroborate ([Emim]BF₄), 1-ethyl-3-methylimidazole bistrifluoromethosulfonimide ([Emim]TFSI), 1-ethyl-3-methylimidazole difluorosulfonimide ([Emim]FSI), 1-Ethyl-3-methylimidazolium chloride ([Emim]Cl) and a combination thereof.

32. The aprotic alkali metal-gas battery as claimed in claim 28, wherein the Li-based aprotic electrolyte includes about 5% to about 50% by volume of the ionic liquid.

33. The aprotic alkali metal-gas battery as claimed in claim 27, wherein the cathode further includes a conductive carbon material and a binder.

34. The aprotic alkali metal-gas battery as claimed in claim 33, wherein the conductive carbon material is selected from the group consisting of graphene, carbon nanotubes (CNTs), carbon blacks, carbon paper, carbon cloth and a combination thereof.

35. The aprotic alkali metal-gas battery as claimed in claim 33, wherein the binder includes Nafion.

36. The aprotic alkali metal-gas battery as claimed in claim 33, wherein the cathode has a weight ratio of 4H/fcc Ru—Ni Janus hollow nanostructure:conductive carbon material:binder of about 2.7:0.9:0.4.

37. The aprotic alkali metal-gas battery as claimed in claim 33, wherein the cathode has a mass loading of a mixture of the 4H/fcc Ru—Ni Janus hollow nanostructure and the conductive carbon material of about 0.2 mg cm⁻³ to about 0.3 mg cm⁻³.
